(19) United States
(12) Patent Application Publication
(10) Pub. No.: US 2004/0009441 A1
(43) Pub. Date: Jan. 15, 2004

(54) Thermally developable photosensitive material

(76) Inventors: Makoto Ishihara, Kanagawa (JP); Yasuhiro Yoshioka, Kanagawa (JP)

Correspondence Address: Sheldon J. Moss, c/o Yumi Yerks, Apartment #412-North, 2111 Jefferson Davis Highway, Arlington, VA, 22202, US

(21) Appl. No.: 10/400,494

(22) Filed: Mar. 28, 2003

(30) Foreign Application Priority Data
Apr. 2, 2002 (JP) 2002-99888
Apr. 3, 2002 (JP) 2002-101654
Oct. 24, 2002 (JP) 2002-309163
Dec. 5, 2002 (JP) 2002-353235

(51) Int. Cl. G03C 1/34; G03C 1/498

(52) U.S. Cl. 430/614; 430/607; 430/620

(57) ABSTRACT

The present invention relates to, a thermally developable photosensitive material containing a non-photosensitive organic silver salt, photosensitive silver halide and a reducing agent on at least one surface of a transparent substrate, wherein a fog density value immediately after thermal developing treatment is 0.20 or less, a value of b₀* in the following equation (1) at a fog density portion satisfies −20≦b₀* <−4, and a change in an image tone from immediately after thermal developing treatment to after a point when an amount of time has passed as a value of a color difference ΔE as defined in the equation (1) is any one of (a) 1.2 or less at 9 months under an environment of 30° C. and 60% RH, (b) 1.2 or less at 3 months under an environment of 40° C. and 40% RH, or (c) 0.9 or less at 1 week under an environment of 45° C. and 40% RH.

ΔE=[(L₁*−L₀*)²+(a₁*−a₀*)²+b₁*−b₀*]²]^{1/2} Equation (1)

### BACKGROUND OF THE INVENTION

1. Field of the Invention

The present invention relates to a thermally developable photosensitive material, more particularly, a thermally developable photosensitive material which is excellent in the tone stability at storage of an image.

2. Description of the Related Art

In recent years, in the medical field, decrease in an amount of treatment waste is ardently desired from a viewpoint of environmental preservation and space saving. Then, there are demanded the techniques regarding a photosensitive thermally developable photographic material for medical diagnosis and photographic technique which can be effectively exposed by a laser image setter or a laser imager, and can form a clear black image having the high resolution and sharpness. These photosensitive thermally developable photographic materials can eliminate use of solvent system treating chemicals, and can supply to customers the thermally developing treating system which is simple and dose not deteriorate the environment.

Although there are also the similar demands in the field of general image forming materials, the medical image has the characteristics that since fine delineation is required, the high image quality excellent in the sharpness and granularity is necessary and, further, a cold black tone image is preferred from a viewpoint of easy diagnosis. Currently, various hardcopy systems utilizing pigments and dyes such as ink jet printers and electrophotographies are being distributed as a general image forming system, but there is no one which is satisfactory as an output system for a medical image.

On the other hand, a thermally image forming system utilizing an organic silver salt is known (e.g. see Patent Documents 1 and 2 and Non-patent Reference 1). In particular, thermally developable photosensitive materials have generally a photosensitive layer in which a catalytic active amount of a photocatalyst (e.g. silver halide), a reducing agent, a reducible silver salt (e.g. organic silver salt) and, if necessary, a tone agent which controls the tone of silver are dispersed in a binder matrix. In the thermally developable photosensitive material, a black silver image is formed by, after imagewise exposure, heating to a high temperature (e.g. 80° C. or higher), and redox-reacting between a silver halide or a reducible silver salt (functioning as an oxidizing agent) and a reducing agent. A redox reaction is promoted by the catalytic action of a latent image of a silver halide produced by exposure. For that reason, a black silver image is formed on an exposed region. Thermally developable photosensitive materials are disclosed in many literatures and, as a medical image forming system utilizing a thermally developable photosensitive material, Fuji Medical Dry Imager FM-DPL has been marketed (e.g. see Patent Documents 3 and 4, and None-patent Document 2).

In preparation of a thermally image forming system utilizing an organic silver salt, there are a method of preparation by solvent coating, and a method of preparation by coating and drying a coating solution containing, as a main binder, a polymer fine particle as a dispersion in water. Since the latter method does not require a step of recovering a solvent, a preparation facility is simple, and this method is advantageous for large scale production.

Although a thermally developable photosensitive material is an environmentally excellent system, that does not require a treating agent and does not produce a waste material, since a reactive material remains in a photosensitive material even after thermal development, compatibility between the developing activity and the image shelf stability is a greatest problem. Particularly, in medical diagnostic utility, a change in the tone at image shelf stability is not preferable in process observation. A change in the tone by illumination with a fluorescent lamp or a schaukasten is not preferable in process observation and, when an intermediate concentration region of an image is changed, it is easily recognized visually. Further, in a clear thermally developable photosensitive material having the low minimum concentration (fog density), a undesirable change is visually recognized also in a low concentration region in the vicinity of the minimum concentration. From these points, the previous thermally developable photosensitive materials have not sufficiently satisfactory performance and, thus, there is desired further improvement.

[Patent Document 1]

U.S. Pat. No. 3,152,904

[Patent Document 2]

U.S. Pat. No. 3,457,075

[Patent Document 3]

U.S. Pat. No. 2,910,377

[Patent Document 3]

Japanese Patent Application Publication (JP-B) No. 43-4924

[None-Patent Document 1]

B. Shely, “Thermally Processed Silver Systems”, Imaging Processes and Materials, Neblette, 8th edition, Sturge, edited by V. Walworth, A. Shepp, page 2, 1996

[None-Patent Document 2]

Fuji Medical Review No. 8, pages 39-55

### SUMMARY OF THE INVENTION

Accordingly, an object of the present invention is to provide a thermally developable photosensitive material which has the low fog density, and the improved shelf stability of an image after thermal development (change in tone), or provide a thermally developable photosensitive material which gives the sufficient image concentration at a small amount of a reducing agent, has the low fog density, and has the improved image shelf stability at light illumination (change in tone).

The object of the invention is attained by the following thermally developable photosensitive material.

There is provided a thermally developable photosensitive material comprising a non-photosensitive organic silver salt, a photosensitive silver halide and a reducing agent on at least one surface of a transparent substrate, wherein the thermally developable photosensitive material is characterized in that the fog density value immediately after thermal developing treatment is 0.20 or less, and a change in image tone after a point when an amount of time has passed from immediately after thermal developing treatment expressed by a value of a color difference ΔE as defined by the following equation (1) is any one of (a) 1.2 or less after 9 months under an environment at 30° C. and 60% RH, (b) 1.2 or less after 3 months under an environment at 40° C. and 40% RH, and (c) 0.9 or less after 1 week under an environment at 45° C. and 40% RH:

ΔE=[(L₁*−L₀*)²+(a₁*−a₀*)²+(b₁*−b₀*)²]^{1/2} (1)

wherein L₁* and L₀* represent respectively metric brightnesses after a point when an amount of time has passed and immediately after thermal development in a CIELAB space when observed with a light source used in a medical schaukasten, a₁*, b₁* and a₀*, b₀* represent amounts (color coordinate) regarding hue and chroma after a point when an amount of time has passed and immediately after thermal developing treatment in a CIELAB space.

There is provided a thermally developable photosensitive material comprising a non-photosensitive organic silver salt, a photosensitive silver halide and a reducing agent on at least one surface of a transparent substrate, wherein the thermally developable photosensitive material is characterized in that the fog density value immediately after thermal developing treatment is 0.13 or less, and a value of b₀* in the following equation (1) at a fog density portion satisfies −4≦b₀*<4 and, further, a change in image tone after a point when an amount of time has passed from immediately after thermal developing treatment expressed by a value of a color difference ΔE as defined by the above equation (1) is any one of (a) 1.2 or less after 9 months under an environment at 30° C. and 60% RH, (b) 1.2 or less after 3 months under an environment at 40° C. and 40% RH, and (c) 0.9 or less after 1 week under an environment at 45° C. and 40% RH.

There is provided a thermally developable photosensitive material having at least a non-photosensitive organic silver salt, a photosensitive silver halide and a reducing agent on the same surface of a substrate, wherein

1) a fog density value immediately after thermal developing treatment is 0.20 or less;

2) and, a value of b₀* in the above equation (1) at a fog density portion satisfies −20≦b₀*<−4; and

3) further, a change in image tone (color difference ΔE) as defined by the following equation (1) in a period from immediately after thermal developing treatment to after light illumination satisfies any one of the following condition (a) or the following condition (b):

condition (a);

ΔE obtained when 1000 Lux light is continuously irradiated for one day under an environment at 30° C. and 70% RH is 1.2 or less,

condition (b);

ΔE obtained when 10000 Lux light is continuously irradiated for one day under an environment at 25° C. and 60% RH is 0.9 or less.

There is provided a thermally developable photosensitive material having at least a non-photosensitive organic silver salt, a photosensitive silver halide and a reducing agent on the same surface of a substrate, wherein

1) a fog density value immediately after thermal developing treatment is 0.13 or less;

2) and a value of b₀* in the above equation (1) at a fog density portion satisfies −4≦b₀*<4;

3) further, a change in image tone (color difference ΔE) as defined by the above equation (1) in a period from immediately after thermal developing treatment to a time after light illumination satisfies any one of the following condition (a) or the following condition (b):

Condition (a);

ΔE obtained when 1000 Lux light is continuously irradiated for one day under an environment at 30° C. and 70% RH is 1.2 or less,

Condition (b);

ΔE obtained when 10000 Lux light is continuously irradiated for one day under an environment at 25° C. and 60% RH is 0.9 or less.

There is provided the thermally developable photosensitive material, wherein an entire amount of coated silver in the thermally developable photosensitive material is 1.6 g/m².

There is provided the thermally developable photosensitive material, wherein 50% or more of the particles of the photosensitive silver halide is of a particle size of 50 nm or less.

There is provided the thermally developable photosensitive material, wherein the amount of the reducing agent to be coated is 1.0 g/m² or less.

There is provided the thermally developable photosensitive material, which contains a polyhalogen compound as a antifoggant on the same surface side of that of a non-photosensitive organic silver salt relative to a substrate, wherein a coating amount of the polyhalogen compound is 0.5 g/m² or less.

That is,

a first aspect of the invention provides a thermally developable photosensitive material (J) containing a non-photosensitive organic silver salt, a photosensitive silver halide and a reducing agent on at least one surface of a transparent substrate, wherein a fog density value immediately after thermal developing treatment is 0.20 or less, and a value of b₀* in the following equation (1) at a fog density portion satisfies −20≦b₀*<−4 and, further, a change in image tone in a period from immediately after thermal developing treatment to after a point when an amount of time has passed from then expressed by a value of a color difference ΔE as defined by the equation (1) is any one of (a) 1.2 or less at 9 months under an environment at 30° C. and 60% RH, (b) 1.2 or less at 3 months under an environment at 40° C. and 40% RH, and (c) 0.9 or less at 1 week under an environment at 45° C. and 40% RH:

ΔE=[(L₁*−L₀*)²+(a₁*−a₀*)²+(b₁*−b₀*)²]^{1/2} (1)

wherein L₁* and L₀* represent metric brightnesses after a point when an amount of time has passed and after immediately after thermal development in a CIELAB space when observed with a light source used in a medical schaukasten, a₁*, b₁* and a₀*, b₀* represent respectively amounts (color coordinate) regarding hue and chroma after a point when an amount of time has passed and immediately after thermal developing treatment in a CIELAB space.

A second aspect of the invention provides a thermally developable photosensitive material (K) according to the thermally developable photosensitive material (J), wherein the fog density value is 0.13 or less, and a value of b₀* in the above equation (1) at a fog density portion satisfies −4≦b₀*≦4.

A third aspect of the invention provides a thermally developable photosensitive material, wherein an entire amount of coated silver in the above thermally developable photosensitive material (J) is 0.1 to 5.0 g/m².

A fourth aspect of the invention provides a thermally developable photosensitive material, wherein an entire amount of coated silver in the above thermally developable photosensitive material (K) is 0.1 to 5.0 g/m².

A fifth aspect of the invention provides a thermally developable photosensitive material, wherein 50% by mass or more of the particles of the photosensitive silver halide in the above thermally developable photosensitive material (J) is of a particle size of 80 nm or less.

A sixth aspect of the invention provides thermally developable photosensitive material, wherein 50% by mass or more of the particles of the photosensitive silver halide in the above thermally developable photosensitive material (K) is of a particle size of 80 nm or less.

A seventh aspect of the invention provides a thermally developable photosensitive material, wherein the amount of the reducing agent to be coated in the above thermally developable photosensitive material (J) is 0.1 to 3.0 g/m².

An eighth aspect of the invention provides a thermally developable photosensitive material, wherein the amount of the reducing agent to be coated in the above thermally developable photosensitive material (K) is 0.1 to 3.0 g/m².

A ninth aspect of the invention provides a thermally developable photosensitive material, wherein the thermally developable photosensitive material (J) contains, as a antifoggant, an organic polyhalogen compound represented by the following general formula (H):

Q−(Y)ₙ−C(Z₁)(Z₂)X General formula (H):

wherein Q represents an alkyl group, an aryl group or a heterocyclic group, Y represents a divalent tethering group, n represents 0 or 1, Z₁ and Z₂ represent a halogen atom, and X represents a hydrogen atom or an electron withdrawing group.

A tenth aspect of the invention provides a thermally developable photosensitive material, wherein the above thermally developable photosensitive material (K) contains an organic polyhalogen compound represented by above general formula (H) as a antifoggant.

An eleventh aspect of the invention provides a thermally developable photosensitive material (L) having at least a non-photosensitive organic silver salt, a photosensitive silver halide and a reducing agent on the same surface of a substrate, wherein

1) a fog density value immediately after thermal developing treatment is 0.20 or less,

2) and, a value of b₀* in the following equation (1) at a fog density portion satisfies −20≦b₀*<−4,

3) further, a chance in image tone (color difference ΔE) in a period from immediately after thermal developing treatment to after light illumination as defined by the above equation (1) satisfies any one of the following condition (a) or the following condition (b):

condition (a);

ΔE obtained when 1000 Lux light is continuously irradiated for one day under an environment at 30° C. and 70% RH is 1.2 or less,

condition (b);

ΔE obtained when 10000 Lux light is continuously irradiated for one day under an environment at 25° C. and 60% RH is 0.9 or less.

A twelfth aspect of the invention provides a thermally developable photosensitive material (M) according to the thermally developable photosensitive material (L), wherein the fog density value is 0.13 or less, and a value of b₀* in the above equation (1) at a fog density portion satisfies −4≦b₀*≦4.

A thirteenth aspect of the invention provides a thermally developable photosensitive material, wherein an entire amount of coated silver in the above thermally developable photosensitive material (L) is 0.1 to 5.0 g/m².

A fourteenth aspect of the invention provides a thermally developable photosensitive material, wherein an entire amount of coated silver in the above thermally developable photosensitive material (M) is 0.1 to 5.0 g/m².

A fifteenth aspect of the invention provides a thermally developable photosensitive material, wherein 50% by mass or more of the particles of the photosensitive silver halide in the above thermally developable photosensitive material (L) is of a particle size of 80 nm or less.

A sixteenth aspect of the invention provides a thermally developable photosensitive material, wherein 50% by mass or more of the particles of the photosensitive silver halide in the above thermally developable photosensitive material (M) is of a particle size of 80 nm or less.

A seventeenth aspect of the invention provides a thermally developable photosensitive material, wherein the amount of the reducing agent to be coated in the above thermally developable photosensitive material (L) is 0.1 to 3.0 g/m².

An eighteenth aspect of the invention provides a thermally developable photosensitive material, wherein the amount of the reducing agent to be coated in the above thermally developable photosensitive material (M) is 0.1 to 3.0 g/m².

A nineteenth aspect of the invention provides thermally developable photosensitive material, wherein the above thermally developable photosensitive material (L) contains an organic polyhalogen compound represented by the above general formula (H) as a antifoggant.

A twentieth aspect of the invention provides a thermally developable photosensitive material, wherein the above thermally developable photosensitive material (M) contains an organic polyhalogen compound represented by the above general formula (H) as a antifoggant.

### DESCRIPTION OF PREFERRED EMBODIMENTS

The present invention will be explained in detail below.

The thermally developable photosensitive material in accordance with a first embodiment of the invention is characterized in that a color difference represented by the above equation (1) is any one of (a) 1.2 or less at 9 months under an environment at 30° C. and 60% RH, (b) 1.2 or less at 3 months under an environment at 40° C. and 40% RH, and (c) 0.9 or less at 1 week under an environment at 45° C. and 40% RH, and a fog density value immediately after thermal developing treatment is 0.20 or less.

The thermally developable photosensitive material in accordance with a second embodiment of the invention is a thermally developable photosensitive material characterized in that it has at least a non-photosensitive organic silver salt, a photosensitive silver halide and a reducing agent on the same surface of a substrate, a fog density value immediately after thermal developing treatment is 0.20 or less, and a change in image tone in a period from immediately after thermal developing treatment to after light illumination, expressed by a color difference ΔE as defined by the above equation (1) satisfies any one of the following condition (d) or the following condition (e):

condition (d);

ΔE obtained when 1000 Lux light is continuously irradiated for one day under an environment at 30° C. and 70% RH is 1.2 or less,

condition (3);

ΔE obtained when 10000 Lux light is continuously irradiated for one day under an environment at 25° C. and 60% RH is 0.9 or less.

A fog density of the invention will be explained. The thermally developable photosensitive material of the invention has an image forming layer on a transparent substrate, and a transmittal image is obtained by thermal development. The resulting image is measured for the optical concentration at a visual (VIS) region with a transmission Macbeth densitometer, and the concentration at an unexposed part is defined as a fog value.

A color difference value of the invention will be explained. A color difference can be measured by a generally known color difference meter. In the present application, a color difference is measured by a spectrocolorimeter according to JIS Z 8722. As an equation for expressing a color difference, various equations are proposed and, herein, a color difference is defined by a numerical equation using a CIELAB space proposed by Committee of International Illumination (CIE) as described below.

Previously, it was generally thought that, as a change in the fog density with time grows smaller, a change in image tone grows small, and a thermally developable photosensitive material having as small change in the fog density as possible has been studied. However, the present inventors intensively study and, as a result, found that, in a thermally developable photosensitive material satisfying the aforementioned (a) to (c) conditions, unexpectedly, in the case of a bluish type photosensitive material usually called blue base in which a value of b₀* in the above equation (1) at a fog density portion satisfies −20≦b₀*<−4, unexpectedly, when a fog density value immediately after thermal developing treatment is 0.20 or less, a change in image tone is small regardless of a magnitude of a change in the fog density with time. On the other hand, we found that, in the case of a weakly bluish type photosensitive material usually called clear base in which a value of b₀* in the equations (1) at a fog density portion satisfies −4≦b₀*≦4, when a fog density value immediately after thermal developing treatment is o.13 or less, a change in image tone is small regardless of a magnitude of change in the fog density with time.

In addition, regarding the thermally developable photosensitive material having such the characteristics, it was found that, also in an actual image which has been stored in the atmosphere of a usual storage box of a medical organization for a long term, a tone change is so small that it can not be recognized visually. On the other hand, it was found that, when the fog density immediately after thermal developing treatment exceeds 0.20 in the above blue base, and when the concentration exceeds 0.13 in the above clear base, even if any of the above (a) to (c) conditions is satisfied, a tone change is so large that it can be easily recognized visually, in an actual image after long term storage.

In addition, in the thermally developable photosensitive material satisfying the definition of the above condition (d) or condition (e), we found that, in the case of a bluish type photosensitive material usually called blue base in which a value of b₀* in the above equation (1) at a fog density portion satisfies −20≦b₀*<−4, unexpectedly, when a fog density value immediately after thermal developing treatment is 0.20 or less, a change in image tone is small regardless of a magnitude of a change in the fog density due to light illumination. In addition, in the thermally developable photosensitive material having such the characteristics, it was found that, also in an actual image which has been exposed to the light (light irradiation by an indoor fluorescent lump or schaukasten light at diagnosis) for a normal time upon handling in a medical fascilities, a change in tone can not practically be recognized visually.

On the other hand, in the case of a weakly bluish photosensitive material usually called clear base in which a value of b₀* in the equation (1) at a fog density portion satisfies −4≦b₀*≦4, it was found that, when a fog density value immediately after thermal developing treatment is 0.13 or less, a change in image tone is small regardless of a magnitude of a change in the fog density caused by light irradiation.

In the thermally developable photosensitive material of the invention, in the case of a bluish type photosensitive material usually called blue base in which a value of b₀* in the above equation (1) at a fog density portion satisfies −20≦b₀*<−4, the fog density value of 0.20 or less is preferable, 0.19 or less is more preferable, and 0.18 or less is most preferable. On the other hand, in the case of a weakly bluish photosensitive material usually called clear base in which a value of b₀* in the equation (1) at a fog density portion satisfies −4≦b₀*≦4) a fog density value immediately after developing treatment is preferably 0.13 or less, more preferably 0.12 or less, most preferably 0.11 or less.

A value of b₀* varies depending on a kind or a content of a blue dye, and an observation light source at tone measurement. In the case of a bluish type photosensitive material usually called blue base, the value is in a range of −20≦b₀*<−4 and, when an observation light source is test light F5 (medium light color), the value is generally in a range of −15≦b₀*≦−8. On the other hand, in the case of a weakly bluish type photosensitive material usually called clear base, the value is in a range of −4≦b₀*≦4 and, when an observation light source is test light F5 (medium light color), the value is generally in a range of −3.5≦b₀*≦−2.5.

On the other hand, it was found that, when the fog density immediately after thermal developing treatment exceeds 0.20 in the above blue base, and when the concentration exceeds 0.13 in the above clear base, even if any one of the above (d) or (e) condition is satisfied, a tone change is easily recognized visible in an actual image after light irradiation.

In the thermally developable photosensitive material of the invention, a smaller color difference ΔE value is preferable and, under the environmental conditions (a), (b) and (d), ΔE value of 0.9 or less is preferable, 0.6 or less is more preferable. In addition, under the environmental conditions (c) and (e), ΔE value of 0.6 or less is preferable, 0.3 or less is more preferable.

The CIELAB space referred to in the above equation (1) is one of equal color spaces recommended by Committee of International Illumination (CIE) in 1976. (With respect to L₀*, a₀*, B₀*, and L₁*, a₁*, b₁* in the above equation (1)), letting three stimulation values of a subjective object to be X, Y, Z, and three stimulation values of a complete diffusion reflection plane to be Xₙ, Yₙ (normalized as Yₙ=100) and Zₙ, a* and b* which are amounts (color coordinates) regarding a brightness L* and a hue and color saturation are defined by the following equation (2).

L*=116(Y/Yₙ)^{1/3}−16

a*=500{(X/Xₙ)^{1/3}−(Y/Yₙ)^{1/3}} (2)

b*=200{(Y/Yₙ)^{1/3}−(Z/Zₙ)^{1/3}}

provided that the equation (2) is used in a range of X/Xₙ>0.008856, Y/Yₙ>0.008856, and Z/Zₙ>0.008856 and, in a range other than that range, a correction equation of the following equation (3) is used.

L*=116f(Y/Yₙ)−16,

a*=500{f(X/Xₙ)−f(Y/Yₙ)} (3),

b*=200{f(Y/Yₙ)−f(Z/Zₙ)},

wherein f(X/Xₙ), f(Y/Yₙ) and f(Z/Zₙ) are functions,

f(X/Xₙ)=(X/Xₙ)^{1/3}X/Xₙ>0.008856,

f(X/Xₙ)=7.787(X/Xₙ)+16/116X/Xₙ≦0.008856,

f(Y/Yₙ)=(Y/Yₙ)^{1/3}X/Xₙ>0.008856,

f(Y/Yₙ)=7.787(Y/Yₙ)+16/116X/Xₙ≦0.008856,

f(Z/Zₙ)=(Z/Zₙ)^{1/3}X/Xₙ>0.008856,

f(Z/Zₙ)=7.787(Z/Zₙ)+16/116X/Xₙ≦0.008856.

In the invention, L*, a* and b* obtained from X, Y and Z, and Xₙ, Yₙ and Zₙ immediately after developing treatment are adopted respectively named L₀*, a₀* and b₀*, and L*, a* and b* obtained from X, Y and Z, and Xₙ, Yₙ and Zₙ after light irradiation are adopted asrespectively named L₁*, a₁* and b₁*.

As the light source used in a medical schaukasten referred to in the above equation (1), any light sources may be used as far as they are light sources which can be used for medical schaukasten and, usually, a day light color or white color (cool white) fluorescent lamp is used.

In order to obtain a color difference of the invention in the thermally developable photosensitive material, means therefore is not particularly limited, but means can be surely attained by appropriately combining single or a plurality of various following adjusting factors constituting the thermally developable photosensitive material. From a viewpoint of remarkably exerting the effects thereof, a combination of a plurality of adjusting factors is preferable.

Examples of specific means for attaining a desired color difference in the thermally developable photosensitive material of the invention include 1) adjustment of an entire coated amounts of a non-photosensitive organic silver salt and a photosensitive silver halide in a sensitive material in a preferable range described below, 2) adjustment of a particle size and a content of a photosensitive silver halide in a preferable range as described below, 3) adjustment of selection and an amount to be added of a reducing agent in a preferable range as described below. 4) adjustment of selection and an amount to be added of a development accelerator in a preferable range as described below, and 5) adjustment of selection and an amount to be added of a antifoggant in a preferable range as described below.

Specific construction of the thermally developable photosensitive material of the present application, components contained therein and a method of forming an image will be explained below.

The thermally developable photosensitive material in accordance with a first embodiment of the invention has an image forming layer containing a photosensitive silver halide, a non-photosensitive organic silver salt, a reducing agent and a binder on at least one surface of a substrate. In addition, preferably, the material may have a surface protecting layer on the image forming layer, or a back layer or a back protecting layer on the opposite surface.

Construction of each layer of the thermally developable photosensitive material of the invention, and preferable components therefor will be explained in detail below.

(Explanation of Organic Silver Salt)

1) Composition

An organic silver salt which can be used in the invention is a silver salt which is relatively stable to the light, but functions as a silver ion donor in the presence of an exposed photosensitive silver halide and a reducing agent or when heated to 80° C. or higher, whereby, a silver image is formed. The organic silver salt may be an arbitrary organic substance which can supply a silver ion which is reducible by a reducing agent. Such the non-photosensitive organic silver salt is described in paragraph numbers 0048 to 0049 in Japanese Patent Application Laid-Open (JP-A) No. 10-62899, page 18 line 24 to page 19 line 37 in EP Laid-Open Nos. 0803764A1, 0962812A1, JP-A Nos. 11-349591, 2000-7683, 2000-72711 and the like. A silver salt of an organic acid, in particular, a silver salt of a long aliphatic carboxylic acid (having 10 to 30 carbon atoms, preferably 15 to 28) is preferable. Preferable examples of a fatty acid silver salt include silver lignocerate, silver behenate; silver arachidate, silver stearate, silver oleate, silver laurate, silver caprate, silver myristate, silver palmitate, silver erucate, and a mixture thereof. In the invention, among these silver salts, it is preferable to use fatty acid silver having a content of behenic acid silver of preferably not less than 50 mole % and not greater than 100 mole %, more preferably not less than 85 mole % and not greater than 100 mole %, further preferably not less than 95 mole % and not greater than 100 mole %. Further, it is preferable to use fatty acid silver having a content of silver erucate of 2 mole % or less, more preferably 1 mole % or less, further preferably 0.1 mole %.

In addition, it is preferable that a content of silver stearate is 1 mole % or less. By rendering a content of silver stearate 1 mole % or less, a silver salt of an organic acid having low Dmin, the high sensitivity and the excellent image shelf stability is obtained. The content of silver stearate is preferably 0.5 mole % or less, particularly preferably substantially zero.

Further, when silver arachidate as an organic acid silver salt is contained, a content of silver arachidate of 6 mol % or less is preferable, 3 mol % or less is more preferable, in that the low Dmin is obtained and a silver salt of an organic acid having the excellent image shelf stability is obtained.

2) Shape

A shape of an organic silver salt which can be used in the invention is not particularly limited, but may be any one of needle-like, bar-like, plate-like or scale-like shape.

In the invention, a scale-like organic silver slat is preferable. In addition, short needle-like, cuboid, cubic or potato-like unshaped particles having a ratio of a long axis and a short axis in length of 5 or less are also preferably used. These organic silver particles have the characteristics that a fog is small at thermal development as compared with a long needle-like particle having a ratio of a long axis and a short axis in length of 5 or larger. In particular, a particle having a ratio of a long axis and a short axis of 3 or less is preferable because the mechanical stability of a coated film is improved. In the present specification, a scale-like organic silver salt is defined as follows: an organic acid silver salt is observed with an electron microscope, a shape of an organic acid silver salt particle is approximated as a cuboid and, letting sides of this cuboid to be a, b and c from a shortest side (c and b may be the same), calculation is performed by using smaller numerical values a and b, and x is obtained as follows:

x=b/a

Like this, x is obtained for around 200 particles and, by letting an average to be x(average), those satisfying the relationship of x(average)≧1.5 is regarded as scale-like. Preferably, 30≧x(average)≧1.5, and more preferably 15≧x(average)≧1.5. Incidentally, needle-like is 1≦x(average)<1.5.

In a scale-like particle, “a” can be regarded as a thickness of a plate-like particle having a plane having sides b and c as a main flat plane. An average of “a” is preferably not smaller than 0.01 μ and not larger than 0.3 μm, more preferably not smaller than 0.1 μm and not larger than 0.23 μm. It is preferable that an average of c/b is not smaller than 1 and not larger than 9, more preferably not smaller than 1 and not larger than 6, further preferably not smaller than 1 and not larger than 4, most preferably not smaller than 1 and not larger than 3.

By rendering the above-mentioned sphere equivalent diameter not smaller than 0.05 μm and not larger than 1 μm, particles are hardly aggregated in a photosensitive material, and the image shelf stability becomes better. The sphere equivalent diameter is preferably not smaller than 0.1 μm and not larger than 1 μm. In the invention, a sphere equivalent diameter is measured by directly shooting a sample using an electron microscope and, thereafter, image-treating the negative.

In the scale-like particle, a sphere equivalent diameter/a of a particle is defined as an aspect ratio. An aspect ratio of a scale-like particle is preferably not smaller than 1.1 and not larger than 30, more preferably not smaller than 1.1 and not larger than 15 from a viewpoint that particles are hardly aggregated in a photosensitive material, and the image shelf stability becomes better.

A particle size distribution of an organic silver salt is preferably monodispersion. Monodispersion is such that a percentage of a value obtained by dividing standard deviation of each length of a short axis and a long axis by a short axis and a long axis respectively, is preferably 100% or less, more preferably 80% or less, further preferably 50% or less. As a method of measuring a shape of a silver salt, the shape can be obtained from a transmission electron microscope image of an organic silver salt dispersion. As another method of measuring monodispersity, there is a method of obtaining a standard deviation of a volume weighted average diameter of an organic silver salt, and a percentage of a value divided by a volume weighted average diameter (variation coefficient) is preferably 100% or less, more preferably 80% or less, further preferably 50% or less. As a measuring method, for example, monodispersity can be measured from a particle size (volume weighted average diameter) obtained by irradiating an organic silver salt dispersed in a solution with a laser light, and obtaining a self correlation function of fluctuation of the scattered light relative to a time change.

3) Preparation

As a process for preparing organic acid silver used in the invention and a method of dispersing the same, the known methods can be applied. For example, reference may be made to the above-mentioned JP-A No. 10-62899, EP Laid-Open No. 0803763A1, EP Laid-Open No. 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, 2002-107868 and the like.

In addition, when a photosensitive silver salt is present in combination at dispersion of an organic silver salt, since a fog is increased and sensitivity is remarkably reduced, it is more preferable that a photosensitive silver salt is not substantially contained at dispersion. In the invention, an amount of a photosensitive silver salt to be dispersed in a water dispersion is preferably 1 mol % or less, more preferably 0.1 mol % or less relative to 1 mol of an organic acid silver salt in the solution, further preferably, positive addition of a photosensitive silver salt is not performed.

In the invention, a photosensitive material can be prepared by mixing an organic silver salt dispersion in water and a photosensitive silver salt dispersion in water, a ratio of mixing an organic silver salt and a photosensitive silver salt can be selected depending on the purpose, and a ratio of a photosensitive silver salt relative to an organic silver salt is preferably in a range of 1 to 30 mol %, and a range of further 2 to 20 mol %, particularly 3 to 15 mol %. Mixing of a dispersion of two kinds or more of organic silver salts in water and two or more kinds of water dispersion of photosensitive silver salts is a method which is preferably used for regulating the photographic properties.

4) Amount to be Added

An organic silver salt of the invention can be used in a desired amount, and an entire amount of coated silver including silver-halide is preferably 0.1 to 5.0 g/m², more preferably 0.3 to 3.0 g/m², further preferably 0.5 to 2.0 g/m². In particular, in order to improve the image shelf stability, it is preferable that an entire amount of coated silver is 1.8 g/m² or less, more preferably 1.6 g/m². When a preferable reducing agent of the invention is used, the sufficient image concentration can be obtained even in such a low silver amount.

(Explanation of Reducing Agent)

It is preferable that the thermally developable photosensitive material of the invention contains a thermally developing agent which is a reducing agent for an organic silver salt. The reducing agent for an organic silver salt may be an arbitrary substance (preferably organic substance) which reduces a silver ion into metal silver. Examples of such a reducing agent are described in paragraph numbers 0043-0045 in JP-A No. 11-65021, and page 7 line 34 to page 18 line 12 in EP Laid-Open No. 0803764A1.

In the invention, as a reducing agent, a so-called hindered phenol series reducing agent which has a substituent at an ortho position of a phenolic hydroxy group, or a bisphenol series reducing agent is preferable, and a compound represented by the following general formula (R) is more preferable.

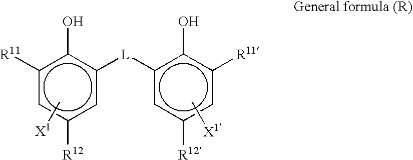

(In the general formula (R), R¹¹ and R^{11′} represent, each independently, an alkyl group having 1 to 20 carbon atoms. R¹² and R^{12′} represent, each independently, a hydrogen atom or a substituent substitutable on a benzen ring. L represents a —S— group or a —CHR¹³— group. R¹³ represents a hydrogen atom or an alkyl group having 1 to 20 carbon atoms. X¹ and X^{1′} represent, each independently, a hydrogen atom or a group substitutable on a benzen ring.)

The general formula (R) will be explained in detail.

1) R¹¹ and R^{11′}

R¹¹ and R^{11′} are, independently, a substituted or unsubstituted alkyl group having 1 to 20 carbon atoms, and a substituent for an alkyl group is not particularly limited, but preferable examples thereof include an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group, an ureido group, an urethane group, a halogen atom and the like.

2) R¹² and R^{12′}, X¹ and X^{1′}

R¹² and R^{12′} are, independently, a hydrogen atom or a substituent substitutable on a benzen ring, and X¹ and X^{1′} represent, each independently, a hydrogen atom or a group substitutable on a benzen ring. Preferred examples of each group substitutable on a benzen ring include an alkyl group, an aryl group, a halogen atom, an alkoxy group, and an acylamino group.

3) L

L represents a —S— group or a —CHR¹³— group. R¹³ represents a hydrogen atom or an alkyl group having 1 to 20 carbon atoms, and an alkyl group may have a substituent. Specific examples of an unsubstituted alkyl group for R¹³ include a methyl group, an ethyl group, a propyl group, a butyl group, a heptyl group, an undecyl group, an isopropyl group, a 1-ethylpentyl group, and a 2,4,4-trimethylpentyl group. Examples of a substituent for an alkyl group are the same as those for R¹¹, and include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, and a sulfamoyl group.

4) Preferred Substituent

R¹¹ and R^{11′} are preferably a secondary or tertiary alkyl group having 3 to 15 carbon atoms, specifically, an isopropyl group, an isobutyl group, a t-butyl group, a t-amyl group, a t-octyl group, a cyclohexyl group, a cyclopentyl group, a 1-methylcyclohexyl group, and a 1-ethylcyclopropyl group. R¹¹ and R^{11′} are more preferably a tertiary alkyl group having 4 to 12 carbon atoms and, inter alia, a t-butyl group, a t-amyl group, and a 1-methylcyclohexyl group are further preferable, and a t-butyl group is most preferable.

R¹² and R^{12′} are preferably an alkyl group having 1 to 20 carbon atoms, specifically, a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. More preferable are a methyl group, an ethyl group, a propyl group, an isopropyl group, and t-butyl group.

X¹ and X^{1′} are preferably a hydrogen atom, a halogen atom, an alkyl group, more preferably a hydrogen atom.

L is preferably a —CHR¹³— group.

R¹³ is preferably a hydrogen atom or an alkyl group having 1 to 15 carbon atoms and, as an alkyl group, a methyl group, an ethyl group, a propyl group, an isopropyl group, and a 2,4,4-trimethylpentyl group are preferable. R¹³ is particularly preferably a hydrogen atom, a methyl group, an ethyl group, a propyl group or an isopropyl group.

When R¹³ is a hydrogen atom, R¹² and R^{12′} are preferably an alkyl group having 2 to 5 carbon atoms, and an ethyl group and a propyl group are more preferable, and an ethyl group is most preferable.

When R¹³ is a primary or secondary alkyl group having 1 to 8 carbon atoms, R¹² and R^{12′} are preferably a methyl group. As a primary or secondary alkyl group having 1 to 8 carbon atoms for R¹³, a methyl group, an ethyl group, a propyl group and an isopropyl group are more preferable, and a methyl group, an ethyl group, and a propyl group are further preferable.

When all of R^{11,} R^{11′}, R¹² and R^{12′} are methyl groups, it is preferable that R¹³ is a secondary alkyl group. In this case, as a secondary alkyl group for R¹³, an isopropyl group, an isobutyl group, and a 1-ethylpentyl group are preferable, and an isopropyl group is more preferable.

The above-mentioned reducing agent has the different thermally developing property or developed silver tone depending on a combination of R¹¹, R^{11′}, R¹², R^{12,} and R¹³. Since a combination of two or more kinds of reducing agents can adjust them, it is preferable to use by combining two or more kinds depending on the purpose.

Specific examples of a reducing agent of the invention including a compound represented by the general formula (R) herein will be shown below, but the invention is not limited by them.

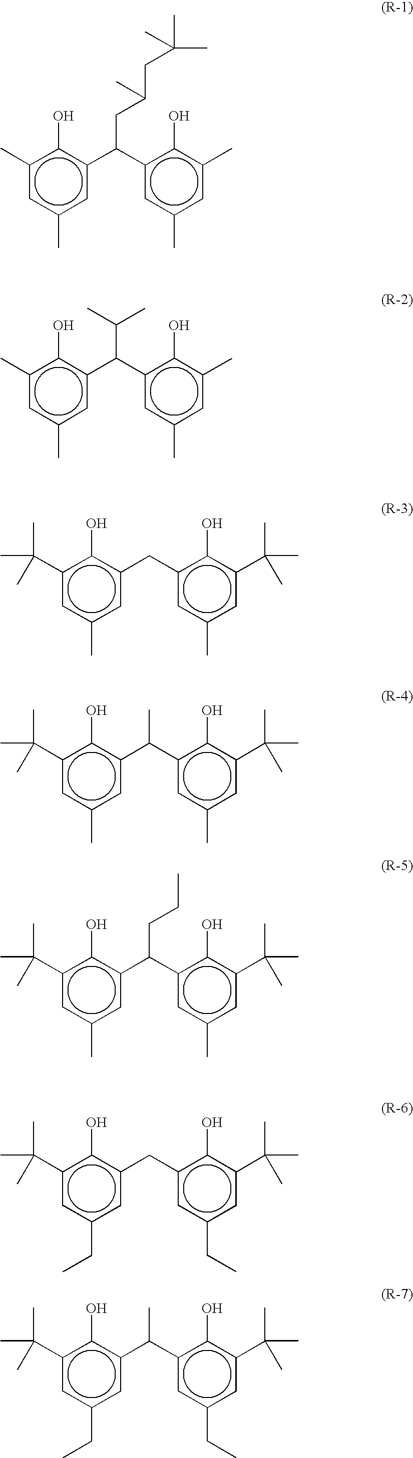

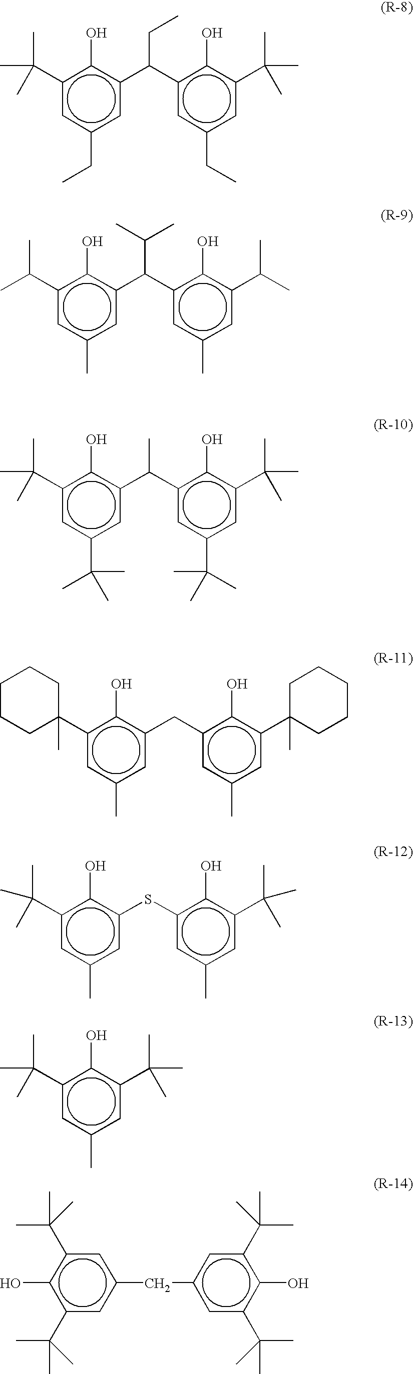

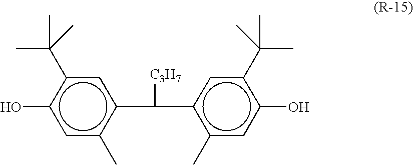

Other examples of a preferable reducing agent of the invention are compounds described in JP-A Nos. 2001-188314, 2001-209145, 2001-350235, and 2002-156727.

In the invention, an amount of a reducing agent to be added is preferably 0.1 to 3.0 g/m², more preferably 0.2 to 1.5 g/m², further preferably 0.3 to 1.0 g/m². A reducing agent is contained preferably at 5 to 50% mol, more preferably 8 to 30 mol %, further preferably 10 to 20 mol % relative to 1 mol of silver in a plane having an image forming layer. It is preferable that a reducing agent is contained in an image forming layer.

A reducing agent may be contained in a coating solution, or may be contained in a photosensitive material by any method such as a solution form, an emulsion dispersion form, and a solid fine particle dispersion form.

Examples of a well known emulsion dispersing method include a method of dissolving a reducing agent using an oil such as dibutyl phthalate, tricresyl phosphate, glyceryl triacetate and diethyl phthalate, or a complementing solvent such as ethyl acetate and cyclohexanone, and mechanically preparing an emulsion dispersion.

In addition, examples of a solid fine particle dispersing method include a method of dispersing a reducing agent powder in a suitable solvent such as water and the like with a ball mill, a colloid mill, a vibration ball mill, a sand mill, a jet mill, a roller mill or ultrasonic waves, and preparing a solid dispersion. Upon this, a protective colloid (e.g. polyvinyl alcohol), and a surfactant (e.g. anionic surfactant such as sodium triisopropylnaphthalenesulfonate (mixture of those having different substitution positions of three isopropyl groups)) may be used. In the above mills, beads such as zirconium and the like are normally used as a dispersing medium, and Zr and the like which are dissolved out from these beads are mixed in a dispersion in some cases. Zr is usually in a range of 1 ppm to 1000 ppm depending on the dispersing conditions. When a content of Zr in a sensitive material is 0.5 mg or less per 1 g of silver, there is no practical problem.

It is preferable that a preservative (e.g. sodium salt of benzoisothiazolinone) is contained in a water dispersion.

Particularly preferable is a solid particle dispersion method for a reducing agent, and it is preferable that a reducing agent is added as a fine particle having an average particle size of 0.01 μm to 10 μm, preferably 0.05 μm to 5 μm, more preferably 0.1 μm to 2 μm. In the present application, it is preferable that other solid dispersions are used by dispersing particles at a particle size of this range.

(Explanation of Development Accelerator)

In the thermally developable photosensitive material of the invention, as a development accelerator, a sulfonamidophenol series compound represented by the general formula (A) described in JP-A Nos. 2000-267222 and 2000-330234, a hindered phenol series compound represented by the general formula (II) described in JP-A No. 2001-92075, a hydrazine series compound represented by the general formula (I) described in JP-A Nos. 10-62895 and 11-15116, by the general formula (D) described in JP-A No. 2002-156727, or by the general formula (1) described in JP-A No. 2001-074278, and a phenol series or naphthol series compound represented by general formula (2) described in JP-A No. 2001-264929 are preferably used. These development accelerators are used in a range of 0.1 to 20 mol %, preferably in a range of 0.5 to 10 mol %, more preferably in a range of 1 to 5 mol % relative to a reducing agent. Examples of a method of introduction of the development accelerator into a sensitive material include the same methods as those for a reducing agent and, in particular, it is preferably added as a solid dispersion or an emulsion dispersion. When the development accelerator is added as an emulsion dispersion, it is preferable to add as an emulsion dispersion obtained by dispersing using a high boiling point solvent and a low boiling point complementing solvent which are a solid at a normal temperature, or to add as a so-called oilless emulsion dispersion without using a high boiling solvent.

In the invention, among the above-mentioned development accelerators, a hydrazine series compound represented by the general formula (D) described in JP-A No. 2002-156727, a phenol series or naphthol series compound represented by the general formula (2) described in JP-A No. 2001-264929 are more preferable.

A particularly preferable development accelerator of the invention includes compounds represented by the following general formulae (A-1) and (A-2).

Q₁-NHNH-Q₂ General formula (A-1)

(wherein, Q₁ is an aromatic group which binds to —NHNH-Q₂ with a carbon atom, or a heterocyclic group, and Q₂ represents a carbamoyl group, an acyl group, an alkoxycarbonyl group, an aryloxycarbonyl group, a sulfonyl group, or a sulfamoyl group).

In the general formula (A-1), as an aromatic group or a heterocyclic group represented by Q₁, a 5 to 7-membered unsaturated ring is preferable. Preferable examples thereof include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, and a thiophene ring. Fused rings in which these rings are mutually fused are also preferable.

These rings may have a substituent and, when they have two or more substituents, those substituents may be the same or different. Examples of a substituent include a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. When these substituents are a replaceable group, they may further have a substituent, and preferred examples of a substituent include a halogen atom, an alkyl group, an aryl group, a carbonamido group; an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

A carbomoyl group represented by Q₂ is a carbamoyl group having preferably 1 to 50 carbon atoms, more preferably 6 to 40 carbon atoms, and examples thereof include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl, and N-benzylcarbamoyl.

An acyl group represented by Q₂ is an acyl group having preferably 1 to 50 carbon atoms, more preferably 6 to 40 carbon atoms, and examples thereof include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. An alkoxycarbonyl group represented by Q₂ is an alkoxycarbonyl group having preferably 2 to 50 carbon atoms, more preferably 6 to 40 carbon atoms, and examples thereof include methoxycarbonyl, ethoxycarbonyl, isobutyloxycarbonyl, cyclohexyloxycarbonyl, dodecyloxycarbonyl, and benzyloxycarbonyl.

An aryloxycarbonyl group represented by Q₂ is an aryloxycarbonyl group having preferably 7 to 50 carbon atoms, more preferably 7 to 40 carbon atoms, and examples thereof include phenoxycarbonyl, 4-octyloxyphenoxycarbonyl, 2-hydroxymethylphenoxycarbonyl, and 4-dodecyloxyphenoxycarbonyl. A sulfonyl group represented by Q₂ is a sulfonyl group having preferably 1 to 50 carbon atoms, more preferably 6 to 40 carbon atoms, and examples thereof include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

A sulfamoyl group represented by Q₂ is a sulfamoyl group having preferably 0 to 50 carbon atoms, more preferably 6 to 40 carbon atoms, and examples thereof include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. A group represented by Q₂ may have a group which is exemplified as a substituent for a 5 to 7-membered unsaturated ring represented by the above-mentioned Q₁ at a replaceable position and, when Q₂ has two or more substituents, those substituents may be the same or different.

Then, a preferable range of a compound represented by the formula (A-1) will be described. As Q₁, a 5 to 6-membered unsaturated ring is preferable, a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring, and rings in which these rings are fused with a benzene ring or an unsaturated heterocycle are more preferable. In addition, as Q₂, a carbamoyl group is preferable and, in particular, a carbamoyl group having a hydrogen atom on a nitrogen atom is preferable.

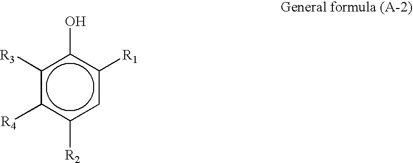

In the general formula (A-2), R₁ represents an alkyl group, an acyl group, an acylamino group, a sulfonamido group, an alkoxycarbonyl group, and a carbamoyl group. R₂ represents a hydrogen atom, a halogen atom, an alkyl group, an alkoxy group, an aryloxy group, an alkyothio group, an arylthio group, an acyloxy group, and a carbonic acid ester group. R₃ and R₄ represent a group substitutable on a benzen ring which is exemplified in an example of a substituent of the general formula (A-1), respectively. R₃ and R₄ may be connected to each other to form a fused ring.

R₁ is preferably an alkyl group having 1 to 20 carbon atoms (e.g. methyl group, ethyl group, isopropyl group, butyl group, tert-octyl group, cyclohexyl group), an acylamino group (e.g. acetylamino group, benzoylamino group, methylureide group, 4-cyanophenylureido group etc.), or a carbamoyl group (n-butylcarbamoyl group, N,N-diethylcarbamoyl group, phenylcarbamoyl group, 2-chlorophenylcarbamoyl group, 2,4-dichlorophenylcarbamoyl group etc.), and an acylamino group (including ureido group and urethane group) is more preferable. R₂ is preferably a halogen atom (more preferably chlorine atom, bromine atom), an alkoxy group (e.g. methoxy group, butoxy group, n-hexyloxy group, n-decyloxy group, cyclohexyloxy group, benzyloxy group etc.), or an aryloxy group (phenoxy group, nathphoxy group etc.).

R₃ is preferably a hydrogen atom, a halogen atom, or an alkyl group having 1 to 20 carbon atom, and a halogen atom is most preferable. R₄ is preferably a hydrogen atom, an alkyl group, or an acylamino group, more preferably an alkyl group or an acylamino group. Examples of a preferable substituent for them are the same as those for R₁. When R₄ is an acylamino group, it is also preferable that R₁ may be combined with R₃ to form a carbostyryl group.

In the general formula (A-2), when R₃ and R₄ are bonded to each other to form a fused ring, as a fused ring, a naphthalene ring is particularly preferable. The same substituents as those which are exemplified for the general formula (A-1) may bind to a naphthalene ring. When the general formula (A-2) is a naphthol series compound, it is preferable that R₁ is a carbamoyl group. Inter alia, it is particularly preferable that it is a benzoyl group. R₂ is preferably an alkoxy group or an aryloxy group, and particularly preferably an alkoxy group.

Preferable examples of a development accelerator of the invention will be shown below. The invention is not limited to them.

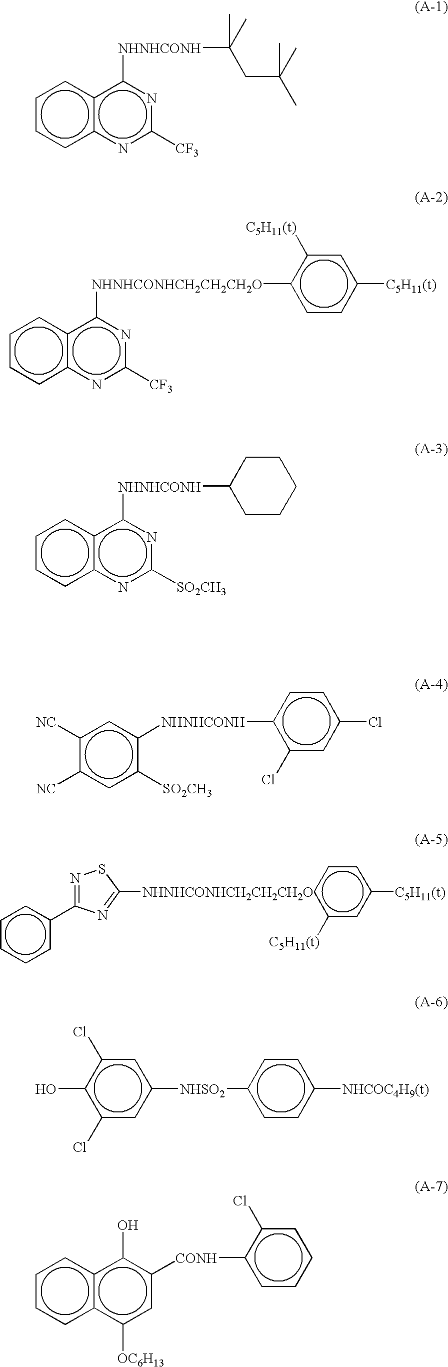

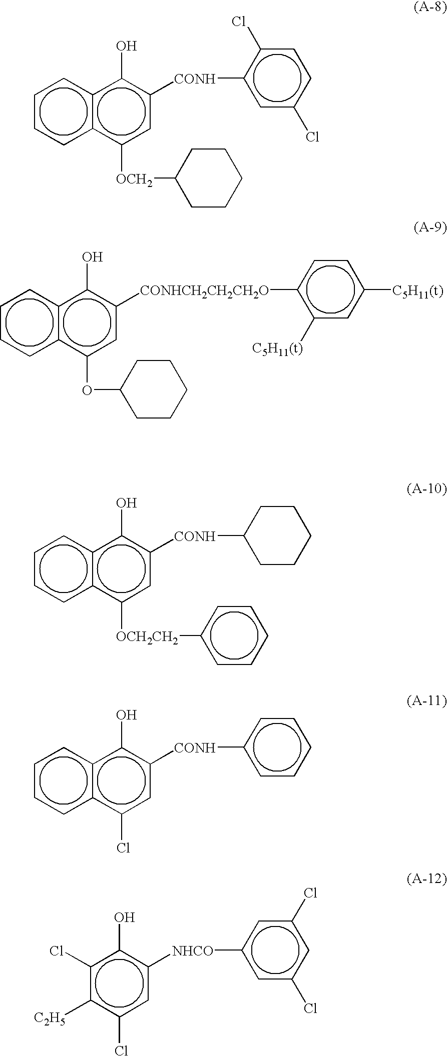

(Explanation of Hydrogen-Bonding Compound)

When a reducing agent of the invention has an aromatic hydroxyl group (—OH) or an amino group (—NHR, wherein R is a hydrogen atom or an alkyl group), in particular, when the reducing agent is the above-mentioned bisphenol, it is preferable to in combination use a non-reducing compound having a group which can form a hydrogen bond with these groups.

Examples of a group which forms a hydrogen bond with a hydroxyl group or an amino group include a phosphoryl group, a sulfoxido group, a sulfonyl group, a carbonyl group, an amido group, an ester group, an urethane group, an ureido group, a tertiary amino group, and a nitrogen-containing aromatic group. Among them, preferred are compounds having a phosphoryl group, a sulfoxido group, an amido group (provided that it has no >N—H group, and is blocked like >N—Ra (wherein Ra is substituent other than H)), an urethane group (provided that it has no >N—H group, and is blocked like >N—Ra (wherein Ra is a substituent other than H)), or an ureido group (provided that it has no >N—H group, and is blocked like >N—Ra (wherein Ra is a substituent other than H)).

In the invention, a particularly preferable hydrogen-bonding compound is a compound represented by the following general formula (D).

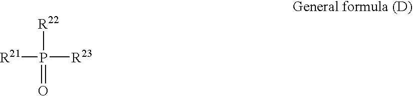

In the general formula (D), R²¹ through R²³ represent, each independently, an alkyl group, an aryl group, an alkoxy group, an aryloxy group, an amino group or a heterocyclic group, and these groups may be unsubstituted or have a substituent.

Examples of a substituent in the case where R²¹ through R²³ have a substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group, a preferable substituent is an alkyl group or an aryl group, and examples thereof include a methyl group, an ethyl group, an isopropyl group, a t-butyl group, a t-octyl group, a phenyl group, a 4-alkoxyphenyl group, and a 4-acyloxyphenyl group.

Specific examples of an alkyl group for R²¹ through R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Examples of an aryl group include a phenyl group, a cresyl group, a xylyl group, a naphthyl group, a 4-t-butylphenyl group, a 4-t-octylphenyl group, a 4-anisidyl group, and a 3,5-dicholorophenyl group.

Examples of an alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

Examples of an aryloxy group include a phenoxy group, a cresyloxy group, an isopropylphenoxy group, a 4-t-butylphenoxy group, a naphthoxy group, and a biphenyloxy group.

Examples of an amino group include a dimethylamino group, a diethylamino group, a dibutylamino group, a dioctylamino group, a N-methyl-N-hexylamino group, a dicyclohexylamino group, a diphenylamino group, and a N-methyl-N-phenylamino group.

As R²¹ through R²³, an alkyl group, an aryl group, an alkoxy group, and an aryloxy group are preferable. In respect of the effects of the invention, it is preferable that at least one of R²¹ through R²³ is an alkyl group or an aryl group, and it is more preferable that two or more are alkyl groups or aryl groups. In addition, in respect of inexpensive availability, the case where R²¹ through R²³ are the same groups is preferable.

Specific examples of a hydrogen-bonding compound including a compound of the general formula (D) of the invention will be shown below, but the invention is not limited to them.

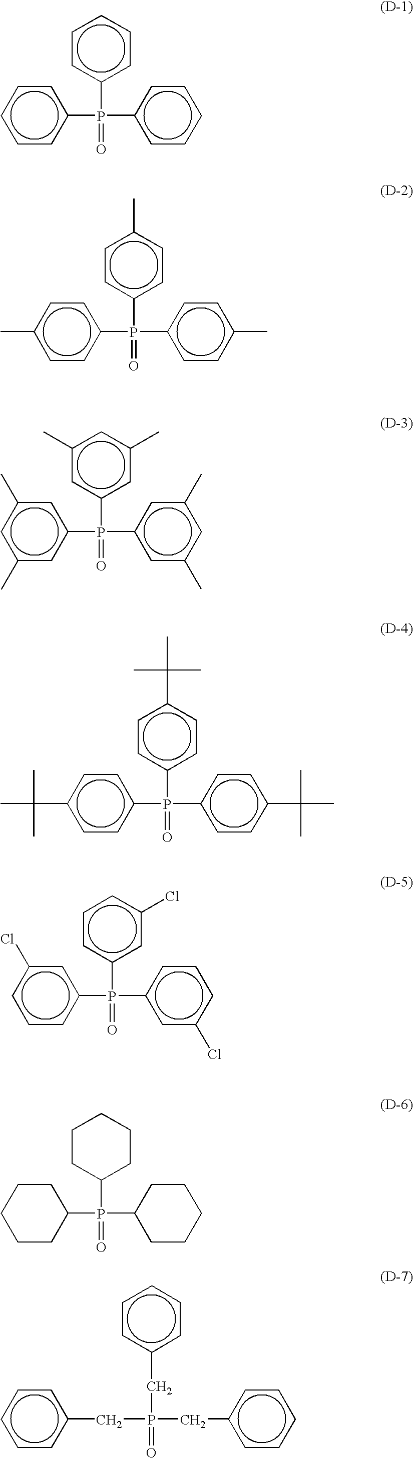

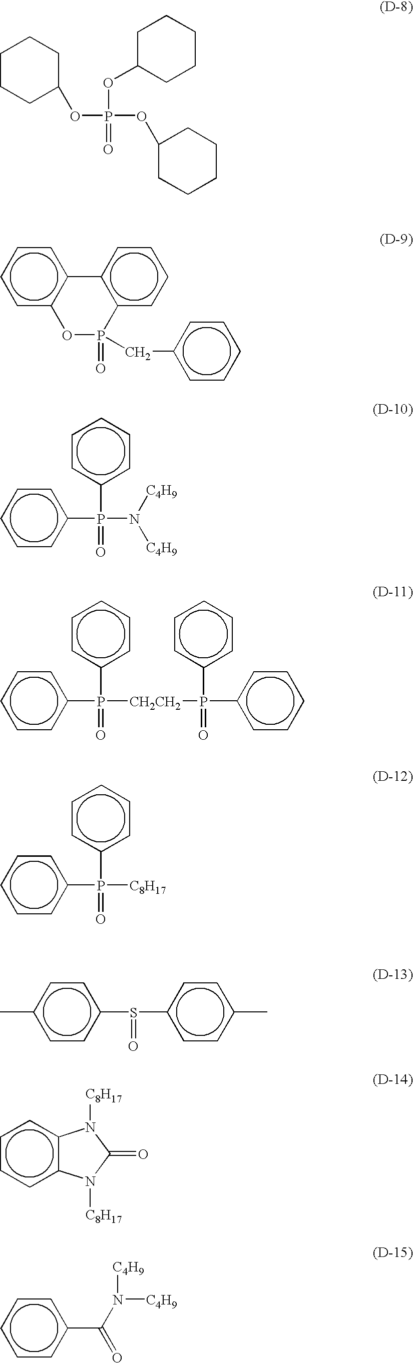

In addition to the foregoing, specific examples of a hydrogen-bonding compound include those described in EP Laid-Open No. 1096310, TP-A No. 2002-156727, and JP-A No. 2001-124796.

A compound of the general formula (D) of the invention, like a reducing agent, can be contained in a coating solution as a solution form, an emulsion dispersion form, or a solid dispersion fine particle dispersion form and can be used in a photosensitive material, and it is preferable to use as a solid dispersion. The compound of the invention forms a hydrogen-bonding complex with a compound having a phenolic hydroxy group or an amino group in the solution form, and can be isolated in the crystal form as a complex depending on a combination of a reducing agent with a compound of the general formula (D) of the invention.

It is particularly preferable that the thus isolated crystal is used as a solid dispersion fine particle dispersion in order to obtain the stable performance. Alternatively, a method of mixing a reducing agent and a compound of the general formula (D) of the invention in the form of a powder, to form a complex using a proper dispersing agent by means of a sand grinder mill or the like at dispersing can be also used preferably.

A compound of the general formula (D) of the invention is used in a range of preferably 1 to 200 mol%, more preferably 10 to 150 mol %, even more preferably 20 to 100 mol % relative to a reducing agent.

(Explanation of Silver Halide)

1) Halogen Composition

The halogen composition of photosensitive silver halide used in the invention is not particularly limited, but silver chloride, silver bromide chloride, silver bromide, silver bromide iodide, silver bromide chloride iodide, and silver iodide can be used. Inter alia, silver bromide, silver bromide iodide and silver iodide are preferable. Distribution of the halogen composition in a particle may be uniform, the halogen composition may be changed in a step-wise, or may be changed continuously. Alternatively, a silver halide particle having a core/shell structure can be preferably used. A preferable structure is a 2 to 5 layered structure, and a core/shell particle of a 2 to 4 layered structure can be used more preferably. Alternatively, the technique of localizing silver bromide or silver iodide on the surface of a silver chloride, silver bromide or silver bromide chloride particle can be also used preferably.

2) Particle Forming Method

A method of forming photosensitive silver halide is well known in the art and, for example, methods described in Research Disclosure No. 17029, June 1978, and U.S. Pat. No. 3,700,458 can be used. Specifically, a method of preparing photosensitive silver halide by adding a silver donor compound and a halogen donor compound to a solution of gelatin or other polymer and, thereafter, mixing it with an organic silver salt is used. In addition, a method described in paragraph numbers 0217 to 0224 of JP-A No. 11-119374, and a method described in JP-A Nos. 11-352627 and 2000-347335 are preferable.

3) Particle Size

For the purpose of reducing whitening cloud after image formation, a particle size of photosensitive silver halide is preferably small, specifically 0.20 μm or smaller, more preferably not smaller than 0.10 μm and not greater than 0.15 μm, and more preferably not smaller than 0.02 μm and not greater than 0.12 μm. As used herein, a particle size refers to a diameter when converted into a circular image having the same area as that of a projected area (in the case of a plate particle, a projected area of a main plane) of a silver halide particle.

4) Particle Formation

Examples of a silver halide shape include a cube, an octahedron, a plate-like particle, a spherical particle, a bar-like particle, a potato-like particle and the like. In the invention, a cubic particle is particularly preferable. A particle in which corners of a silver halide particle are rounded can be also used preferably. Index of plane (Miller index) of the outer surface of a photosensitive silver halide particle is not particularly limited, but it is preferable that a rate of occupation of a [100] plane having the high photospectroscopic sensitizing efficiency when a photospectroscopic sensitizing dye is absorbed thereon, is high. The rate is preferably 50% or more, more preferably 65% or more, further preferably 80% or more. A rate of a Miller index [100] plane can be obtained by a method described in T. Tani; J. Imaging Sci., 29, 165(1985) utilizing absorbing dependency of a [111] plane and a [100] plane in absorption of a sensitizing pigment.

5) Heavy Metal

The photosensitive silver halide particle of the invention can contain metals of Group 8 to Group 10 in Periodic Table (indicating Group 1 to Group 18) or complexes of those metals. The metals of Group 8 to Group 10 in Periodic Table or a central metal for the metal complexes is preferably rhodium, ruthenium and iridium. These metal complexes may be of one kind, or two or more kinds of the complexes of the same metal or different metals may be used in combination. A preferable content is in a range of 133 10⁻⁹ mole to 1×10⁻³ mole relative to 1 mole of silver. These heavy metals and metal complexes, and a method of adding them are described in JP-A No. 7-225449, JP-A No. 11-65021, paragraph numbers 0018 to 0024, and JP-A No. 11-119374, paragraph numbers 0227 to 0240.

In the invention, a silver halide particle in which a hexacyano metal complex is present on the surface is preferable. As the hexacyano metal complex, there are [Fe(CN)₆]⁴⁻, [Fe(CN)₆]³⁻, [Ru(CN)₆]⁴⁻. [Os(CN)₆]⁴⁻, [Co(CN)₆]³⁻, [Rh(CN)₆]³⁻, [Ir(CN)₆]³⁻, [Cr(CN)₆]³⁻, and (Re(CN)₆]³⁻. In the invention, a hexacyano Fe complex is preferable.

Since the hexacyano metal complex is present in a form of an ion in an aqueous solution, a counter positive ion is not important, but it is preferable to use alkali metal ions such as a sodium ion, a potassium ion, a rubidium ion, a cesium ion and a lithium ion, an ammonium ion, an alkylammonium ion (e.g. tetramethylammonium ion, tetraethylammonium ion, tetrapropylammonium ion, tetra(n-butyl)ammonium ion), which are suitable for procedures of precipitating a silver halide emulsion.

The hexacyano metal complex can be added by being mixed with a solvent mixture of water, and a suitable organic solvent which is miscible with water (e.g. alcohols, ethers, glycols, ketones, esters, amides etc.), or with gelatin.

An amount of the hexacyano metal complex to be added is preferably not smaller than 1×10⁻⁵ mole and not greater than 1×10⁻² mole, more preferably not smaller than 1×10⁻⁴ mole and not greater than 1×10⁻³ mole.

In order to have reside the hexacyano metal complex on the surface of a silver halide particle, after addition of an aqueous silver nitrate solution used for forming a particle is completed, before a chemical sensitization for performing chalcogen sensitization such as sulfur sensitization, selenium sensitization and tellurium sensitization or noble metal sensitization such as gold sensitization, the hexacyano metal complex is added directly before completion of a preparatory step, during a water washing step, during a dispersing step, or before a chemical sensitization step. In order that a silver halide fine particle is not grown, it is preferable to add the hexacyano metal complex rapidly after particle formation, and it is preferable to add it before completion of a preparatory step.

Addition of the hexacyano metal complex may be initiated after addition of a total amount of 96% by mass of silver nitrate which is added for particle formation, and the initiation after addition of 98% by mass is more preferable, and after addition of 99% by mass is particularly preferable.

When the hexacyano metal complex is added after addition of an aqueous silver nitrate solution immediately before completion of particle formation, the complex can be adsorbed on the outermost surface of a silver halide particle, and most of the complex forms a poorly soluble salt with a silver ion on the particle surface. Since this silver salt of hexacyano iron (II) is a salt which is more poorly soluble than AgI, redissolution due to a fine particle can be prevented, and it has become possible to prepare a silver halide fine particle having a small particle size.

Further, metal atoms which can be contained in a silver halide particle used in the invention (e.g. [Fe(CN)₆]⁴⁻), methods of desalting a silver halide emulsion and chemical sensitizing methods are described in JP-A No. 11-84574, paragraph numbers 0046 to 0050, JP-All-65021, paragraph numbers 0025 to 0031, and JP-A No. 11-119374, paragraph numbers 0242 to 0250.

6) Gelatin

As gelatin contained in a photosensitive silver halide emulsion used in the invention, various gelatins can be used. It is necessary to maintain the dispersed state of the photosensitive silver halide emulsion in an organic silver salt-containing coating solution better, and it is preferable to use gelatin having a molecular weight of 10,000 to 1,000,000. In addition, it is preferable to phthalate a substituent of gelatin. Although these gelatins may be used at particle formation or at dispersing after desalting treatment, it is preferable to use them at particle formation.

7) Sensitizing Pigment

A sensitizing pigment which can be applied to the invention is a pigment which can spectroscopically sensitize a silver halide particle at a desired wavelength region upon adsorption on a silver halide particle, and a sensitizing pigment having the spectroscopic sensitivity suitable for the spectroscopic property of an exposing light source can be advantageously selected. A sensitizing pigment and a method of adding the same are described in JP-A No. 11-65021, paragraph numbers 0103 to 0109, JP-A No. 10-186572, a compound represented by the general formula (II), JP-A No. 11-119374, a pigment represented by the general formula (I) and paragraph number 0106, U.S. Pat. Nos. 5,510,236, 3,871,887, a pigment described in Example 5, JP-A Nos. 2-96131, 59-48753, a pigment disclosed therein, EP Laid-Open No. 0803764A1, page 19 line 38 to page 20 line 35, JP-A Nos. 2001-272747, 2001-290238, 2002-23306 and the like. These sensitizing pigments may be used alone, or by combining two or more kinds. A time for adding a sensitizing pigment to a silver halide emulsion of the invention is preferably a time after a desalting step before coating, more preferable a time after desalting before completion of chemical ripening.

An amount of a sensitizing pigment to be added in the invention may be a desired amount depending on the sensitivity and the fog performance, and is preferably 10⁻⁶ to 1 mol, more preferably 10⁻⁴ to 10⁻¹ mol, per 1 mol of silver halide in a photosensitive layer,.

In the invention, in order to improve a spectroscopic sensitization efficacy, a supersensitizing agent can be used. Examples of the supersensitizing agent used in the invention include compounds described in EP Laid-Open No. 587,338, U.S. Pat. Nos. 3,877,943, 4,873,184, JP-A Nos. 5-341432, 11-109547, 10-111543 and the like.

8) Chemical Sensitization

It is preferable that the photosensitive silver halide particle of the invention is chemically sensitized by a sulfur sensitizing method, a selenium sensitizing method or a tellurium sensitizing method. As compounds which are preferably used in a sulfur sensitizing method, a selenium sensitizing method and a tellurium sensitizing method, the known compounds, for example, compounds described in JP-A No. 7-128768 can be used. In the invention, tellurium sensitization is particularly preferable, compounds described in JP-A No. 11-65021, paragraph number 0030, and compounds represented by the general formulae (II), (III) and (IV) in JP-A No. 5-313284 are more preferable.

It is preferable that the photosensitive silver halide particle of the invention is chemically sensitized using a gold sensitizing method solely or in combination with the above-mentioned chalcogen sensitization. As a gold sensitizing agent, gold having a valent number of +1 or +3 is preferable and, as a gold sensitizing agent, gold compounds which are normally used are preferable. As a representative example, auric acid chloride, auric acid bromide, potassium chloroaurate, potassium bromoaurate, auric trichloride, potassium auric thiocyanate, potassium iodeaurate, tetracyano auric acid, ammonium aurothiocyanate, and pyridyltrichlorogold are preferable. In addition, gold sensitizing agents described in U.S. Pat. No. 5858637, JP-A No. 2001-79450 are also used preferably.

In the invention, chemical sensitization is possible at any time as far as it is after particle formation and before coating, and can be, after desalting (1) before spectroscopic sensitization, (2) simulutaneously with spectroscopic sensitization, (3) after spectroscopic sensitization, or (4) immediately before coating.

Amounts of sulfur, selenium and tellurium sensitizing agents to be used in the invention vary depending on a silver halide particle to be used, chemical ripening conditions and the like, 10⁻⁸ to 10⁻² mol, preferably 10⁻⁷ to 10⁻³ mol per 1 mol of silver halide is used.

An amount of a gold sensitizing agent to be added varies depending on various conditions, and a standard is from 10⁻⁷ mol to 10⁻³ mol, more preferably from 10⁻⁶ mol to 5×10⁻⁴mol per 1 mole of silver halide.

Conditions for chemical sensitization of the invention are not particularly limited, but pH is from 5 to 8, pAg is from 6 to 11, a temperature is approximately 40 to 95° C.

A thiosulfonic acid compound may be added to a silver halide emulsion used in the invention by a method disclosed in EPA 293,917.

It is preferable that, in the photosensitive silver halide particle of the invention, a reduction sensitizing agent is used. As a specific compound for a reduction sensitizing method, ascorbic acid and thiourea dioxide are preferable and, besides, it is preferable to use stannous chloride, aminoiminomethanesulfinic acid, a hydrazine derivative, a borane compound, a silane compound, a polyamine compound or the like. A reduction sensitizing agent may be added at any stage of a photosensitive emulsion preparing step from crystal growth to preparation step immediately before coating. In addition, it is preferable to perform reduction sensitization by ripening while maintaining pH of an emulsion at 7 or higher or pHg of an emulsion at 8.3 or lower, and it is also preferable to perform reduction sensitization by introducing a single addition part of a silver ion during particle formation.

A compound, of a first embodiment of the invention, in which a one electron-oxidized compound produced by one electron oxidation of the compound can release one or more electrons, will be explained.

It is preferable that the thermally developable photosensitive material of the invention contains a compound in which a one electron-oxidized compound produced by one electron oxidation of the compound can release one or more electrons. The compound is used alone or in conjunction with the above-mentioned various chemical sensitizing agents, which can result in increase in the sensitivity of silver halide.

A compound in which a one electron-oxidized compound produced by one electron oxidation of the compound can release one or more electrons contained in the thermally developable photosensitive material of the invention refers to a compound selected from the following types 1 to 5.

(Type 1)

A compound in which a one electron-oxidized compound produced by one electron oxidization of the compound is accompanied with a subsequent bond cleavage reaction, and can further release two or more electrons.

(Type 2)

A compound in which a one electron-oxidized compound produced by one electron oxidization of the compound is accompanied with a subsequent bond cleavage reaction, and further can release one more electron, and which has two or more groups which are adsorbable to silver halide in the same molecule.

(Type 3)

A compound in which a one electron-oxidized compound produced by one electron oxidation of the compound, after a subsequent bond forming process, can release one or more electrons,

(Type 4)

A compound in which a one electron-oxidized compound produced by one electron oxidization of the compound, after a subsequent intramolecular ring cleavage reaction, can further release one or more electrons.

(Type 5)

A compound represented by X-Y in which a one electron- oxidized compound produced by one electron oxidization of the reducing group represented by X is accompanied with a subsequent X-Y bond cleavage reaction, leaving of Y and X radical formation, becoming able to further release one more electron, wherein X denotes a reducing a group and Y denotes a leaving group,.

Among the above-mentioned compounds of type 1 and types 3 to 5, preferred is a “compound having a group which is adsorbable onto silver halide in a molecule” or a “compound having a partial structure of a spectroscopic sensitizing dye in a molecule”. More preferred is a “compound having a group which is adsorbable onto silver halide in a molecule”. Compounds of types 1 to 4 are more preferably “compounds having, as an adsorptive group, a nitrogen-containing heterocyclic group substituted with two or more mercapto groups”.

Compounds of types 1 to 5 will be explained in detail.

In the compound of type 1, a “bond cleavage reaction” means specifically cleavage of bond between respective elements of carbon-carbon, carbon-silicon, carbon-hydrogen, carbon-boron, carbon-tin, and carbon-germanium, and maybe further accompanied with cleavage of a carbon-hydrogen bond. The compound of type 1 is a compound which is one electron-oxidized to become a one electron-oxidized compound and, thereafter, is accompanied with a bond cleavage reaction for the first time, and can further release two or more (preferable three or more) electrons.

Among compounds of type 1, a preferable compound is represented by the general formula (A), the general formula (B), the general formula (1), the general formula (2) or the general formula (3).

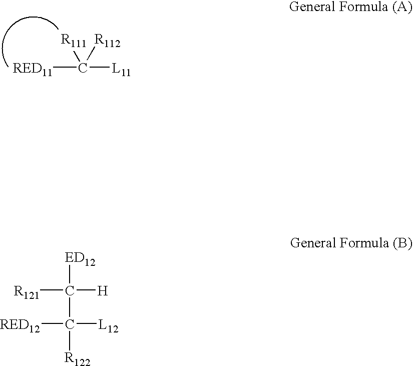

In the general formula (A), RED₁₁ represents a reducing group which can be one electron-oxidized, and L₁₁ represents a leaving group. R₁₁₂ represents a hydrogen atom or a substituent. R₁₁₁ represents a non-metal atomic group which can be taken together with a carbon atom (C) and RED₁₁ to form a cyclic structure corresponding to a tetrahydro compound, a hexahydro compound or an octahydro compound of a 5-membered or 6-menbered aromatic ring (including aromatic heterocycle).

In the general formula (B), RED₁₂ represents a reducing group which can be one electron-oxidized, and L₁₂ represents a leaving group. R₁₂₁ and R₁₂₂ represent a hydrogen atom or a substituent, respectively. ED₁₂ represents an electron-donating group. In the general formula (B), R₁₂₁ and RED₁₂, R₁₂₁ and R₁₂₂, or ED₁₂ and RED₁₂ may be connected to form a cyclic structure.

Compounds represented by these general formula (A) and general formula (B) are compounds in which a reducing group represented by RED₁₁ or RED₁₂ after one electron-oxidized, spontaneously leaves L₁₁ or L₁₂ by a bond cleavage reaction, whereby, accompanying this, two or more electrons, more preferably three or more electrons can be further released.

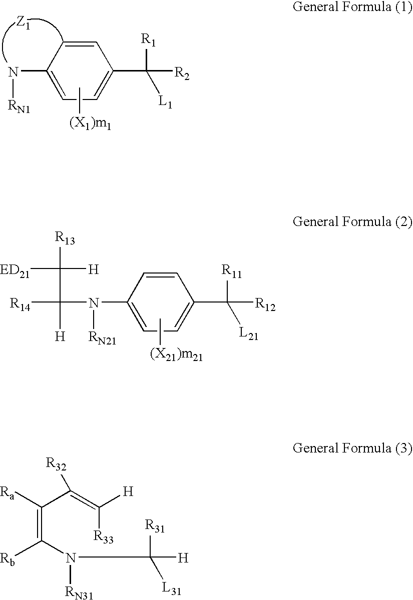

In the general formula (1), Z₁ represents an atomic group which can form a 6-membered ring together with a nitrogen atom and two carbon atoms of a benzene ring, R₁, R₂ and R_{N1} represent a hydrogen atom or substituent, respectively, X₁ represents a substituent substitutable on a benzen ring, m₁ represents an integer of 0 to 3, and L₁ represents a leaving group. In the general formula (2), ED₂₁ represents an electron-donating group, R₁₁, R₁₂, R_{N21}, R₁₃ and R₁₄ represent a hydrogen atom or a substituent, respectively, X₂₁ represents a substituent substitutable on a benzen ring, m₂₁ represents an integer of 0 to 3, and L₂₁ represents a leaving group. R_{N21}, R₁₃, R₁₄, X₂₁ and ED₂₁, may be bonded to each other to form a cyclic structure. In the general formula (3), R₃₂, R₃₃, R₃₁, R_{N31}, Rₐ and R_{b} represent a hydrogen atom or a substituent, respectively, and L₃₁ represents a leaving group. When R31 represents a group other than an aryl group, Rₐ and R_{b} are bonded to each other to form an aromatic ring.

These compounds are compounds which are one electron-oxidized, thereafter, spontaneously leave L₁, L₂₁ or L₃₁ by a bond cleavage reaction, whereby, accompanying this, can release further two or more electrons, preferably three or more electrons.

The compound represented by the general formula (A) will be explained in detail below.

In the general formula (A), a reducing group which can be one electron-oxidized and represented by RED₁₁ is a group which can bind with R₁₁₁ described later to form a particular ring, specifically a divalent group obtained by removing one hydrogen atom at a place suitable for ring formation from the following monovalent group. Examples thereof include an alkyl amino group, an aryl amino group (anilino group, naphthylamino group etc.), a heterocyclic amino group (benzthiazolylamino group, pyrrolylamino group etc.), an alkylthio group, an arylthio group (phenylthio group etc.), a heterocyclic thio group, an alkoxy group, an aryloxy group (phenoxy group etc.), a heterocyclic oxy group, an aryl group (phenyl group, naphthyl group, anthranyl group etc.), and an aromatic or non-aromatic heterocyclic group (5-membered to 7-membered monocyclic or fused heterocycle containing at least one hetero atom of a nitrogen atom, a sulfur atom, an oxygen atom and a selenium atom. Examples include a tetrahydroquinoline ring, a tetrahydroisoquinoline ring, a tetrahydroquinoxaline ring, a tetrahydroquinazoline ring, an indoline ring, an indole ring, an indazole ring, a carbazol ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzoimidazole ring, a benzoimidazoline ring, a benzooxazoline ring, a methylenedioxyphenyl ring and the like) (hereinafter, RED₁₁ is described as a monovalent name for a convenience). RED₁₁ may have a substituent.

In the invention, a substituent means a substituent selected from the following groups unless otherwise specified. Those groups are a halogen atom, an alkyl group (including aralkyl group, cycloalkyl group, active methine group etc.), an alkenyl group, an alkynyl group, an aryl group, a heterocyclic group (regardless of a replacing position), a heterocyclic group containing a quaternarized nitrogen atom (e.g. pyridinio group, imidazolio group, quinolinio group, isoquinolinio grioup), an acyl group, an alkoxycarbonyl group, an aryloxycarbonyl group, a carbamoyl group, a carboxy group or a salt thereof, a sulfonylcarbamoyl group, an acylcarbamoyl group, a sufamoylcarbamoyl group, a carbazoyl group, an oxalyl group, an oxamoyl group, a cyano group, a carbonimidoyl group, a thiocarbamoyl group, a hydroxyl group, an alkoxy group (including a group containing repeatedly an ethyleneoxy group unit or a propyleneoxy group unit), an aryloxy group, a heterocyclic oxy group, an acyloxy group, (alkoxy or aryloxy) carbonyloxy group, a carbamoyloxy group, a sulfonyloxy group, an amino group, (alkyl, aryl, or heterocyclic) amino group and an acylamino group, a sulfonamido group, an ureido group, a thioureido group, an imido group, (alkoxy or aryloxy) carbonylamino group, a sulfamoylamino group, a semicarbazide group, a thiosemicarbazide group, a hydrazino group, an ammonio group, an oxamoylamino group, (alkyl or aryl) sulfonylureido group, an acylureido group, an acylsulfamoylamino group, a nitro group, a mercapto group, (alkyl, aryl, or heterocyclic) thio group, (alkyl or aryl) sulfonyl group, (alkyl or aryl) sulfinyl group, a sulfo group or a salt thereof, a sulfamoyl group, an acylsulfamoyl group, a sulfonylsulfamoyl group or a salt thereof, a group containing phosphoric acid amido or phosphoric acid ester structure, and the like. These substituents may further substituted with theses substituents.

RED₁₁ is preferably an alkylamino group, an arylamino group, a heterocyclic amino group, an aryl group, or an aromatic or non-aromatic heterocyclic group, more preferable an arylamino group (in particular, anilino group), or an aryl group (in particular, phenyl group). When these have a substituent, a substituent is preferably a halogen atom, an alkyl group, an alkoxy group, a carbamoyl group, a sulfamoyl group, an acylamino group, or a sulfonamido group.

When RED₁₁ represents an aryl group, it is preferable that an aryl group has at least one “electron-donating group”. Here, an “electron-donating group” is a 5-membered monocyclic or fused electron-excessive aromatic heterocyclic group (e.g. indolyl group, pyrrolyl group, imidazolyl group, benzimidazolyl group, thiazolyl group, benzthiazolyl group, indazolyl group etc.), or a non-aromatic nitrogen-containing heterocyclic group to be substituted at the nitrogen atom (a group which can be called a cyclic amino group such as pyrrolidinyl group, indolinilyl group, piperidinyl group, piperazinyl group, morpholino group etc.), which contains in a ring at least one of a hydroxyl group, an alkoxy group, a mercapto group, a sulfonamido group, an acylamino group, an alkylamino group, an arylamino group, a heterocyclic amino group, an active methine group, and a nitrogen atom. Here, an active methine group means a methine group substituted with two “electron withdrawing groups”, wherein an “electron withdrawing group” means an acyl group, an alkoxy carbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. Here, two electron withdrawing groups may be bonded to each other to take a cyclic structure.

In the general formula (A), L₁₁ specifically represents a carboxy group or a salt thereof, a silyl group, a hydrogen atom, a triarylboron anion, a trialkylstanyl group, a trialkylgermyl group, or a —CR_{C1}R_{C2}R_{C3} group. Here, a silyl group specifically represents a trialkylsilyl group, an aryl dialkylsilyl group or a triarylsilyl group, and may have an arbitrary substituent.

When L₁₁ represents a salt of a carboxy group, examples of a counterion which forms a salt include an alkali metal ion, an alkaline earth metal ion, a heavy metal ion, an ammonium ion, and a phosphonium ion, preferably an alkali metal ion and an ammonium ion, most preferably an alkali metal ion (in particular, Li⁺, Na⁺ and K⁺ ions).

When L₁₁ represents a —CR_{C1}R_{C2}R_{C3} group, R_{C1}, R_{C2} and R_{C3} represent, independently, a hydrogen atom, an alkyl group, an aryl group, a heterocyclic group, an alkylthio group, an arylthio group, an alkylamino group, an arylamino group, a heterocyclic amino group, an alkoxy group, an aryloxy group, or a hydroxyl group, these may be bonded to each other to form a cyclic structure, and may have an arbitrary substituent. When one of R_{C1}, R_{C2} and R_{C3} represents a hydrogen atom or an alkyl group, remaining two do not represent a hydrogen atom or an alkyl group. R_{C1}, R_{C2} and R_{C3} are preferably, independently, an alkyl group, an aryl group (in particular, phenyl group), an alkylthio group, an arylthio group, an arlkylamino group, an arylamino group, a heterocyclic group, an alkoxy group, or a hydroxyl group, and specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, a N-methylanilino group, a diphenylamino group, a morpholino group, a thiomorpholino group, and a hydroxyl group. Examples of the case where these are bonded to each other to form a cyclic structure include a 1,3-dithiolan-2-yl group, a 1,3-dithian-2-yl group, a N-methyl-1,3-thiazolidin-2-yl group, and a N-benzyl-benzothiazolidin-2-yl group.

The —CR_{C1}R_{C2}R_{C3} group is selected in the above-mentioned range regarding R_{C1}, R_{C2} and R_{C3} and, as a result, the group can represent the same group as a residue obtained removing L₁₁ from the general formula (A), and such the case is also preferable.

In the general formula (A), L₁₁ is preferably a carboxyl group or a salt thereof, or a hydrogen atom, more preferably a carboxyl group or a salt thereof.

When L₁₁ represents a hydrogen atom, it is preferable that a compound represented by the general formula (A) has a base part which resides in a molecule. By the action of this base part, after the compound represented by the general formula (A) is oxidized, a hydrogen atom represented by L₁₁ is deprotonated and, therefrom, an electron is further released.

Here, a base is specifically a conjugate base of an acid exhibiting pKa of about 1 to 10. Examples thereof include a nitrogen containing heterocycles (pyridines, imidazoles, benzoimidazoles, thiazoles and the like), anilines, trialkylamines, amino group, carbon acids (active methylene anion and the like), thioacetic acid anion, carboxylate (—COO—), sulfate (—SO₃⁻), and amine oxide (>N⁺(O⁻)—). Preferable is a conjugate base of an acid exhibiting pKa of about 1 to about 8, and carboxylate, sulfate, and amine oxide are more preferable, and carboxylate is particularly preferable. When these bases have anion, they may have countercation, and examples thereof include an alkali metal ion, an alkaline earth metal ion, a heavy metal ion, an ammonium ion, a phosphonium ion. These bases are connected to the compound represented by the general formula (A) at an arbitrary position. A position at which these base parts bind may be any of RED₁₁, R₁₁₁ and R₁₁₂ in the general formula (A), and base parts may be connected to a substituent of these groups.

In the general formula (A), R₁₁₂ represents a hydrogen atom or a substituent replaceable at a carbon atom. R₁₁₂ does not represent the same group as that represented by L₁₁.

R₁₁₂ is preferably a hydrogen atom, an alkyl group, an aryl group (phenyl group etc.), an alkoxy group (methoxy group, ethoxy group, benzyloxy group etc.), a hydroxyl group, an alkylthio group (methylthio group, butylthio group etc.), an amino group, an alkylamino group, an arylamino group, or a heterocyclic amino group, more preferably a hydrogen atom, an alkyl group, an alkoxy group, a hydroxyl group, a phenyl group, or an alkylamino group.

In the general formula (A), a cyclic structure formed by R₁₁₁ refers to a cyclic structure corresponding to a tetrahydro compound, a hexahydro compound or an octahydro compound of a 5-membered or 6-membered aromatic ring (including aromatic hetercocycle), wherein a hydro compound means a structure in which a carbon-carbon double bond (or carbon-nitrogen double bond) residing in an aromatic ring (including aromatic heterocycle) is partially hydrogenated, a tetrahydro compound means a structure in which two carbon-carbon double bonds (or carbon-nitrogen double bonds) are hydrogenated, a hexahydro compound means a structure in which three carbon-carbon double bonds (or carbon-nitrogen double bonds) are hydrogenated, and an octahydro compound means a structure in which four carbon-carbon double bonds (or carbon-nitrogen double bonds) are hydrogenated. By hydrogenation, an aromatic ring becomes a partially hydrogenated non-aromatic ring structure.

Specifically, examples thereof are a pyrrolidine ring, an imidazolidine ring, a thiazolidine ring, a pyrazolidine ring and an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, a tetrahydroquinazoline ring, and tetrahydroquinoxaline ring, a tetrahydrocarbazole ring, an octahydrophenanthridine ring, and the like. These ring structures may have an arbitrary substituent.

More preferable examples of a ring structure formed by R₁₁₁ include a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, tetrahydroquinoxaline ring, a tetrahydrocarbazole ring, particularly preferable examples include a pyrrolidine ring, a piperidine ring, a piperazine ring, a tetrahydropyridine ring, a tetrahydroquinoline ring, a tetrahydroisoquinoline ring, a tetrahydroquinazoline ring, and a tetrahydroquinoxaline ring, and most preferable examples include a pyrrolidine ring, a piperidine ring, a tetrahydropyridine ring, a tetrahydroquinoline ring, and a tetrahydroisoquinoline ring.

In the general formula (B), RED₁₂ and L₁₂ are groups having the same meanings as those of RED₁₁ and L₁₁ in the general formula (A) respectively, and the preferable range of RED₁₂ and L₁₂ are same as those of RED₁₁ and L₁₁. However, RED₁₂ is monovalent except for formation of the following cyclic structure, specifically, there are groups having the monovalent group names described for RED₁₁. R₁₂₁ and R₁₂₂ are groups having the same meanings as those for R₁₁₂ in the general formula (A), and a preferable range thereof is the same as that for R₁₁₂. ED₁₂ represents an electron-donating group. R₁₂₁ and RED₁₂, R₁₂₁ and R₁₂₂, or ED₁₂ and RED₁₂ may be bonded to each other to form a cyclic structure.

In the general formula (B), an electron-donating group represented by ED₁₂ is the same as the electron-donating group explained as a substituent when RED₁₁ represents an aryl group. Preferable examples of ED₁₂ include a 5-membered monocyclic or fused electron-excessive aromatic heterocyclic group, a non-aromatic nitrogen-containing heterocyclic group to be substituted at the nitrogen atom, which contain, in a ring, at least one of a hydroxyl group, an alkoxy group, a mercapto group, a sulfonamido group, an alkylamino group, an arylamino group, an active methine group, and a nitrogen atom, and a phenyl group substituted with these electron-donating groups, more preferably, a non-aromatic nitrogen-containing heterocyclic group substituted with a hydroxyl group, a mercapto group, a sulfonamido group, an alkylamino group, an arylamino group, an active methine group, or a nitrogen atom, and a phenyl group substituted with these electron-donating groups (e.g. p-hydroxyphenyl group, p-dialkylaminophenyl group, o,p-dialkoxyphenyl group etc.).

In the general formula (B), R₁₂₁ and RED₁₂, R₁₂₂ and R₁₂₁, or ED₁₂ and RED₁₂ may be bonded to each other to form a cyclic ring. A cyclic structure formed herein refers to a non-aromatic carbocyclic or heterocyclic 5-membered to 7-membered monocyclic or fused substituted or unsubstituted cyclic structure. When R₁₂₁ and RED₁₂ form a cyclic structure, examples thereof include, in addition to examples of the cyclic structure formed by R₁₁₁ in the general formula (A), a pyrroline ring, an imidazoline ring, a thiazoline ring, a pyrazoline ring, an oxazoline ring, an indane ring, a morpholine ring, an indoline ring, a tetrahydro- 1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, a 2,3-dihydrobenzothiophene ring and the like. When ED₁₂ and RED₁₂ form a cyclic structure, ED₁₂ represents preferably an amino group, an alkylamino group, or an arylamino group, and examples of a formed cyclic structure include a tetrahydropyrazine ring, a piperazine ring, a tetrahydroxyquinoxaline ring, and a tetrahydroisoquinoline ring. When R₁₂₂ and R₁₂₁ form a cyclic structuere, examples thereof include a cyclohexane ring, and cyclopentane ring.

Then, the general formulae (1) to (3) will be explained.

In the general formulae (1) to (3), R₁, R₂, R₁₁, R₁₂ and R₃₁ are groups having the same meanings as those for R₁₁₂ in the general formula (A), and a preferable range thereof is the same. L₁, L₂₁ and L₃₁ represent the same leaving groups as those exemplified as embodiments when L₁₁ s explained in the general formula (A), and a preferable range is the same. Substituents represented by X₁ and X₂₁ are the same as those when RED₁₁ has a substituent in the general formula (A), and a preferable range is the same. Preferably, m₁ and m₂₁ are an integer of 0 to 2, more preferably 0 or 1.

When R_{N1}, R_{N21}, and R_{N31} represent a substituent, as a substituent, an alkyl group, an aryl group and a heterocvclic group are preferable, these may have further an arbitrary substituents. R_{N1}, R_{N21} and R_{N31} are preferably a hydrogen atom, an alkyl group or an aryl group, more preferably a hydrogen atom or an alkyl group.

When R₁₃, R₁₄, R₃₃, Rₐ and R_{b} represent a substituent, preferable examples of a substituent include an alkyl group, an aryl group, an acyl group, an alkoxycarbonyl group, carbomoyl group, a cyano group, an alkoxy group, an acylamino group, a sulfonamido group, an ureido group, a thioureido group, an alkylthio group, an arylthio group, an alkylsulfonyl group, an arylsulfonyl group, and a sulfamoyl group.

A 6-membered ring formed by Z₁ in the general formula (1) is a non-aromatic heterocycle which is fused with a benzene ring of the general formula (1), and examples of a cyclic structure including a fused benzene ring, include a tetrahydroquinoline ring, a tetrahydroquinoxaline ring, and a tetrahydroquinazoline ring, preferably, a tetrahydroquioline ring, and a tetrahydroquinoxaline ring. These may have a substituent.

ED₂₁ in the general formula (2) is a group having the same meaning as that of ED₁₂ in the general formula (B), and a preferable range thereof is the same.

Any two of R_{N21}, R₁₃, R₁₄, X₂₁ and ED₂₁ in the general formula (2) may be bonded to each other to form a cyclic structure. Here, a cyclic structure formed when R_{N21} and X₂₁ are bonded to each other, is preferably a 5-membered to 7-membered non-aromatic carbocycle or heterocycle, and examples thereof include a tetrahydroquinoline ring, a tetrahydroquinoxaline ring, an indoline ring, and a 2,3-dihydro-5,6-benzo-1,4-thazine ring. Preferable are a tetrahydroquinoline ring, a tetrahydroquinoxaline ring, and an indoline ring.

When R_{N31} represents a group other than an aryl group in the general formula (3), Rₐ and R_{b} are bonded to each other to form a aromatic ring. Here, an aromatic ring refers to an aryl group (e.g. phenyl group, naphthyl group) and an aromatic heterocyclic group (e.g. pyridine ring group, pyrrole ring group, quinoline ring group, indole ring group etc.), and an aryl group is preferable. The aromatic ring group may have an arbitrary substituent.

In the general formula (3), Rₐ and R_{b} are preferably bonded to each other to form an aromatic ring (in particular, phenyl group).

In the general formula (3), R₃₂ is preferably a hydrogen atom, an alkyl group, an aryl group, a hydroxyl group, an alkoxy group, a mercapto group, or an amino group. When R₃₂ represents a hydroxyl group R₃₃ preferably represents an “electron withdrawing group” at the same time. Here, an “electron withdrawing group” is the same as that explained previously, and an acyl group, an alkoxycarbonyl group, a carbamoyl group, and a cyano group are preferable.

Then, compounds of type 2 will be explained.

In the type 2 compounds, a “bond cleavage reaction” means cleavage of a bond between respective elements of carbon-carbon, carbon-silicon, carbon-hydrogen, carbon-boron, carbon-tin, carbon-germanium, and cleavage of carbon-hydrogen may accompany them.

The type 2 compound is a compound which has 2 or more (preferably 2 to 6, more preferably 2 to 4) groups adsorbable onto silver halide in a molecule. More preferable is a compound which has, as an adsorptive group, a nitrogen-containing group substituted with 2 or more mercapto groups. The number of adsorptive groups is preferably 2 to 6, further preferably 2 to 4. The adsorptive group will be explained later.

Among type 2 compounds, a preferable compound is represented by the general formula (C).

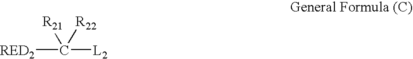

Here, the compound represented by the general formula (C) is a compound which after one electron oxidization of a reducing group represented by RED₂, spontaneously leaves L₂ by a bond cleavage reaction and, accompanying this, can further release one electron.

RED₂ in the general formula (C) represents a group having the same meaning as that of RED₁₂ in the general formula (B), and a preferable range thereof is the same. L₂ represents a group having the same meaning as that of L₁₁ in the general formula (A), and a preferable range thereof is the same. In addition, when L₂ represents a silyl group, the compound is a compound which has, as an adsorptive group, a nitrogen-containing heterocyclic group substituted with 2 or more mercapto groups in a molecule. R₂₁ and R₂₂ represent a hydrogen atom or a substituent, these are groups having the same meanings as that of R₁₂ in the general formula (A), and a preferable range thereof is the same. RED₂ and R₂₁ may be bonded to each other to form a cyclic structure.

Here, a formed cyclic structure refers to a 5-membered to 7-membered monocyclic or fused non-aromatic carbocycle or heterocycle, and may have s substituent. The cyclic structure is not a cyclic structure corresponding to a tetrahydro compound, a hexahydro compound or an octahydro compound of an aromatic ring or an aromatic heterocycle. A cyclic structure is preferably a cyclic structure corresponding to a dihydro compound of an aromatic ring or an aromatic heterocycle, and examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzooxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, and a 1,2-dihydroquinoxaline ring, preferably a 2-imidazoline ring, a 2-thiazoline ring, an indoline ring, a benzoimidazoline ring, a benzothiazoline ring, a benzooxazoline ring, a 1,2-dihydropyridine ring, a 1,2-dihydroquinoline ring, a 1,2-dihydroquinazoline ring, and a 1,2-dihydroquinoxaline ring, more preferably an indoline ring, a benzoimidazoline ring, a benzothiazoline ring, a 1,2-dihydroquinoline ring, particularly preferably an indoline ring.

Then, compounds of type 3 will be explained.

The “bond forming process” in compounds of type 3 means formation of a bond between atoms such as carbon-carbon, carbon-nitrogen, carbon-sulfur, and carbon-oxygen.

The type 3 compound is preferably a compound in which one electron-oxidized compound produced by one electron oxidation is subsequently reacted with a reactive group part (carbon-carbon double bond part, carbon-carbon triple bond part, aromatic group part, or non-aromatic heterocyclic group part of a benzo-fused ring) coexisting in a molecule, to form a bond and, further, one or more electrons can be released.

To describe in more detail, in the type 3 compound, a one electron-oxidized compound (cation radical species, or neutral radical species produced therefrom by leaving of a proton) produced by one electron oxidation is reacted with the above-mentioned reactive group coexisting in the same molecule, to form a bond, thereby, a radical species having a ring structure is newly produced in a molecule. And, there are the characteristics that a second electron is released from this radical species directly or accompanying leaving of a proton.

And, further, among compounds of type 3, thereafter, or after undergoing a hydrolysis reaction in some cases, or directly in some cases, the thus produced two electron oxidized-compound causes a tautomerizing reaction accompanied with transfer of a proton, and further one or more, usually two or more electrons are released therefrom in some cases. Alternatively, there are included compounds having the ability to release further one or more, usually two or more electrons directly from a two electron-oxidized compound without via such the tautomerizing reaction.

The type 3 compound is preferably represented by the general formula (D).

RED₃—L₃—Y₃ General Formula (D)

In the general formula (D), RED₃ represents a reducing group which can be one electron-oxidized, and Y₃ represents a reactive group part which reacts with RED₃ after one electron oxidization, specifically, represents an organic group containing a carbon-carbon double bond part, a carbon-carbon triple bond part, an aromatic group part, or a benzo-fused cyclic non-aromatic heterocyclic group part. L₃ represents a tethering group for tethering RED₃ and Y₃.

RED₃ represents a group having the same meaning as that of RED₁₂ in the general formula (B), preferably an arylamino group, a heterocyclic amino group, an aryloxy group, an arylthio group, an aryl group, or an aromatic or non-aromatic heterocyclic group (in particular, a nitrogen-containing heterocyclic group is preferable), further preferably an arylamino group, a heterocyclic amino group, an aryl group, or an aromatic or non-aromatic heterocyclic group. Among them, regarding a heterocyclic group, a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzimidazole ring group, a benzimidazoline ring group, a benzothiazoline ring group, and a 3,4-methylenedioxyphenyl-1-yl group are preferable.

Particularly preferable RED₃ is an arylamino group (in particular, anilino group), an aryl group (in particular, phenyl group), or an aromatic or non-aromatic heterocyclic group.

Here, when RED₃ represents an aryl group, it is preferable that an aryl group has at least one “electron-donating group”. An “electron-donating group” is the same as that explained previously.

When RED₃ represents an aryl group, a substituent for the aryl group is more preferably an alkylamino group, a hydroxyl group, an alkoxy group, a mercapto group, a sulfonamido group, an active methine group, or a non-aromatic nitrogen-containing heterocyclic group to be substituted at the nitrogen atom, further preferably an alkylamino group, a hydroxyl group, an active methine group, or a non-aromatic nitrogen-containing heterocyclic group to be substituted at the nitrogen atom, most preferably an alkylamino group, or a non-aromatic nitrogen-containing heterocyclic group to be substituted at the nitrogen atom.

When an organic group containing a carbon-carbon double bond part (e.g. vinyl group) represented by Y₃ has a substituent, a substituent therefor is preferably an alkyl group, a phenyl group, an acyl group, a cyano group, an alkoxycarbonyl group, a carbamoyl group, or an electron-donating group. Here, an electron-donating group is preferably an alkoxy group, a hydroxyl group (optionally protected with a silyl group, such as trimethylsilyloxy group, t-butyldimethylsilyloxy group, triphenylsilyloxy group, triethylsilyloxy group, and phenyldimethylsilyloxy group), an amino group, an alkylamino group, an arylamino group, a sulfonamido group, an active methine group, a mercapto group, an alkylthio group, or a phenyl group having these electron-donating groups as a substituent.

Here, when an organic group containing a carbon-carbon double bond part has a hydroxyl group as a substituent, Y₃ becomes to contain a partial structure: >C₁═C₂(—OH)—, and this may be tautomerized into a partial structure: >C₁H—C₂(═O)—. Further, in this case, the case where a substituent replaceable at the C₁ carbon is an electron withdrawing group, is also preferable and, in this case, Y₃ becomes to have a partial structure of an “active methylene group” or an “active methine group”. An electron withdrawing group which can give such the partial structure of an active methylene group or an active methine group is the same as that explained for the above-mentioned “active methine group”.

When an organic group containing a carbon-carbon triple bond part (e.g. ethynyl group) represented by Y₃ has a substituent, as the substituent, an alkyl group, a phenyl group, an alkoxycarbonyl group, a carbamoyl group, and an electron-donating group are preferable.

When Y₃ represents an organic group containing an aromatic group part, preferable examples of an aromatic group include an aryl group (in particular, a phenyl group is preferable) and an indole ring group which have an electron-donating group as a substituent. Here, examples of a preferable donor group include a hydroxyl group (optionally protected with a silyl group), an alkoxy group, an amino group, an alkylamino group, an active methine group, a sulfonamido group, and a mercapto group.

When Y₃ represents an organic group containing a benzo-fused cyclic non-aromatic heterocyclic group part, examples of a preferable benzo-fused cyclic non-aromatic heterocyclic group include groups having an aniline structure as a partial structure therein, such as an indoline ring group, a 1,2,3,4-tetrahydroquinoline ring group, a 1,2,3,4-tetrahydroquinoxaline ring group, and a 4-quinolone ring group.

A more preferable reactive group represented by Y₃ is an organic group containing a carbon-carbon double bond part, an aromatic group part, or a benzo-fused cyclic non-aromatic heterocyclic group. Further preferable are a carbon-carbon double bond part, a phenyl group having an electron-donating group as a substituent, an indole ring group, and a benzo-fused cyclic non-aromatic heterocyclic group having an aniline group as a partial structure therein. Here, it is more preferable that a carbon-carbon double bond part has at least one electron-donating group as a substituent.

As a result of selection of a reactive group represented by Y₃ from the above-explained range, the case where the reactive group has the same partial structure as a reducing group represented by RED₃ is also a preferable example of a compound represented by the general formula (D).

L₃ represents a tethering group for tethering RED₃ and Y₃, specifically, represents each group of an alkylene group, an arylene group, a heterocyclic group, —O—, —S—, —NRN—, —C(═O)—, —SO₂—, —SO—, and —P(═O)—, or a group comprising a combination of these groups. Here, R_{N} represents a hydrogen atom, an alkyl group, an aryl group, or a heterocyclic group. A tethering group represented by L₃ may have an arbitrary substituent. A tethering group represented by L₃ can be tethered at an arbitrary position of groups represented by RED₃ and Y₃ in the form of substitution with an arbitrary one hydrogen atom of each of them.

Preferable examples of L₃ include a single bond, an alkylene group (in particular, methylene group, ethylene group, propylene group), an arylene group (in particular, phenylene group), a —C(═O)— group, a —O— group, a —NH— group, a —N(alkyl group)-group, and a divalent tethering group comprising a combination of these groups.

In a group represented by L₃, when a cation radical species (X⁺.) produced by oxidation of RED₃, or a radical species (X.) produced therefrom accompanied with leaving of a proton, and a reactive group represented by Y₃ are reacted to form a bond, it is preferable that an atomic entity involved in this can form a 3 to 7-membered cyclic structure including L₃. For this, it is preferable that a radical species (X⁺. or X.), a reactive group represented by Y, and L are tethered by 3 to 7 atomic entities.

Then, compounds of type 4 will be explained.

A type 4 compound is a compound having a cyclic structure substituted with a reducing group, wherein after the reducing group is one electron oxidized, one or more electrons can further be released accompanied with a cleavage reaction of a ring structure. As used herein, a cleavage reaction of a ring structure means a manner represented by the following:

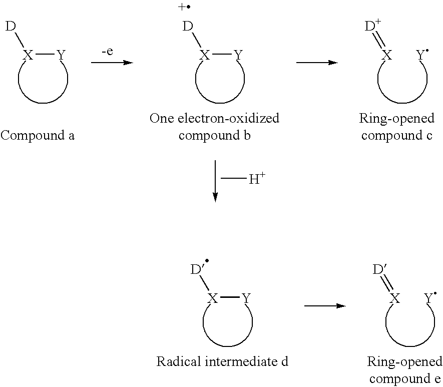

In the formula, the compound a represents a type 4 compound. In the compound a, D represents a reducing group, and X and Y represent atoms forming a bond which is to be cleaved after one electron oxidation, in a cyclic structure. First, the compound a is one electron-oxidized to produce a one electron- oxidized compound b. Therefrom, a single bond of D-X is converted into a double bond and, at the same time, a bond of X—Y is cut to produce a ring-opened compound c. Or, a radical intermediate d is produced from a one electron-oxidized compound b accompanied with leaving of a proton and, therefrom, a ring-opened compound e is produced similarly in some cases. The compound in the present invention is characterized in that, from the thus produced ring-opened compound c or e, subsequently one or more electrons arc further released.

A cyclic structure possessed by the type 4 compound represents a 3 to 7-membered carbocyclic or heterocyclic, monocyclic or fused-cyclic, saturated or unsaturated, non-aromatic ring. Preferable is a saturated cyclic structure, and more preferable is a 3-membered ring or a 4-membered ring. Examples of a preferable cyclic structure include a cyclopropane ring, a cyclobutane ring, an oxirane ring, an oxetane ring, an aziridine ring, an azetidine ring, an episulfide ring, and a thietane ring. More preferable are a cyclopropane ring, a cyclobutane ring, an oxirane ring, an oxetane ring, and an azitidine ring, and particularly preferable are a cyclopropane ring, a cyclobutane ring, and an azetidine ring. A cyclic structure may have an arbitrary substituent.

The type 4 compound is preferably represented by the general formula (E) or (F).

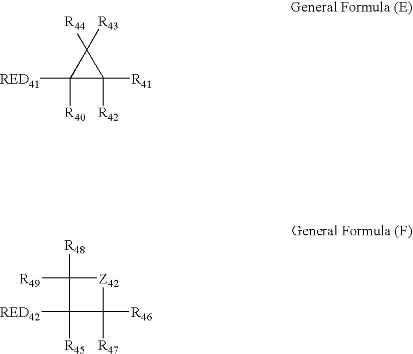

In the general formula (E) and the general formula (F), RED₄₁ and RED₄₂ represent groups having the same meanings as those of RED₁₂ in the general formula (B), respectively, and a preferable range thereof is also the same. R₄₀ to R₄₄ and R₄₅ to R₄₉ represent a hydrogen atom or a substituent, respectively. In the general formula (F), Z₄₂ represents —CR₄₂₀R₄₂₁—, —NR₄₂₃—, or —O—. Here, R₄₂₀ and R₄₂₁ represent a hydrogen atom or a substituent, respectively, and R₄₂₃ represents a hydrogen atom, an alkyl group, an aryl group or a heterocyclic group.

In the general formula (E) and the general formula (F), R₄₀ and R₄₅ represent preferably a hydrogen atom, an alkyl group, an aryl group, or a heterocyclic group, more preferably a hydrogen atom, an alkyl group, or an aryl group. R₄₁ to R₄₄ and R₄₆ to R₄₉ are preferably a hydrogen atom, an alkyl group, an alkenyl group, an aryl group, a heterocyclic group, an arylthio group, an alkylthio group, an acylamino group, or a sulfonamido group, more preferably a hydrogen atom, an alkyl group, an aryl group, or a heterocyclic group.

As to R₄₁ to R₄₄, it is preferable that at least one of them is a donor group, or R₄₁ and R₄₂, or R₄₃ and R₄₄ are both an electron withdrawing group. More preferably, at least one of R₄₁ to R₄₄ is a donor group. Further preferably, at least one of R₄₁ to R₄₄ is a donor group, and a group which is not a donor group among R₄₁ to R₄₄ is a hydrogen atom or an alkyl group.

As used herein, a donor group is an “electron-donating group”, or an aryl group substituted with at least one electron-donating group”. A 5-membered monocyclic or fused-cyclic electron-excessive aromatic heterocyclic group which preferably comprises at least one of a nitrogen atom, an alkylamino group, an arylamino group and a heterocyclic amino group in the ring as a donor group, or a non-aromatic nitrogen-containing heterocyclic group to be substituted at the nitrogen atom, or a phenyl group substituted with at least one electron-donating group is used. More preferably, a 5-membered monocyclic or fused-cyclic electron-excessive aromatic heterocyclic group containing at least one of an alkylamino group, an arylamino group; and a nitrogen atom in a ring (indole ring, pyrrole ring, carbazole ring), or a phenyl group substituted with an electron-donating group (phenyl group substituted with 3 or more alkoxy groups, phenyl group substituted with hydroxyl group, alkylamino group or arylamino group etc.) is used. Particularly preferably, a 5-membered monocyclic or fused-cyclic electron-excessive aromatic heterocyclic group containing at least one of an arylamino group, and a nitrogen atom in a ring (in particular, 3-indolyl group), or a phenyl group substituted with an electron-donating group (in particular, trialkoxyphenyl group, phenyl group substituted with alkylamino group or arylamino group) is used.

Z₄₂ is preferably —CR₄₂₀R₄₂₁— or —NR₄₂₃—, more preferably —NR₄₂₃—. R₄₂₀ and R₄₂₁ are preferably a hydrogen atom, an alkyl group, an aryl group, a heterocyclic group, an acylamino group, or a sulfonamino group, more preferably a hydrogen atom, an alkyl group, an aryl group, or a heterocyclic group. R₄₂₃ represents preferably a hydrogen atom, an alkyl group, an aryl group, or an aromatic heterocyclic group, more preferably a hydrogen atom, an alkyl group, or an aryl group.

When respective groups of R₄₀ to R₄₉ and R₄₂₀, R₄₂₁ and R₄₂₃ are substituents, a total carbon number of 40 or fewer is preferable, a total carbon number of 30 or fewer is more preferable, and a total carbon number of 15 or fewer is particularly preferable for the respective groups. Alternatively, these substituents may be bonded to each other mutually, or with another part in a molecule (RED₄₁, RED₄₂ or Z₄₂) to form a ring.

In type 1 to 4 compounds in the invention, an adsorptive group toward silver halide is a group which is directly adsorbed onto silver halide, or a group which promotes adsorption onto silver halide, specifically, a mercapto group (or a salt thereof), a thione group (—C(═S)—), a heterocyclic group containing at least one atom selected from a nitrogen atom, a sulfur atom, a selenium atom and a tellurium atom, a sulfide group, a cationic group, or an ethynyl group. In the type 2 compound in the invention, a sulfide group is not included in an adsorptive group.

A mercapto group (or a salt thereof) as an adsorptive group means a mercapto group (or a salt thereof) itself and, at the same time, represents more preferably a heterocyclic group, an aryl group or an alkyl group which is substituted with at least one mercapto group (or salt thereof). Here, a heterocyclic group is a 5-membered to 7-membered monocyclic or fused cyclic, aromatic or non-aromatic, heterocyclic group, and examples thereof include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like. In addition, an example may be heterocyclic group containing a quaternarized nitrogen atom and, in this case, a substituted mercapto group may be dissociated into a mesoion, and examples of such the heterocyclic group include a imidazolium ring group, a pyrazolium ring group, a thiazolium ring group, a triazolium ring group, a tetrazolium ring group, a thiadiazolium ring group, a pyridinium ring group, a pyrimidinium ring group, and a triadinium ring group and, inter alia, a triazolium ring group (e.g. 1,2,4-triazolium-3-thiolate ring group) is preferable. Examples of an aryl group include a phenyl group and a naphthyl group. Examples of an alkyl group include a linear or branched or cyclic alkyl group having a carbon number of 1 to 30. When a mercapto group forms a salt, examples of a counterion include cations such as an alkali metal, an alkaline earth metal and a heavy metal (Li^{+,} Na⁺, K^{+,} Mg²⁺, Ag⁺, Zn²⁺ etc.), an ammonium ion, a heterocyclic group containing a quaternarized nitrogen atom, and a phosphonium ion.

A mercapto group as an adsorptive group may be further tautomerized into a thione group, and examples thereof include a thioamido group (here, —C(═S)—NH group), and a group containing a partial group of the thioamido group, that is, a linear or cyclic thioamido group, a thioureido group, a thiourethane group, or a dithiocarbamic acid ester group. Here, examples of cyclic include a thiazolidine-2-thione group, an oxazolidine-2-thione group, a 2-thiohydantoin group, a rhodanine group, an isorhodanine group, a thiobarbituric acid group and a 2-thioxo oxazolidine-4-on group.

A thione group as an adsorptive group includes, in addition to the aforementioned case where a mercapto group is tautomerized into a thione group, a linear or cyclic thioamido group, thioureido group, thiourethane group, and dithiocarbamic acid ester group, which can not be tautomerized into a merapto group (have not a hydrogen atom at an α-position on a thione group).

A heterocyclic group containing at least one selected from a nitrogen atom, a sulfur atom, a selenium atom and a tellurium atom as an adsorptive group is a nitrogen-containing heterocyclic group having, as a partial structure of a heterocycle, a —NH— group which can form an iminosilver (>NAg), or a heterocyclic group having, as a partial structure of a heterocycle, a “—S—” group, a “—Se—” group, a “—Te—” group or a “═N—” group which can be coordinated on a silver ion with a coordinating bond, and examples of the former include a benzotriazole group, a triazole group, an indazole group, a pyrazole group, a tetrazole group, a benzimidazole group, an imidazole group, and a purine group, and examples of the latter include a thiophene group, a thiazole group, an oxazole group, a benzothiazole group, a benzooxazole group, a thiadiazole group, an oxadiazole group, a triazine group, a selenoazole group, a benzselenoazole group, a telluruazole group, and a benztelluruazole group. Preferable is the former.

A sulfide group as an adsorptive group includes all groups having a partial structure of “—S—”, preferably a group having a partial structure of alkyl(or alkylene)-S-alkyl(or alkylene), aryl(or arylene)-S-alkyl (or alkylene), or aryl(or arylene)-S-aryl(or arylene). Further, these sulfide groups may form a cyclic structure, or may become to be a —S—S— group. Examples of formation of a cyclic structure include a thiolane ring, a 1,3-dithiolane ring or a 1,2-dithiolane ring, a thian ring, a dithian ring, and a tetrahydro-1,4-thiazine ring (thiomorpholine ring). A sulfide group is particularly preferably a group having a partial structure of alkyl(or alkylene)-S-alkyl(or alkylene).

A cationic group as an adsorptive group means a group containing a quaternarized nitrogen atom, specifically a group containing a nitrogen-containing heterocyclic group containing an ammonio group or a quaternarized nitrogen atom. However, the cationic can not be a part of an atomic group for forming a pigment structure (e.g. cyanine color developing entity). Here, examples of an ammonio group include a trialkylammonio group, a dialkylarylammonio group, and an alkyldiarylammonio group, such as a benzyldimethylammonio group, a trihexylammonio group, and a phenyldiethylammonio group. Examples of a nitrogen-containing heterocyclic group containing a quaternarized nitrogen atom include a pyridinio group, a quinolinio group, an isoquinolinio group, and an imidazolio group, preferably a pyridinio group and an imidazolio group, particularly preferably a pyridinio group. These nitrogen-containing heterocyclic groups containing a quaternarized nitrogen may have an arbitrary substituent and in the case of a pyridinio group and an imidazolio group, examples of a substituent include preferably an alkyl group, an aryl group, an aminoacyl group, a chlorine atom, an alkoxycarbonyl group, and a carbamoyl group and, in the case of a pyridinio group, examples of a substituent include particularly preferably a phenyl group.

An ethynyl group as an adsorptive group means a —C≡CH group, and a hydrogen atom may be substituted.

The above-mentioned adsorptive group may have an arbitrary substituent.

As embodiment of the adsorptive group include those described in JP-A No. 11-95355, pages 4 to 7.

Preferable examples of the adsorptive group in the invention include a mercapto-substituted nitrogen-containing heterocyclic group (e.g. 2-mercaptothiadiazole group, 3-mercapto-1,2,4-triazole group, 5-mercaptotetrazole group, 2-mercapto-1,3,4-oxadiazole group, 2-mercaptobenzoxazole group, 2-mercaptobenzthiazole group, 1,5-dimethyl- 1,2,4-triazolium-3-thiolate group etc.), and a nitrogen-containing heterocyclic group having, as a partial structure of a heterocycle, a —NH— group which can form iminosilver (>Nag) (e.g. benzotriazole group, benzimidazole group, indazole group etc.). Particularly preferable are a 5-mercaptotetrazole group, 3-mercapto-1,2,4-triazole group, and a benzotriazole group, and most preferable are 3-mercapto-1,2,4-triazole and a 5-mercaptotetrazole group.

Among compounds in the invention, a compound having two or more mercapto groups as a partial structure in a molecule is also a particularly preferable compound. Here, a mercapto group (—SH) may be a thione group when it can be tautomerized. Examples of such the compound may be a compound which may have two or more adsorptive groups having the aforementioned mercapto group or thione group as a partial structure (e.g. a ring forming thioamido group, alkylmercapto group, arylmercapto group, heterocyclic mercapto group etc.) in a molecule, or a compound having one or more adsorptive groups having, as a partial structure, two or more mercapto groups or thione groups among adsorptive groups (e.g dimercapto-substituted nitrogen-containing hetrocyclic group).

Examples of an adsorptive group having two or more mercapto groups as a partial structure (dimercapto-substituted nitrogen-containing heterocyclic group etc.) include a 2,4-dimercaptopyrimidine group, a 2,4-dimercaptotriazine group, a 3,5-dimercapto- 1,2,4-triazole group, a 2,5-dimercapto- 1,3-thiazole group, a 2,5-dimercapto-1,3-oxazole group, 2,7-dimercapto-5-methyl-s-triazolo(1,5-A)-pyrimidine, 2,6,8-trimercaptopurine, 6,8-dimercaptopurine, 3,5,7-trimercapto-s-triazolotriazine, and 4,6-dimercaptopyrazolopyrimidine, 2,5-dimercaptoimidazole, particularly preferably a 2,4-dimercaptopyrimidine group, a 2,4-dimercaptotriazine group, and a 3,5-dimercapto-1,2,4-triazole group.

An adsorptive group may be replaceable at any position of the general formulae (A) to (F) and the general formulae (1) to (3), and it is preferably replaceable at RED₁₁, RED₁₂, RED₂ or RED₃ in the general formulae (A) to (D), at RED₄₁, R₄₁, RED₄₂ or R₄₆ to R₄₈ in the general formulae (E) and (F), and at any position except for R₁, R₂, R₁₁, R₁₂, R₃₁, L₁, L₂₁ and L₃₁ in the general formulae (1) to (3), and, further, it is more preferably replaceable at RED₁₁ to RED₄₂ in all of the general formulae (A) to (F).

A partial structure of a spectroscopic sensitizing dye is a group containing a choromophore of a spectroscopic sensitizing dye, and is a residue in which an arbitrary hydrogen atom or a substituent is removed from a spectroscopic sensitizing dye compound. A partial structure of a spectroscopic sensitizing dye may be replaced at any position of the general formulae (A) to (F) and the general formulae (1) to (3), and it is preferably replaceable at RED₁₁, RED₁₂, RED₂ or RED₃ in the general formulae (A) to (D), at RED₄₁, R₄₁, RED₄₂ or R₄₆ to R₄₈ in the general formulae (E) and (F), and at any position except for R₁, R₂, R₁₁, R₁₂, R₃₁, L₁, L₂₁ and L₃₁ in the general formulae (1) to (3), and, further, it is more preferably replaceable at RED₁₁ to RED₄₂ in all of the general formulae (A) to (F). A preferable spectroscopic sensitizing dye is a spectroscopic sensitizing dye which is typically used in the color sensitizing technique and includes, for example, cyanine dyes, composite cyanine dyes, merocyanine dyes composite merocyanine dyes, same polar cyanine dyes, styryl dyes, and hemicyanine dyes. Representative spectroscopic sensitizing dyes are disclosed in Research Disclosure, Item36544, September in 1994. A person skilled in the art can synthesize these pigments according to the procedures described in the above-mentioned Research Disclosure or F. M. Hamer, The Cyanine dyes and Related Compounds (Interscience Publishers, New York, 1964). Further, all dyes described in JP-A No.1 1-95355 (U.S. Pat. No. 6,054,260), specification, pages 7 to 14 are applicable.

It is preferable that compounds of types 1 to 4 in the invention have a total carbon number in a range of 10 to 60, more preferably 15 to 50, more preferably 18 to 40, particularly preferably 18 to 30.

Compounds of types 1 to 4 in the invention are one electron-oxidized by trigger by exposure of a silver halide photographic photosensitive material comprising them and, after a subsequent reaction, one more electron or, in some types, two or more electrons are released, resulting in oxidation. An oxidation potential at first electron is preferably about 1.4 V or less, further preferably 1.0 V or less. This oxidation potential is preferably higher than 0 V, more preferably higher than 0.3 V. Therefore, an oxidation potential is preferably in a range of about 0 to about 1.4 V, more preferably about 0.3 to about 1.0 V.

Herein, an oxidation potential can be measured by the technique of cyclic voltammetry, specifically, the potential is measured by dissolving a sample in a solution of acetonitrile: water (containing 0.1 M lithium perchlorate)=80%:20% (volume %), bubbling a nitrogen gas for 10 minutes and, thereafter, measuring at 25° C. and at 0.1 V/sec potential scanning rate using a glass-like carbon disc as a working electrode, using a platinum wire as a counter electrode, and using a calomel electrode (SCE) as a reference electrode. At a peak potential of a cyclic voltammetry wave, oxidation potential vs. SCE is taken.

When compounds of types 1 to 4 in the invention are a compound which is one electron-oxidized and, after a subsequent reaction, releases one more electron, an oxidation potential at this later stage is preferably −0.5 V to −2 V, more preferably −0.7 V to −2 V, further preferably −0.9 V to −1.6 V.

When compounds of types 1 to 4 in the invention are a compound which is one electron-oxidized and, after a subsequent reaction, releases further two or more electrons while oxidized, an oxidation potential at this later stage is not particularly limited. The reason is that it is difficult to actually measure them accurately and discriminate them in many cases, in that an oxidation potential at a second electron and an oxidation potential at a third electron and thereafter, can not be clearly discriminated.

Then, a type 5 compound will be explained.

A type 5 compound is represented by X—Y wherein X represents a reducing group and Y represents a leaving group, and is a compound in which a one electron-oxidized compound produced by one electron oxidation of a reducing group represented by X leaves Y accompanied by a subsequent cleavage reaction of a X—Y bond, to generate a X radical and, therefrom, one electron can be further released. A reaction where such the type 5 compound is oxidized can be represented by the following equation.

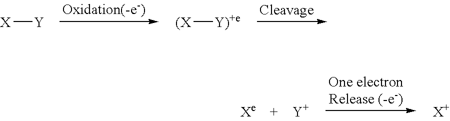

The type 5 compound has an oxidation potential of preferably 0 to 1.4 V, more preferably 0.3 V to 1.0 V. An oxidation potential of a radical X·generated in the above reaction equation is preferably −0.7 V to −2.0 V, more preferably −0.9 V to −1.6 V.

The type 5 compound is preferably represented by the general formula (G).

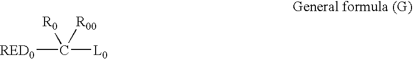

In the general formula (G), RED₀ represents a reducing group, Lo represents a leaving group, and R₀ and R₀₀ represent a hydrogen atom or a substituent. RED₀ and R₀, or R₀ and R₀₀ may be bonded to each other to form a cyclic structure. RED₀ represents a group having the same meaning as that of RED₂ in the general formula (C), and a preferable range thereof is the same. R₀ and R₀₀ are groups having the same meanings as those of R₂₁ and R₂₂ in the general formula (C), and a preferable range thereof is the same. R₀ and R₀₀ do not represent a group having the same meaning as that of L₀ except in a case of a hydrogen atom. RED₀ and R₀ may be bonded to each other to form a cyclic group. And examples of a cyclic structure include the same examples as those of the case where RED₂ and R₂₁ in the general formula (C) are bonded to each other to form a cyclic structure, and a preferable range thereof is the same. Examples of a cyclic structure formed by mutual binding of R₀ and R₀₀ include a cyclopentane ring and a tetrahydrofuran ring. In the general formula (G), L₀ is a group having the same meaning as that of L₂ in the general formula (C), and a preferable range thereof is the same.

It is preferable that a compound represented by the general formula (G) has an adsorptive group toward silver halide or a partial structure of a spectroscopic sensitizing dye in a molecule. Provided that when L₀ represents a group other than a silyl group, the compound does not have two or more adsorptive groups in a molecule at the same time. However, a sulfide group as an adsorptive group may have two or more of them regardless of L₀.

Examples of an adsorptive group toward silver halide possessed by a compound represented by the general formula (G) include the same examples as those of an adsorptive group which may be possessed by compounds of types 1 to 4 in the invention. Additionally, all groups described as a “silver halide adsorptive group” in JP-A No. 11-95355, pages 4 to 7, and a preferable range thereof is the same.

A partial structure of a spectroscopic sensitizing dye which may be possessed by a compound represented by the general formula (G) is the same as a partial structure of a spectroscopic sensitizing dye which may be possessed by compounds of types 1 to 4 in the invention. Examples thereof include all partial structures described as a “light absorbing group” also in JP-A No. 11-95355, pages 7 to 14, and a preferable range thereof is the same.

Compounds of types 1 to 5 in the invention will be exemplified below, but the invention is not limited by them.

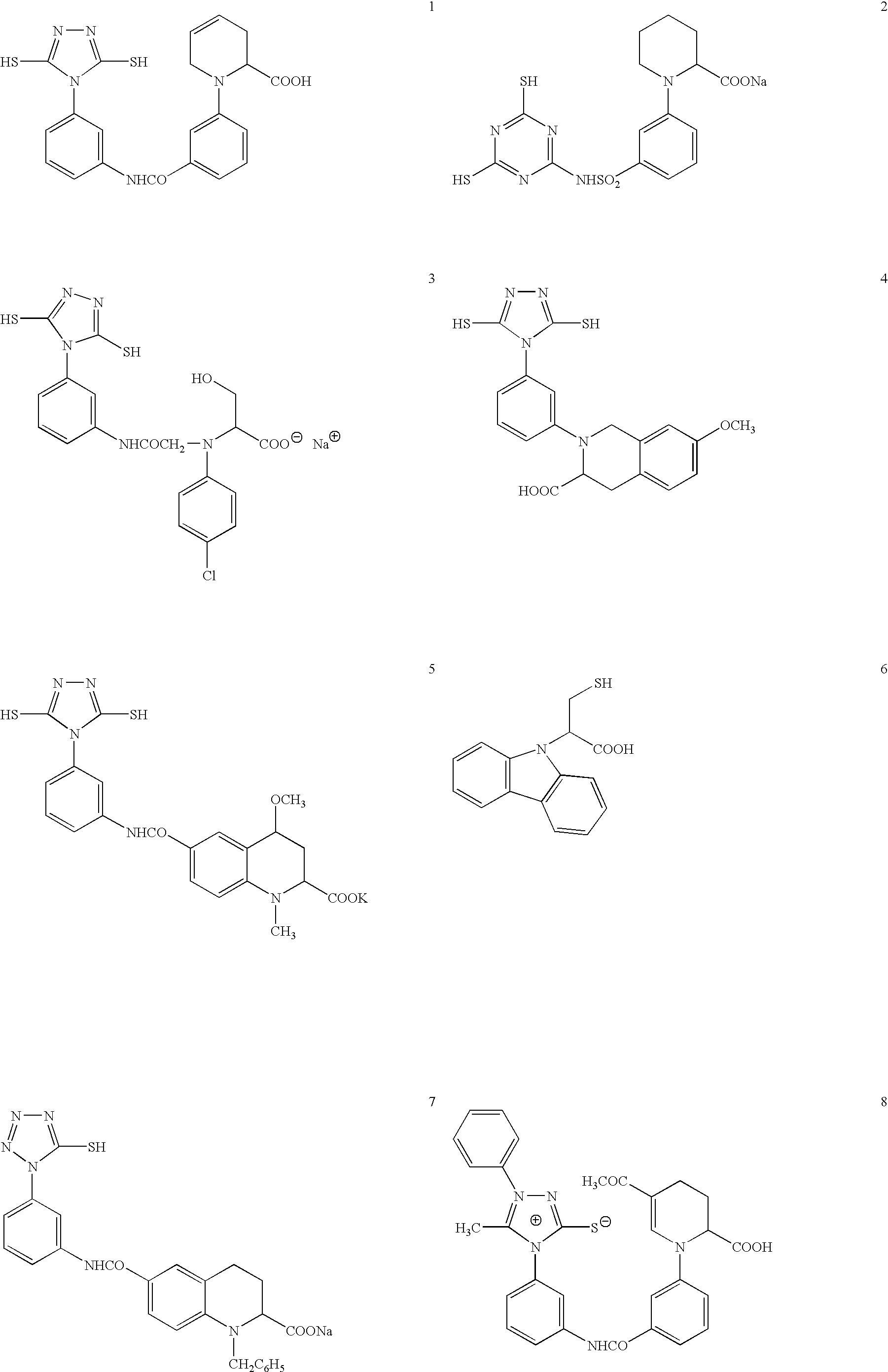

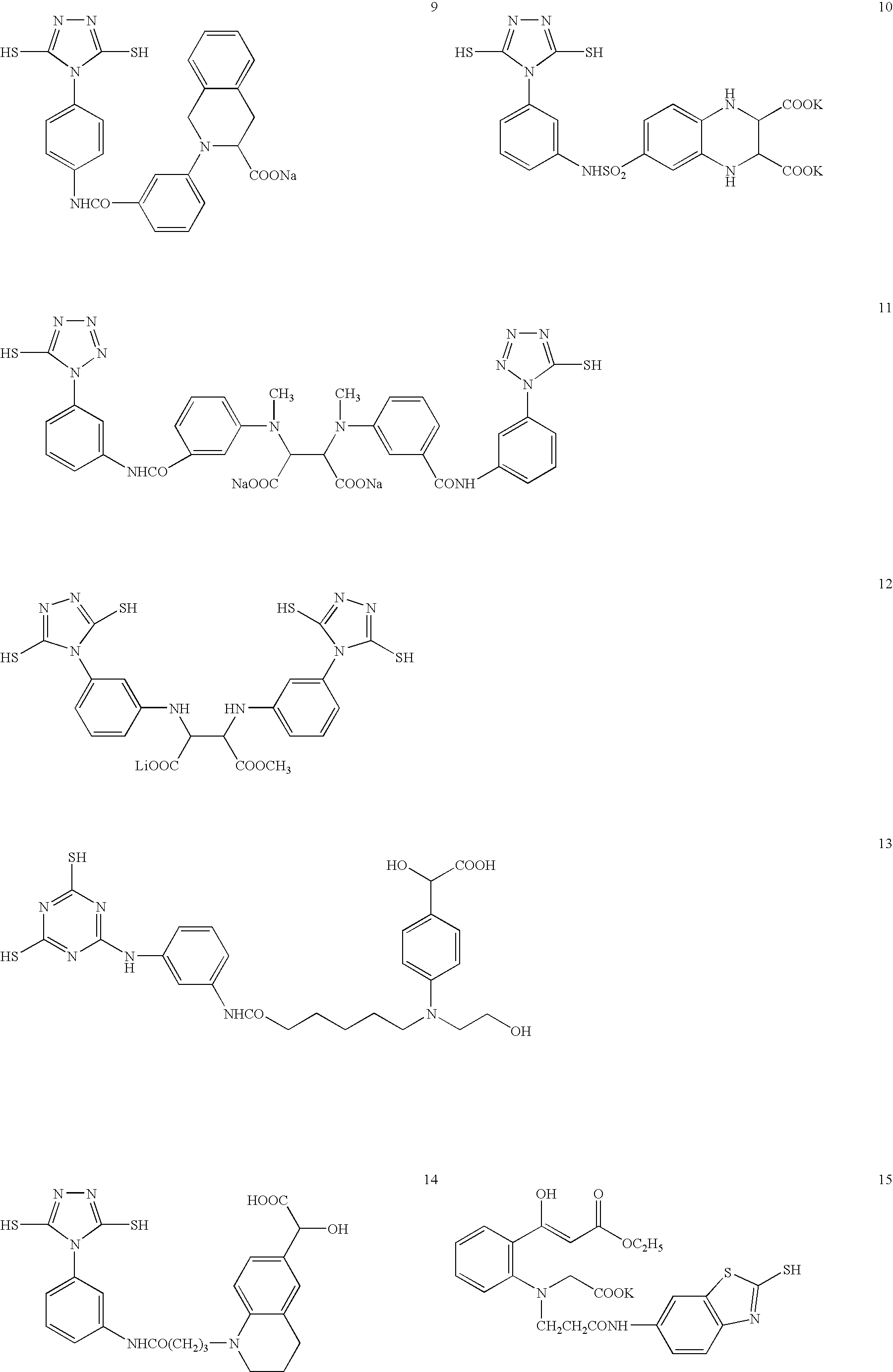

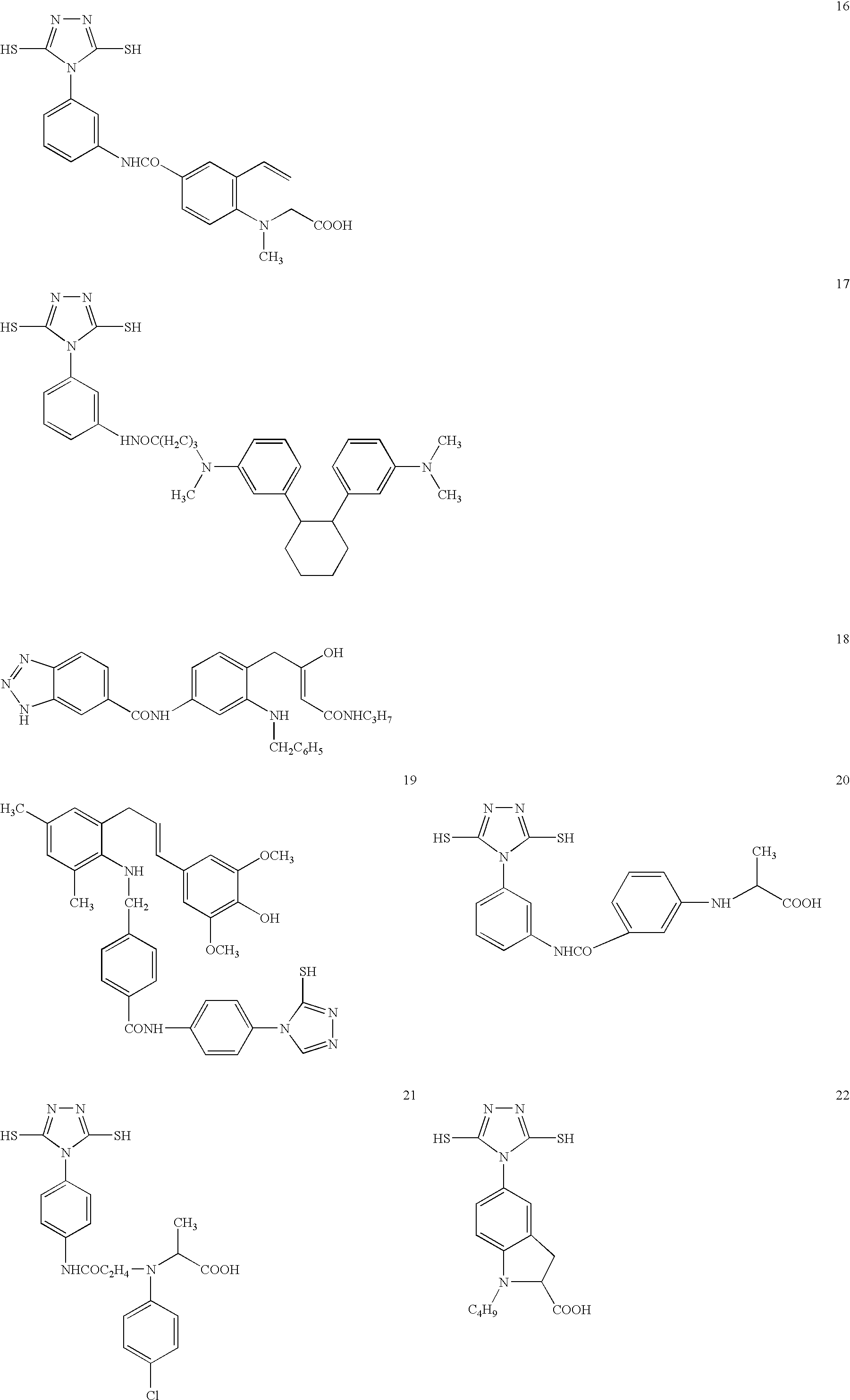

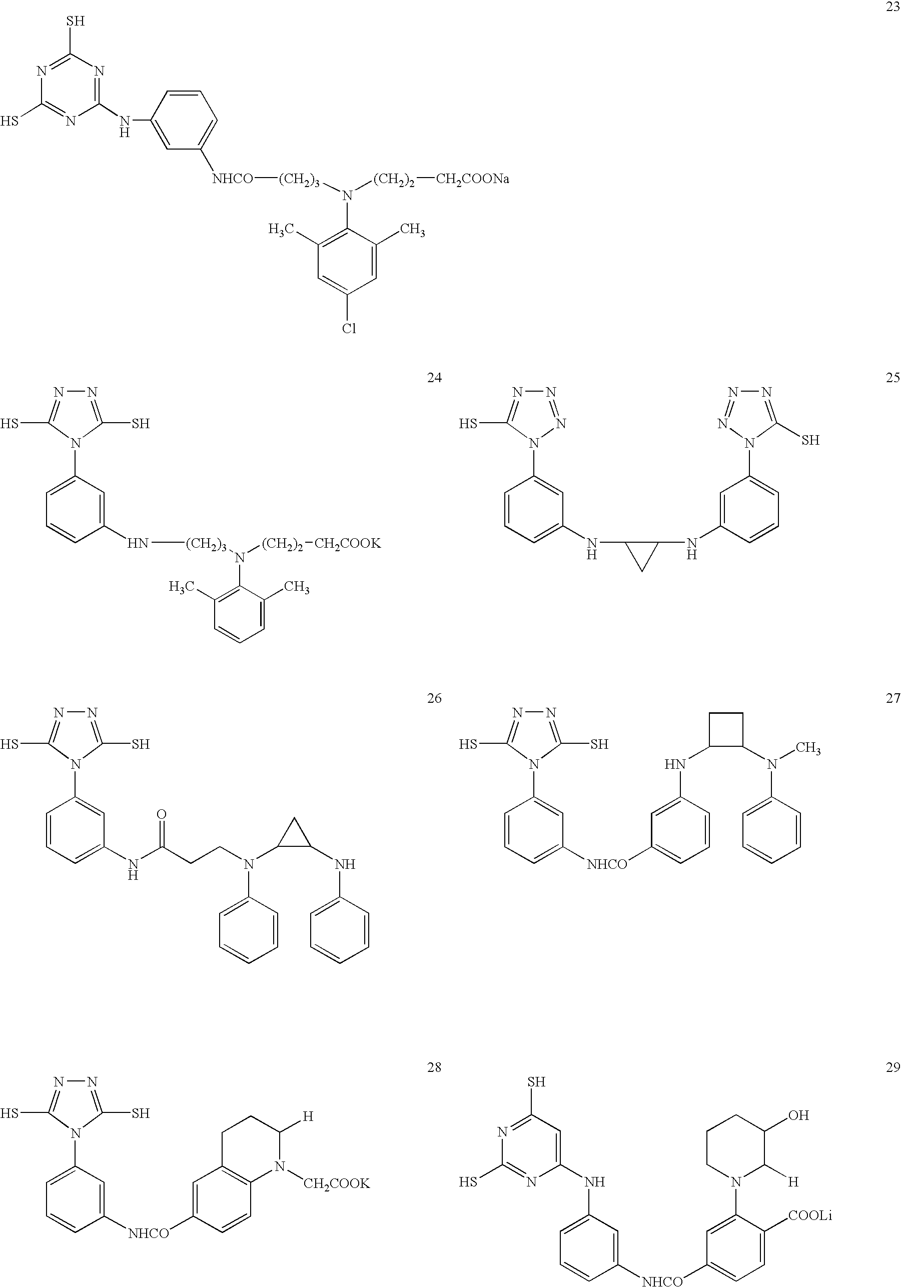

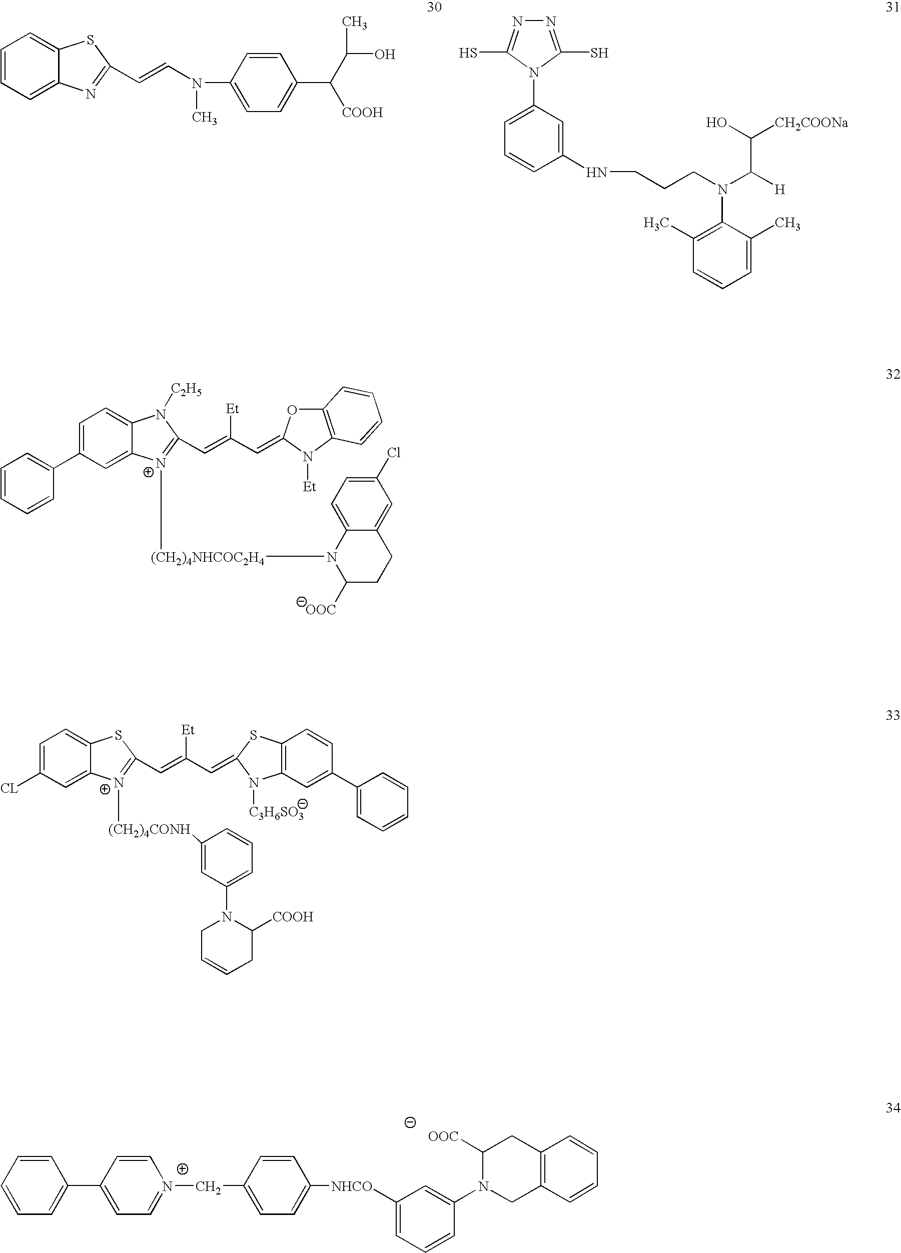

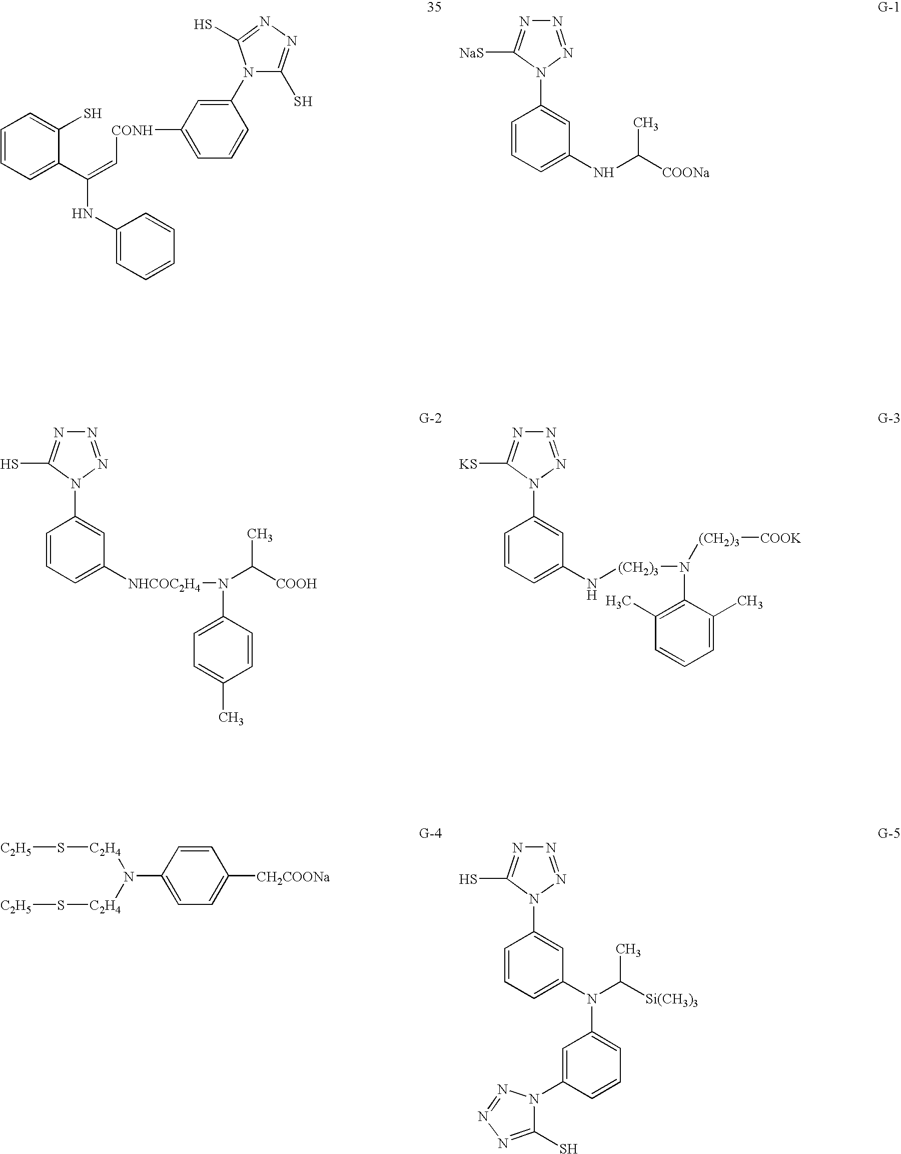

Compounds of types 1 to 4 in the invention are the same compounds as those explained in detail in Japanese Patent Application Nos. 2002-192373, 2002-188537, 2002-188536, 2001-272137 and 2002-192374, respectively. Specific compound examples described in these patent application specifications can be also exemplified as examples of compounds of types 1 to 4 in the invention. Synthesis examples of compounds of types 1 to 4 in the invention are also the same as those described in these patent applications.

As an embodiment of the type 5 compound in the invention, there can be further exemplified compounds called “one photon two electrons sensitizing agents” or “deprotonation electron-donating sensitizing agents” described in patents such as JP-A No. 9-211769 (compounds PMT-1 to S-37 described in Table E and Table F on pages 28 to 32), JP-A Nos. 9-211774, 11-95355 (compounds INV1 to 36), JP-T No. 2001-500996 (compounds 1 to 74, 80 to 87, 92 to 122), U.S. Pat. Nos. 5,747,235, 5,747,236, EP Nos. 786692A1 (compounds INV1 to 35), 893732A1, U.S. Pat. Nos. 6,054,260, and 5,994,051.

Compounds of types 1 to 5 in the invention may be used at any time at preparation of a photosensitive silver halide emulsion, and at a step of preparing a thermally developable photosensitive material, for example, at formation of a photosensitive silver halide particle, at a desalting step, at chemical sensitization, and before coating. The compounds may be added at a plurality times in these steps. A preferable addition time is from completion of formation of a photosensitive silver halide particle to before a desalting step, at chemical sensitization (from immediately before initiation of chemical sensitization to immediately after completion), or before coating, more preferably from at chemical sensitization to before mixing with a non-photosensitive organic silver salt.

It is preferable that compounds of types 1 to 5 in the invention are added by being dissolved in water, a water-soluble solvent such as methanol and ethanol, or a mixed solvent of them. When the compound is dissolved in water, a compound having the higher solubility at a higher or lower pH is dissolved by rising or lowering pH, and this solution may be added.

It is preferable that compounds of types 1 to 5 in the invention are used in an emulsion layer containing photosensitive silver halide and a non-photosensitive organic silver salt, or they may be added not only to an emulsion layer containing photosensitive silver halide and a non-photosensitive organic silver salt but also to a protecting layer and an intermediate layer, and they may be diffused at coating. The compounds in the invention may be added before or after a sensitizing pigment, and is contained in a silver halide emulsion layer at a rate of 1×10⁻⁹ to 5×10⁻¹ mol, further preferably 1×10⁻⁸ to 5×10⁻² mol per 1 mol of silver halide.

10) Use of Plural Silver Halides

Only one kind of a photosensitive silver halide emulsion in a thermally developable photosensitive material may be used in the invention, and two or more of the emulsions (e.g. emulsions having different average particle sizes, different halogen compositions, different crystal habits, or different chemical sensitization conditions) may also be used in combination. By using plural kinds of photosensitive silver halides having different sensitivities, gradation can be regulated. Examples of techniques regarding them include those described in JP-A Nos. 57-119341, 53-106125, 47-3929, 48-55730, 46-5187, 50-73627, and 57-150841. It is preferable to adjust sensitivities of each emulsion to have a difference of 0.2 log E or larger between them.

A content rate of a particle size is preferable such that a rate of photosensitive silver halide having a smaller particle size is high, and it is preferable that 50% by mass or more of photosensitive silver halide has a particle size of 80 nm or smaller, further preferably 50 nm or smaller.

In addition, in the invention, 50% by number or more of photosensitive silver halide particles has preferably a particle size of 50 nm or smaller, also in that the aforementioned ΔE can easily satisfy any condition of the above-mentioned conditions (a), (b) and (c).

11) Coating Amount

An amount of photosensitive silver halide to be added is, as an amount of coated silver per 1 m² of a sensitive material, preferably 0.03 to 0.6 g/m², further preferably 0.05 to 0.4 g/m², most preferably 0.07 to 0.3 g/m² and, relative to 1 mol of an organic silver salt, photosensitive silver halide is preferably not smaller than 0.01 mol and not greater than 0.5 mol, more preferably not smaller than 0.02 mol and not greater than 0.3 mol, further preferably not smaller than 0.03 mol and not greater than 0.2 mol.

12) Mixing of Photosensitive Silver Halide and Organic Silver Salt

As a method and conditions for mixing photosensitive silver halide and an organic silver salt which have been prepared separately, there are a method for mixing a silver halide particle and an organic silver salt which have been prepared separately, with a high speed stirrer, a ball mill, a sand mill, a colloid mill, a vibration mill, a homogenizer or the like, and a method for mixing photosensitive silver halide which has been prepared at any time during preparation of an organic silver salt, to prepare an organic silver salt, but the method and conditions are not particularly limited as far as effects of the invention are sufficiently exerted. In addition, mixing of two or more organic silver salt dispersions in water and two or more photosensitive silver salt dispersions in water is a preferable method for regulating the photographic properties.

13) Mixing of Silver Halide into Coating Solution

A preferable time of adding silver halide in the invention into an image forming layer coating solution is 180 minutes before to immediately before coating, preferable 60 minutes before to 10 seconds before coating, but a mixing method and mixing conditions are not particularly limited as far as effects of the invention are sufficiently exerted. As a specific mixing method, there are a method of mixing in a tank by adjusting an average residence time calculated from an addition flow rate and an amount of supply to a coater, to a desired time, and a method using a static mixer described in “Liquid Mixing Technology” (published by The Nikkan Kogyo Shimbun, Ltd., 1989), chapter 8, authored by N. Harnby, M. F. Edwards, A. W. Nienow, translated by Koij Takahashi.

(Explanation of Binder)

As a binder in an organic silver salt-containing layer in the invention, any polymers may be used, and a suitable binder is transparent or translucent, is generally colorless, and examples thereof include natural resins, polymers and copolymers, synthetic resins, polymers and copolymers, and other film forming media, such as gelatins, rubbers, poly(vinyl alcohols), hydroxyethylcelluloses, cellulose acetates, cellulose acetate butyrates, poly(vinyl pyrrolidones), casein, starch, poly(acrylic acids), poly(methyl methacrylic acids), poly(vinyl chlorides), poly(methacrylic acids), styrene-maleic anhydride copolymers, styrene-acrylonitrile copolymers, styrene-butadiene copolymers, poly(vinyl acetals)(e.g. poly(vinyl formal) and poly(vinyl butyral)), poly(esters), poly(urethanes), phenoxy resin, poly(vinylidene chlorides), poly(epoxides), poly(carbonates), poly(vinyl acetates), poly(olefins), cellulose esters, and poly(amides). A binder may form a coating from water, an organic solvent or an emulsion. in the invention, a glass transition temperature of a binder which can be used in combination in a layer containing an organic silver salt is preferably not lower than 0° C. and not higher than 80° C. (hereinafter, referred to as high Tg binder), more preferably 10° C. to 70° C., further preferably not lower than 15° C. and not higher than 60° C.

In the present specification, Tg is calculated by the following equation.

1/Tg=Σ(Xi/Tgi)

Here, it is assumed that n monomer components (i=1 to n) are copolymerized in a polymer. Xi is a weight fraction of i^{th} monomer (ΣXi=1), and Tgi is a glass transition temperature (absolute temperature) of a homopolymer of i^{th} monomer, provided that Σ is a sum of i=1 to n. As a value of a glass transition temperature (Tgi) of a homopolymer of each monomer, values described in Polymer Handbook(3^{rd} Edition)(J. Brandrup E. H. Immergut (Wiley-Interscience, 1989)) are adopted.

If necessary, two or more kinds of binders may be used. Alternatively, a binder having a glass transition temperature of 20° C. or higher and a binder having a glass transition temperature of lower than 20° C. may be used as a combination. When two or more polymers having different Tgs are used by blending, weight average Tg is preferably in the above-mentioned range.

In the invention, it is preferable that a coated film of an organic silver salt-containing layer is formed by coating and drying a coating solution in which 30% by mass or more of a solvent is water.

In the invention, when an organic silver salt-containing layer is formed by coating and drying a coating solution in which 30% by mass of more of a solvent is water, and further when a binder for an organic silver salt-containing layer can be dissolved or dispersed in an aqueous solvent (water solvent), in particular, when the layer comprises a latex of a polymer having an equilibrium moisture content at 25° C. and 60% RH of 2% by mass or less, the performance is improved. The most preferable aspect is adjustment of an ion conductivity to 2.5 mS/cm or less and, as such the adjusting method, there is a method of purification treatment using a separation functioning membrane after polymer synthesis.

As used herein, an aqueous solvent in which the above-mentioned polymer can be dissolved or dispersed is water, or a mixture of water and 70% by mass or lower of a water-miscible organic solvent. Examples of the water-miscible organic solvent include alcohols such as methyl alcohol, ethyl alcohol, propyl alcohol and the like, cellosolves such as methyl cellosolve, ethyl cellosolve, butyl cellosolve and the like, ethyl acetate, and dimethyl formamide.

In addition, also in a system in which a polymer is not thermodynamically dissolved and is present in the so-called dispersed state, a term aqueous solvent is used herein.

In addition, an “equilibrium moisture content at 25° C. and 60% RH” can be expressed as follows by using a weight W1 of a polymer which is in moisture condition equilibrium under the atmosphere of 25° C. and 60% RH, and a weight W0 of a polymer which is in the absolutely dry state at 25° C.

Equilibrium moisture content at 25° C. and 60% RH=[(W1-W0)/W0]×100(% by mass)

Regarding definition of a moisture content and a method of measuring the same, reference can be made to, for example, Polymer Technology Course 14, Polymer Material Test Method (edited by Society of Polymer, Chijinshokan).

An equilibrium moisture content at 25° C. and 60% RH of a binder polymer in the invention is preferably 2% by mass or less, more preferably not smaller than 0.01% by mass and not larger than 1.5% by mass, further preferably not smaller than 0.02% by mass and not larger than 1% by mass.

In the invention, a polymer which can be dispersed in an aqueous solvent is particularly preferable. Examples of the dispersed state include a latex in which a fine particle of a water-insoluble hydrophobic polymer is dispersed, and a dispersion in which a polymer molecule is dispersed in a molecular state or in a formed micelle, a latex-dispersed particle being more preferable. An average particle diameter of a dispersion particle is in a range of 1 to 50,000 nm, preferably in a range of 5 to 1,000 nm, more preferably 10 to 500 nm, further preferably in a range of 50 to 200 nm. A particle diameter distribution of a dispersion particle is not particularly limited, and may be a wide particle diameter distribution or a monodisperse particle diameter distribution. Use of mixing two or more kinds of particles having monodisperse particle diameter distributions is a preferable method for controlling the physical properties of a coating solution.

As a preferable aspect of a polymer which can be dispersed in an aqueous solvent in the invention, hydrophobic polymers such as acrylic polymer, poly(esters), rubbers (e.g. SBR resin), poly(urethane), poly(vinyl chlorides), poly(vinyl acetates), poly(vinyliden chlorides), poly(olefins) and the like can be preferably used. These polymers may be a linear polymer or a branched polymer, a cross-linked polymer, a so-called homopolymer obtained by polymerization of a single monomer, or a copolymer obtained by polymerization of two or more kinds of monomers. A copolymer may be a random copolymer or a block copolymer. A molecular weight of these polymers is 5,000 to 1,000,000, preferably 10,000 to 200,000 as expressed by a number average molecular weight. In addition, a cross-linking polymer latex is particularly preferably used.

(Example of Latex)

As an example of a preferable polymer latex, there can be exemplified as follow: A polymer latex is represented using a raw material monomer, a numeral in parenthesis is % by mass, and a molecular weight is expressed as a number average molecular weight. When a polyfunctional monomer is used, since it forms a cross-linked structure, the concept of a molecular weight cannot be applied. Then, “cross-linking” is described, and description of a molecular weight is omitted. Tg represents a glass transition temperature.

P1; -MMA(70)-EA(27)-MAA(3)-latex (molecular weight 37000, Tg 61° C.)

P-2; -MMA(70)-2EHA(20)-St(5)-AA(5)-latex (molecular weight 40000, Tg 59° C.)

P-3; -St(50)-Bu(47)-MAA(3)-latex (cross-linking, Tg-17° C.)

P-4; -St(68)-Bu(29)-AA(3)-latex (cross-linking, Tg 17° C.)

P-5; -St(71)-Bu(26)-AA(3)-latex (cross-linking, Tg 24° C.)

P-6; -St(70)-Bu(27)-IA(3)-latex (cross-linking)

P-7; -St(75)-Bu(24)-AA( l)-latex (cross-linking, Tg 29° C.)

P-8; -St(60)-Bu(35)-DVB(3)-MAA(2)-latex (cross-linking)

P-9; -St(70)-Bu(25)-DVB(2)-AA(3)-latex (cross-linking)

P-10; -VC(50)-MMA(20)-EA(20)-AN(5)-AA(5)-latex (molecular weight 80000)

P-11; -VDC(85)-MMA(5)-EA(5)-MAA(5)-latex(molecular weight 67000)

P-12; -Et(90)-MAA(10)-latex(molecular weight 12000)

P-13; -St(70)-2EHA(27)-AA(3)-latex(molecular weight 130000, Tg 43° C.)

P-14; -MMA(63)-EA(35)-AA(2) latex(molecular weight 33000, Tg 47° C.)

P-15; -St(70.5)-Bu(26,5)-AA(3)-latex(cross-linking, Tg 23° C.)

P- 16; -St(69.5)-Bu(27.5)-AA(3)-latex(cross-linking, Tg 20.5° C.)

Abbreviations for the above structures represent the following monomers:MMA; methyl methacrylate, EA; ethyl acrylate, MAA; methacrylic acid, 2 EHA; 2-ethylhexyl acrylate, St; styrene, Bu; butadiene, AA; acrylic acid, DVB; divinylbenzene, VC; vinyl chloride, AN; acrylonitrile, VDC; vinylidene chloride, ET; ethylene, IA; itaconic acid.

The above-mentioned polymer latexes are also commercially available, and the following polymers can be utilized. Examples of an acrylic polymer include Sevien A-4635, 4718, 4601 (all manufactured by Daicel Chemical Industries, Ltd.) and Nipol Lx 811, 814, 821, 820, 857 (all manufactured by Nippon Zeon Co., Ltd.). Examples of poly(esters) include FINETEX ES650, 611, 675, 850 (all manufactured by Dainippon Ink and Chemicals, Incorporated), and WD-size, WMS (all manufactured by Eastman Chemical). Examples of poly(urethanes) include HYDRN AP10, 20, 30, 40 (all manufactured by Dainippon Ink and Chemicals, Incorporated). Examples of rubbers include LACSTAR 7310K, 3307B, 4700H, 7132C (all manufactured by Dainippon Ink and Chemicals, Incorporated), and Nipol Lx416, 410, 438C, 2507 (all, manufactured by Nippon Zeon Co., Ltd.). Examples of poly(vinyl chlorides) include G351, G576 (all manufactured by Nippon Zeon Co., Ltd.). Examples of poly(vinylidene chlorides) include L502, L513 (all manufactured by Asahi Chemical Industry Co., Ltd.). Examples of poly(orefins) include Chemipearl S120, SA100 (all manufactured by Mitsui Petrochemical Industries, Ltd.).

These polymer latexes may be used alone, or two or more kinds may be blended if necessary.

(Preferable Latex)

As a polymer latex used in the invention, in particular, a styrene-butadiene copolymer latex is preferable. It is preferable that a weight ratio of a monomer unit of styrene and a monomer unit of butadiene in a styrene-butadiene copolymer is 40:60 to 95:5. In addition, it is preferable that a rate of a monomer unit of styrene and a monomer unit of butadiene in a copolymer is 60 to 99% by mass. In addition, a polymer latex in the invention contains acrylic acid or methacrylic acid at 1 to 6% by mass, more preferably 2 to 5% by mass relative to a sum of styrene and butadiene. It is preferable that a polymer latex in the invention contains acrylic acid. A preferable range of a molecular weight is as described above.

Examples of a preferable latex of a styrene-butadiene copolymer used in the invention include the above-mentioned P-3 to P-8, 15, and commercially available LACSTAR-3307B, 7132C, Nipol Lx416 and the like.

If necessary, hydrophilic polymers such as gelatin, polyvinyl alcohol, methylcellulose, hydroxypropylcellulose and carboxymethylcellulose may be added to an organic silver salt-containing layer of a photosensitive material in the invention. An amount of these hydrophilic polymers to be added is preferably 30% by mass or less, more preferably 20% by mass or less of an entire binder in an organic silver salt-containing layer.

It is preferable that an organic silver salt-containing layer (that is, image forming layer) in the invention is formed by using a polymer latex. An amount of a binder in an organic silver salt-containing layer is such that a weight ratio of entire binder/organic silver salt is in a range of 1/10 to 10/1, more preferably 1/3 to 5/1, further preferably 1/1 to 3/1.

In addition, such the organic silver salt-containing layer is usually also a photosensitive layer (emulsion layer) containing photosensitive silver halide which is a photosensitive silver salt, and a weight ratio of entire binder/silver halide in such the case is in a range of 400 to 5, more preferably in a range of 200 to 10.

An amount of an entire binder in an image forming layer in the invention is preferably in a range of 0.2 to 30 g/m², more preferably 1 to 15 g/m², further preferably 2 to 10 g/m². A cross-linking agent for cross-linking, and a surfactant for improving the coating property may be added to an image forming layer in the invention.

(Preferable Solvent of Coating Solution)

As a solvent of a coating solution for an organic silver salt-containing layer in a photosensitive material in the invention (herein, a solvent and a dispersing medium are expressed as solvent or simplicity an aqueous solvent containing 30% by mass or more of water is preferable. As a component other than water, arbitrary water-miscible organic solvents such as methyl alcohol, ethyl alcohol, isopropyl alcohol, methyl cellosolve, ethyl cellosolve, dimethylformamide and ethyl acetate may be used. A water content of a solvent in a coating solution is preferably 50% by mass or larger, more preferably 70% by mass or larger. Examples of a preferable solvent composition include, in addition to water, water/methyl alcohol=90/10, water/methyl alcohol=70/30, water/methyl alcohol/dimethylformamide=80/15/5, water/methyl alcohol/ethyl cellosolve=85/10/5, and water/methyl alcohol/isopropyl alcohol=85/10/5 (numerals are % by mass).

(Explanation of Antifoggant)

Examples of a antifoggant, a stabilizing agent and a stabilizing agent precursor which can be used in the invention include compounds described in JP-A No. 10-62899, paragraph number 0070, EP Laid-Open No. 0803764A1, page 20 line 57 to page 21 line 7, JP-A Nos. 9-281637, 9-329864, U.S. Pat. No. 6,083,681, and EP No. 1048975. In addition, a antifoggant which is preferably used in the invention is an organic halide, and examples thereof include those described in JP-A No. 11-65021, paragraph numbers 0111 to 0112. An organic halogen compound represented by the formula (P) in JP-A No. 2000-284399, an organic polyhalogen compound represented by the general formula (II) in JP-A No. 10-339934, and an organic polyhalogen compound described in JP-A Nos. 2001-31644 and 2001-33911 are particularly preferable.

(Explanation of Polyhalogen Compound)

An organic polyhalogen compound which is preferable in the invention will be specifically explained below. A preferable polyhalogen compound in the invention is a compound represented by the following general formula (H).

Q-(Y)ₙ—C(Z₁)(Z₂)X General Formula (H):

In the general formula (H), Q represents an alkyl group, an aryl group or a heterocyclic group, Y represents a divalent tethering group, n represents 0 or 1, Z₁ and Z₂ represent a halogen atom, and X represents a hydrogen atom or an electron withdrawing group.

In the general formula (H), Q is preferably an aryl group or a heterocyclic group. In the general formula (H), when Q is a heterocyclic group, a nitrogen-containing heterocyclic group containing 1 to 2 nitrogen atom(s) is preferable, and a 2-pyridyl group and a 2-quinolyl group are particularly preferable.

In the general formula (H), when Q is an aryl group, Q represents preferably a phenyl group substituted with an electron withdrawing group having a positive value of Hammett substituent constant σp. Regarding Hammett substituent constant, reference can be made to Journal of Medicinal Chemistry, 1973, Vol. 16, No. 11, 1207-121r. Examples of such the electron withdrawing group include a halogen atom (fluorine atom (σp value: 0.06), chlorine atom (σp value: 0.23), bromine atom (σp value: 0.23), iodine atom (σp value: 0.18), trihalomethyl group (tribromomethyl (σp value: 0.29), trichloromethyl (σp value: 0.33), trifluoromethyl (σp value: 0.54)), a cyano group (σp value: 0.66), a nitro group (σp value: 0.78), an aliphatic, aryl or heterocyclic sulfonyl group (e.g. methanesulfonyl (σp value: 0.72)), an aliphatic, aryl or heterocyclic acyl group (e.g. acetyl (σp value: 0.50), benzoyl (σp value: 0.43)), an alkynyl group (e.g. C≡CH (σp value: 0.23)), an aliphatic, aryl or heterocyclic oxycarbonyl group (e.g. methoxycarbonyl (σp value: 0.45), phenoxycarbonyl (σp value: 0.44)), a carbamoyl group (σp value: 0.36), a sulfamoyl group (σp value: 0.57), a sulfoxide group, a heterocyclic group, a phosphoryl group and the like. A σp value is preferably in a range of 0.2 to 2.0, more preferably in a range of 0.4 to 1.0. A particularly preferable electron withfrawing group is a carbamoyl group, an alkoxycarbonyl group, an alkylsulfonyl group, or an alkylphosphoryl group and, inter alia, a carbamoyl group is preferable.

X is preferably an electron withdrawing group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group, particularly preferably a halogen atom. Among a halogen atom, a chlorine atom, a bromine atom and an iodine atom are preferable, a chlorine atom and a bromine atom are further preferable, and a bromine atom is particularly preferable.

Y represents preferably —C(═O)—, —SO— or —SO₂—, more preferably —C(═O)—, —SO₂—, particularly preferably —SO₂—. And, n represents 0 or 1, preferably 1.

Examples of the compound of the general formula (H) in the invention will be shown below.

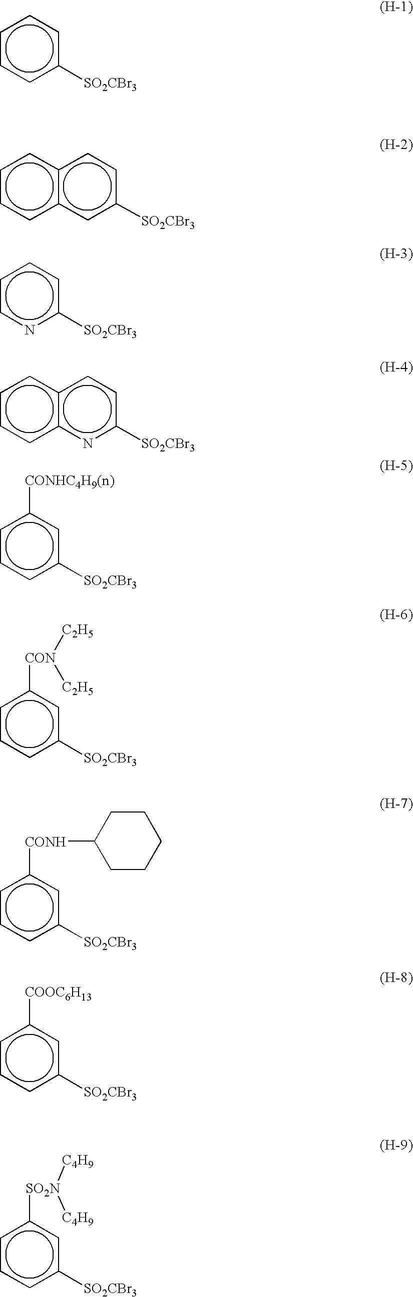

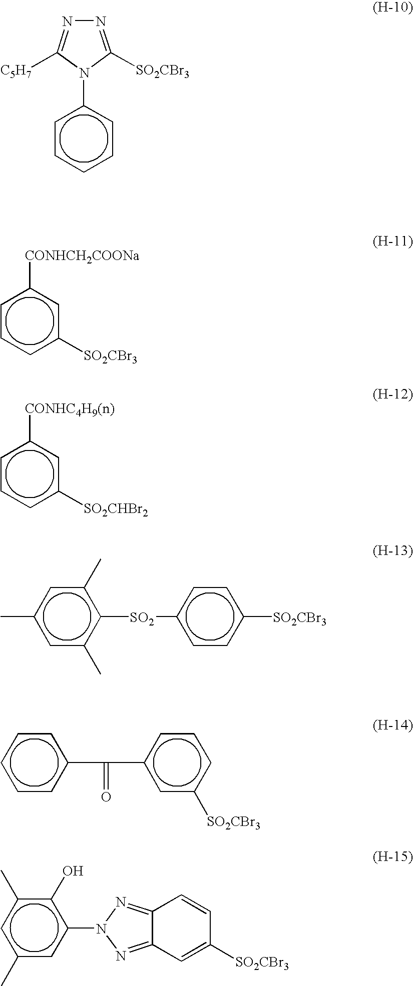

Examples of a preferable polyhalogen compound in the invention in addition to the foregoing, include compounds described in JP-A Nos. 2001-31644, 2001-56526, and 2001-209145.

The compound represented by the general formula (H) in the invention is used in a range of preferably 10⁻⁴ to 1 mol, more preferably 10⁻³ to 0.5 mol, further preferably 1×10⁻² to 0.2 mol per 1 mol of a non-photosensitive silver salt in an image forming layer.

In the invention, as a method for inclusion of a antifoggant in a photosensitive material, there are methods described in the above-mentioned method for inclusion of a reducing agent, and it is also preferable that an organic polyhalogen compound is added as a solid fine particle dispersion.

(Other Antifoggant)

Examples of other antifoggants include a silver (II) salt described in JP-A No. 11 -65021, paragraph number 0113, benzoic acids described in the same, paragraph number 0114, a salicylic acid derivative described in JP-A No. 2000-206642, a formalin scavenger compound represented by the formula (S) described in JP-A No. 2000-221634, a triazine compound relating to claim 9 of JP-A No. 11-352624, and a compound represented by the general formula (III), 4-hydroxy-6-methyl-1,3,3a,7-tetraazaindene described in JP-A No. 6-11791.

A thermally developable photosensitive material in the invention may contain an azolium salt for the purpose of preventing fog. Examples of an azolium compound include a compound represented by the general formula (XI) described in JP-A No. 59-193447, a compound described in JP-B No. 55-12581, and a compound represented by the general formula (II) described in JP-A No. 60-153039. An azolium salt may be added to any part of a photosensitive material, but as a layer to be added, it is preferable to add to a layer on a surface having a photosensitive layer, more preferably to an organic silver salt-containing layer. An azolium salt may be added at any step in preparation of a coating solution and, when the salt is added to an organic silver salt-containing layer, the salt may be added at any step from preparation of an organic silver salt to preparation of a coating solution, preferably after preparation of an organic silver salt to immediately before coating. The azolium salt may be added in any form such as a powder, a solution and a fine particle dispersion. Alternatively, the salt may be added as a solution obtained by mixing with other additives such as a sensitizing pigment, a reducing agent and a tone agent. In the invention, an amount of the azolium salt to be added is any amount, but not smaller than 1×10⁻⁶ mol and not larger than 2 mol is preferable, and not smaller than 1×10⁻³ mol and not larger than 0.5 mol is more preferable per 1 mol of silver.

(Other Additives)

1) Mercapto, Disulfide and Thiones

In the invention, in order to suppress or promote development and control development, in order to improve the spectroscopic sensitizing efficacy, and in order to improve the shelf stability before and after development, a mercapto compound, a disulfide compound, and a thione compound may be contained, and examples thereof include a compound represented by the general formula (I) described in JP-A No. 10-62899, paragraph numbers 0067 to 0069, and JP-A No. 10-186572, and embodiments thereof described in paragraph numbers 0033 to 0052, and EP Laid-Open No. 0803764A1, page 20, lines 36 to 56. Inter alia, mercapto-substituted heterocyclic aromatic compounds described in JP-A Nos. 9-297367, 9-304875, 2001-100358, Japanese Patent Application Nos. 2001-104213, 2001-104214 and the like are preferable.

2) Tone Agent

In the thermally developable photosensitive material in the invention, it is preferable to add a tone agent, a tone agent is described in JP-A No. 10-62899, paragraph numbers 0054 to 0055, EP Laid-Open No. 0803764A1, page 21, lines 23 to 48, JP-A Nos. 2000-356317 and 2000-187298, and particularly, phthalazinones (phthalazinone, phthalazinone derivatives or metal salts; for example, 4-(1-naphthyl)phthalazinone, 6-chlorophthalazinone, 5,7-dimethoxyphthalazinone and 2,3-dihydro-1,4-phthalazinedione); a combination of phthalazinones and phthalic acids (e.g. phthalic aicd, 4-methylphthalic acid, 4-nitrophthalic acid, diammonium phthalate, sodium phthalate, potassium phthalate and tetrachlorophthalic anhydride); phthalazines (phthalazine, phthalazine derivatives or metal salts; for example, 4-(1-naphthyl)phthalazine, 6-isopropylphthalazine, 6-t-butylphthalazine, 6-chlorophthalazine, 5,7-dimethoxyphthalazine and 2,3-dihydrophthalazine); a combination of phthalazines and phthalic aicds is preferable and, inter alia, particularly preferable is a combination of 6-isopropylphthalazine and phthaiic acid or 4-methylphthalic acid. In addition, in a combination with silver halide of a composition having a high silver iodide content, a combination of phthalazines and phthalic acids is preferable.

A preferable amount of phthalazines to be added is 0.01 mol to 0.3 mol, further preferably 0.02 to 0.2 mol, particularly preferably 0.02 to 0.1 mol per 1 mol of an organic silver salt.

3) Plasticizer, Lubricant

A plasticizer and a lubricant which can be used in a photosensitive layer in the invention are described in JP-A No. 11-65021, paragraph number 0117, a gradation ultra-hardening agent for forming a ultra high contrast image and a method of adding the same are described in the same publication, paragraph number 0118, JP-A No. 11-223898, paragraph numbers 0136 to 0193, and compounds of the formula (H), the formulae (1) to (3), the formulae (A) and (B) in JP-A No. 2000-284399, compounds of the general formulae (III) to (V) (specific compound: Chemical Formula 21 to Chemical Formula 24) in Japanese Patent Application No. 11-91652, and a gradation ultra-hardening agent is described in JP-A No. 11-65021, paragraph No. 0102, and JP-A No. 11-223898, paragraph numbers 0194 to 0195. A lubricant is described in JP-A No. 11-84573, paragraph numbers 0061 to 0064 and JP-A No. 11-106881, paragraph numbers 0049 to 0062.

4) Dye, Pigment

In a photosensitive layer in the invention, various dyes and pigments (e.g. C.I.Pigment Blue 60, C.I.Pigment Blue 64, C.I.Pigment Blue 15:6) can be used from a viewpoint of prevention of occurrence of interference fringes at laser exposure, and prevention of irradiation. These are described in detail in WO98/36322, JP-A Nos. 10-268465, 11-338098 and the like.

5) Gradation Ultra-Hardening Agent

In order to form a ultra-high contrast image suitable for printing plate making, it is preferable to add a gradation ultra-hardening agent to an image forming layer. A gradation ultra-hardening agent, a method of adding the same and an amount of the same to be added are described in the same publication, paragraph number 0118, JP-A No. 11-223898, paragraph numbers 0136 to 0193, compounds of the formula (H), the formulae (1) to (3), the formulae (A) and (B) of Japanese Patent Application No. 11-87297, compounds of the general formulae (III) to (V) (specific compounds: Chemical Formula 21 to Chemical Formula 24) described in Japanese Patent Application No. 11-91652, and a superhigh contrast promoting agent is described in JP-A No. 11-65021, paragraph number 0102, and JP-A No. 11-223898, paragraph numbers 0194 to 0195.

In order to use formic acid or formate as a strong fogging substance, it is preferable that they are contained in a side having an image forming layer containing photosensitive silver halide at 5 mmol or less, further 1 mmol or less per 1 mol of silver.

When a gradation ultra-hardening agent is used in the thermally developable photosensitive material in the invention, it is preferable to use an acid produced by hydration of diphosphorus pentaoxide or a salt thereof in combination. Examples of an acid produced by hydration of diphosphorus pentaoxide or a salt thereof include metaphosphoric acid (salt), pyrophosphoric acid (salt), orthophosphoric acid (salt), triphosphoric acid (salt), tetraphosphoric acid (salt), and hexametaphosphoric acid (salt). Examples of an acid produced by hydration of diphosphorus pentaoxide or a salt thereof which is particularly preferably used include orthophosphoric acid (salt) and hexametaphosphoric acid (salt). Specific examples of a salt include sodium orthophosphate, sodium dihydrogen orthophosphate, sodium hexametaphosphate, and ammonium hexametaphosphate.

An amount of an acid produced by hydration of diphosphorus pentaoxide or a salt thereof to be used (a coating amount per 1 m² of a photosensitive material) may be desired amount depending on the performance such as sensitivity and fog, and is preferably 0.1 to 500 mg/m², more preferably 0.5 to 100 mg/m².

A reducing agent, a hydrogen-bonding compound, a development accelerator and a polyhalogen compound in the invention are preferably used as a solid dispersion, and a preferable process for preparing these solid dispersions is described in JP-A No. 2002-55405.

(Preparation and Coating of Coating Solution)

A temperature for preparing an image forming layer coating solution in the invention is not lower than 30° C. and not higher than 65° C., further preferably not lower than 35° C. and lower than 60° C., more preferably not lower than 35° C. and not higher than 55° C. In addition, it is preferable that a temperature of an image forming layer coating solution immediately after addition of a polymer latex is maintained at not lower than 30° C. and not higher than 65° C.

(Layer Construction and Elements)

An image forming layer in the invention is composed of one or more layers on a substrate. When the image forming layer is composed of one layer, the layer comprises an organic silver salt, photosensitive silver halide, a reducing agent and a binder and, if necessary, contains desired additional materials such as a tone agent, a coating assistant and other auxiliary agents. When the image forming layer is composed of two or more layers, a first image forming layer (usually, a layer adjacent to a substrate) must contain an organic silver salt and photosensitive silver halide, and a second image forming layer or both layers must contain some other components. A construction of a multi-color photosensitive thermally developable photographic material may contain a combination of these two layers regarding each color, or may contain all components in a single layer as described in U.S. Pat. No. 4,708,928. In the case of a multi-dye multi-color photosensitive thermally developable photographic material, respective emulsion layers are retained being discriminated from each other by using a functionally or non-functional barrier layer between respective photosensitive layers as generally described in U.S. Pat. No. 4,460,681.

The thermally developable photosensitive material in the invention may have a non-photosensitive layer in addition to the image forming layer. A non-photosensitive layer can be classified into (a) a surface protecting layer provided on the image forming layer (on a farer side from a substrate), (b) an intermediate layer provided between a plurality of image forming layers or between the image forming layer and a protecting layer, (c) an undercoating layer provided between the image forming layer and a substrate, and (d) a back layer provided on an opposite side of the image forming layer, from a viewpoint of arrangement thereof.

In addition, a layer acting as an optical filter can be provided, and is provided as a layer of (a) or (b). An anti-halation layer is provided in a photosensitive material as a layer of (c) and (d).

1) Surface Protecting Layer

For the purpose of preventing attachment of an image forming layer, a surface protecting layer can be provided on the thermally developable photosensitive material in the invention. The surface protecting layer may be a single layer or a multi-layer.

The surface protecting layer is described in JP-A 11-65021, paragraph numbers 0119 to 0120, and JP-A No. 2000-171936.

As a binder in the surface protecting layer in the invention, gelatin is preferable, but it is preferable to use polyvinyl alcohol (PVA) alone in combination. As gelatin, inert gelatin (e.g. Nitta Gelatin 750) and phthalated gelatin (e.g. Nitta Gelatin 801) can be used. Examples of PVA include those described in JP-A No. 2000-171936, paragraph numbers 0009 to 0020, preferably completely saponified PVA-105, partially suponified PVA-205 and PVA-335, and modified polyvinyl alcohol MP-203 (all trade names manufactured by Kuraray Co., Ltd.). An amount of polyvinyl alcohol in the protecting layer (per one layer) to be coated (per 1 m² of a substrate) is preferably 0.3 to 4.0 g/m², more preferably 0.3 to 2.0 g/m².

An amount of a total binder (including a water-soluble polymer and a latex polymer) in the surface protecting layer (per one layer) to be coated (per 1 m² of a substrate) is preferably 0.3 to 5.0 g/m², more preferably 0.3 to 2.0 g/m².

2) Anti-Halation Layer

In the thermally developable photosensitive material in the invention, an anti-halation layer can be provided on a photosensitive layer on a farer side from the light source.

The anti-halation layer is described in JP-A No. 11-65021, paragraph numbers 0123 to 0124, JP-A No. 11-223898, same 9-230531, same 10-36695, same 10-104779, same 11-231457, same 11-352625, same 11-352626 and the like.

The anti-halation layer contains an anti-halation dye having absorption at an exposure wavelength. When an exposure wavelength is in an infrared region, an infrared-ray absorbing lye may be used and, in that case, a dye having no absorption in a visible region is preferable.

When halation prevention is performed using a dye having absorption in a visible region, it is preferable to make a color of dye not sufficiently remain after formation of an image, it is preferable to use a means for decolor the dye by the heat of thermal development, and it is particularly preferable to add a heat decolorizable dye and a base of precursor to a non-photosensitive layer to function as an anti-halation layer. These techniques are described in JP-A No. 11-231457.

An amount of a decolorizable dye to be added is determined by utility of a dye. Generally, the dye is used in such an amount that the optical density (absorbance) exceeds 0.1 when measured at a desired wavelength. The optical density is preferably 0.15 to 2, more preferably 0.2 to 1. An amount of a dye to be used for obtaining such the optical density is generally around 0.001 to 1 g/m².

When a dye is decolored like this, the optical density after thermal development can be reduced to 0.1 or less. Two or more kinds of a decolorizable dye may be used in combination in a heat decolorizable recording material or a thermally developable photosensitive material. Similarly, two more kinds of base precursors may be used in combination.

In heat decoloring using such the decolorizable dye and base precursor, it is preferable to use a substance which lowers a melting point by 3° C. (deg) or more when mixed with a base precursor (e.g. diphenylsulfone, 4-chlorophenyl(phenyl)sulfone), 2-naphthyl benzoate and the like described in JP-A No. 11-352626 in combination, from a viewpoint of the heat decoloring property.

3) Back Layer

A back layer which can be applied to the invention is described in JP-A No. 11-65021, paragraph numbers 0128 to 0130.

In the invention, for the purpose of improving a change in silver tone and image with time, a colorant having maximum absorption at 300 to 450 nm can be added. Such the colorant is described in JP-A Nos. 62-210458, 63-104046, 63-103235, 63-208846, 63-306436, 63-314535, 01-61745, and 2001-100363.

Such the colorant is usually added in a range of 0.1 mg/m² to 1 g/m², preferably to a back layer provided on an opposite side to a photosensitive layer.

In addition, in order to adjust basic tone, it is preferable to use a dye having an absorption peak at 580 to 680 nm. As a dye for this purpose, an oil-soluble dye of an azomethine series having the small absorption intensity on a short wavelength side described in JP-A Nos. 4-359967 and 4-359968, and a water-soluble dye of a phthalocyanine series described in Japanese Patent Application No. 2002-96797 are preferable. The dye for this purpose may be added to any layer, more preferably to a non-photosensitive layer on an emulsion surface side or to a back surface side.

It is preferable that the thermally developable photosensitive material in the invention is a so-called one surface photosensitive material having at least one photosensitive layer containing a silver halide emulsion on one side of a substrate and having a back layer on another side.

4) Mat Agent

In the invention, in order to improve the conveyance property, it is preferable to add a mat agent, and a mat agent is described in JP-A No. 11-65021, paragraph numbers 0126 to 0127. An amount of a mat agent to be coated per 1 m² of a photosensitive material is preferably 1 to 400 mg/m², more preferably 5 to 300 mg/m².

In the invention, a shape of the mat agent may be defined shape or undefined shape, preferably defined shape, and a spherical shape is preferably used. An average particle diameter is preferably in a range of 0.5 to 10 μm, more preferably 1.0 to 8.0 μm, further preferably 2.0 to 6.0 μm. In addition, a variation coefficient of size distribution is preferably 50% or less, more preferably 40% or less, further preferably 30% or less. Here, a variation coefficient is a value expressed by (standard deviation of particle diameter)/(average of particle diameter)×100. In addition, it is also preferable to use two kinds of mat agents having a small variation coefficient and having a ratio of average particle In addition, a mat degree of an emulsion surface may be any one as far as pip disorder does not occur, and Beck smoothness of not smaller than 30 seconds and not larger than 2000 seconds is preferable, and not smaller than 40 seconds and not larger than 1500 seconds is particularly preferable. Beck smoothness can be easily obtained according to Japanese Industrial Standards (JIS) P8119 “Method of a smoothness test of a paper and a board by a Beck tester” and TAPPI standard method T479.

In the invention, as a mat degree of a back layer, Beck smoothness of not smaller than 10 seconds and not larger than 1200 seconds is preferable, not smaller than 20 seconds and not larger than 800 seconds is preferable, and not smaller than 40 seconds and not larger than 500 seconds is further preferable.

In the invention, it is preferable that a mat agent is contained in an outermost surface layer or a layer functioning as an outermost surface layer of a photosensitive material, or in a layer near the outer surface, or in a layer acting as a so-called protecting layer.

5) Polymer Latex

When the thermally developable photosensitive material is used in, particularly, printing utility where a dimensional change becomes a problem, it is preferable to use a polymer latex in a surface protecting layer or a back layer. Such the polymer latex is described in “Synthetic Resin Emulsion (edited by Tira Okuda, Hiroshin Inagaki, published by Polymer Publishing Institute (1978))”, “Application of Synthetic Latex (edited by Takaaki Sugimura, Yasuo Kataoka, Soichi Suzuki, Keiji Kasahara, published by Polymer Publishing Institute (1993))”, and “Chemistry of Synthetic Latex (authored by Soichi Muroi, published by Polymer Publishing Institute (1970))”, and examples thereof include a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of ethyl acrylate /methacrylic acid copolymer, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer, and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer. Further, as a binder for a surface protecting layer, a combination of polymer latexes described in Japanese Patent Application No. 11-6872, the techniques described in JP-A No. 2000-267226, paragraph numbers 0021 to 0025, the techniques described in Japanese Patent Application No. 11-6872, paragraph numbers 0027 to 0028, and the techniques described in JP-A No. 2000-19678, paragraph numbers 0023 to 0041 may be applied. A ratio of a polymer latex in a surface protecting layer is preferably not smaller than 10% by mass and not larger than 90% by mass, particularly preferably not smaller than 20% by mass and not larger than 80% by mass based on a total binder.

6) Film Surface pH

In the thermally developable photosensitive material in the invention, film surface pH before thermal developing treatment is preferably 7.0 or lower, more preferably 6.6 or lower. A lower limit thereof is not particularly limited, but is around 3. A most preferable pH range is 4 to 6.2. Use of a non-volatile acid such as organic acid such as a phthalic acid derivative, and sulfuric acid, or a volatile base such as ammonia for adjusting film surface pH is preferable from a viewpoint of reduction in film surface pH. In particular, since ammonia is easily vaporized, and can be removed before a coating step and thermal development, it is preferable for attaining low film surface pH.

In addition, it is preferable to use a non-volatile base such as sodium hydroxide, potassium hydroxide and lithium hydroxide, and ammonia in combination. In addition, a method of measuring film surface pH is described in JP-A No. 2000-284399, paragraph number 0123.

7) Hardening Agent

A hardening agent may be used in respective layers such as a photosensitive layer, a protecting layer and a back layer in the invention. As an example of hardening agent, there are methods described in T. H. James, “THE THEORY OF THE PHOTOGRAPHIC PROCESS FOURTH EDITION” (published by Macmillan Publishing Co., 1977) page 77 to page 87, and chromium alum, a sodium salt of 2,4-dichloro-6-hydroxy-s-triazine, N,N-ethylenebis(vinylsulfonacetamide), and N,N-propylenebis(vinylsulfonacetamide), as well as a multivalent metal ion described in the same document, page 78, polyisocyanates described in U.S. Pat. No. 4,281,060 and JP-A No. 6-208193, epoxy compounds described in U.S. Pat. No. 4,791,042, and vinylsulfone series compounds described in JP-A No. 62-89048 are preferably used.

A hardening agent is added in a form of a solution, and this solution is added to a protecting layer coating solution in a period from 180 minutes before coating to immediately before coating, preferably from 60 minutes before to 10 minutes before coating. A mixing method and mixing conditions are not particularly limited as far as the effects of the invention are sufficiently exerted. As a specific mixing method, there are a method for mixing in a tank by adjusting an average residence time calculated from an addition flow rate and an amount to be supplied to a coater, to a desired time, and a method by using a static mixer described in “Liquid Mixing Technology” (published by Nikkankogyoushinbunsha, 1989) chapter 8 authored by N. Harnbi, M. F. Edwards, A. W. Nienow, translated by Koji Takahashi.

8). Surfactant

A surfactant which can be applied to the invention is described in JP-A No. 11-65021, paragraph number 0132, a solvent is described in the same publication, paragraph number 0133, a substrate is described in the same publication, paragraph number 0134, an antistatic or electrically conductive layer is described in the same publication, paragraph number 0135, a method of obtaining a color image is described in same publication, paragraph number 0136, and a lubricant is described in JP-A No. 11-84573, paragraph numbers 0061 to 0064 and Japanese Patent Application No. 11-106881, paragraph numbers 0049 to 0062.

In the invention, it is preferable to use a fluorine series surfactant. Examples of a fluorine series surfactant include compounds described in JP-A Nos. 10-197985, 2000-19680, 2000-214554 and the like. In addition, a polymer fluorine series surfactant described in JP-A No. 9-281636 is also preferably used. In the thermally developable photosensitive material in the invention, it is preferable to use fluorine series surfactants described in JP-A No. 2002-82411, Japanese Patent Application No. 2001-242357 and Japanese Patent Application No. 2001-264110. In particular, fluorine series surfactants described in JP No. 2001-242357 and Japanese Patent Application No. 2001-264110 are preferable in respect of the electrification adjusting ability, the stability on a coating surface, and the sliding property when coating is performed using an aqueous coating solution. A fluorine series surfactant described in Japanese Patent Application No. 2001-264110 is most preferable in that the electrification adjusting ability is high and a small amount of the surfactant can be sufficient for use.

In the invention, a fluorine series surfactant can be used on both of an emulsion surface and a back surface, and it is preferable to use it on both surfaces. In addition, it is particularly preferable to use it in conjunction with the above-mentioned electrically conducting layer containing a metal oxide. In this case, even when an amount of a fluorine series surfactant on a surface having an electrically conducting layer to be used is reduced or the surfactant is removed, the sufficient performance can be obtained.

An amount of a fluorine series surfactant to be used is preferably in a range of 0 1 mg/m² to 100 mg/m², more preferably in a range of 0.3 mg/m² to 30 mg/m², further preferably in a range of 1 mg/m² to 10 mg/m² on each of an emulsion surface and a back surface. In particular, a fluorine series surfactant described in Japanese Patent Application No. 2001-264110 has the great effects, and a range of 0.10 to 10 mg/m² is preferable, and a range of 0.1 to 5 mg/m² is more preferable.

9) Antistatic Agent

It is preferable that the invention has an electrically conducting layer containing a metal oxide or an electrically conductive polymer. The antistatic layer may function also as an undercoating layer, a back layer, or a surface protecting layer or may be provided separately. As an electrically conductive material in an electrification preventing layer, a metal oxide in which the electrically conductive property is enhanced by introducing oxygen defect, or a heterogeneous metal atom in the metal oxide, is preferably used. As an example of a metal oxide, ZnO, TiO₂ and SnO₂ are preferable. Addition of Al or In to ZnO, addition of Sb, Nb, P or halogen element to SnO₂, and addition of Nb or Ta to TiO₂ are preferable. In particular, SnO₂ with Sb added is preferable. An amount of a heterogeneous atom to be added is preferably in a range of 0.01 to 30 mol %, more preferably in a range of 0.1 to 10 mol %. A shape of a metal oxide may be any of spherical, needle-like and plate-like, and a needle-like particle having a long axis/short axis ratio of 2.0 or larger, preferably of 3.0 to 50 is suitable in respect of the effects of imparting the electrically conductive property. An amount of a metal oxide to be used is preferably in a range of 1 mg/m² to 1000 mg/m², more preferably in a range of 10 mg/m² to 500 mg/m², further preferably in a range of 20 mg/m² to 200 mg/m². The antistatic layer in the invention may be provided on any side of an emulsion surface and a back surface, but it is preferable to provide between a substrate and a back layer. Specific examples of the antistatic layer in the invention are described in JP-A No. 11-65021, paragraph number 0135, JP-A Nos. 56-143430, 56-143431, 58-62646, 56-120519, 11-84573, paragraph numbers 0040 to 0051, U.S. Pat. No. 5,575,957, and JP-A No. 11-223898, paragraph numbers 0078 to 0084.

10) Substrate

In order to relax internal distortion remaining in a film at biaxial stretching, and eliminate heat shrinkage distortion produced during thermal developing treatment, polyester subjected to heat treatment at a temperature range of 130 to 185° C., particularly, polyethylene terephthalate is preferably used in a transparent substrate. In the case of a medical thermally developable photosensitive material, a transparent substrate may be colored with a blue dye (e.g. dye-1 described in JP-A No. 8-240877, Example) or may be colorless. It is preferable to apply to a substrate the undercoating techniques such as water-soluble polyester described in JP-A No. 11-84574, a styrene-butadiene copolymer described in JP-A No. 10-186565, and a vinylidene copolymer described in JP-A No. 2000-39684 and Japanese Patent Application No. 11-106881, paragraph numbers 0063 to 0080. When an emulsion layer or a back layer is coated on a substrate, a water content of a substrate is preferably 0.5wt % or lower.

11) Other Additives

An antioxidant, a stabilizing agent, a plasticizer, an ultraviolet ray absorbing agent or a coating assistant may be further added to the thermally developable photosensitive material. Various additives are added to any of a photosensitive layer and a non-photosensitive layer. Regarding them, a reference can be made to WO 98/36322, EP803764A1, JP-A Nos. 10-186567 and 10-18568.

12) Coating Manner

The thermally developable photosensitive material in the invention may be coated by any method. Specifically, various coating procedures including an extrusion coating, a slide coating, a curtain coating, a dipping coating, a knife coating, a flowing coating, and an extrusion coating using various hoppers described in U.S. Pat. No. 2,681,294 are used, and an extrusion coating or a slide coating described in “Liquid Film Coating” (published by Chapman & HALL, 1997) pages 399 to 536 authored by Stephen F. Kistler, Petert M. Schweizer is preferably used, and a slide coating is particularly preferably used. An example of a shape of a slide coater used in a slide coating is described in FIG. 11b.1 on page 427 in the same document. Alternatively, if desired, two or more layers can be coated simultaneously by a method described on pages 399 to 536 in the same document, or a method described in U.S. Pat. No. 2,761,791 and British Patent No. 837,095. A particularly preferable coating method in the invention is a method described in JP-A Nos. 2001-194748, 2002-153808, 2002-153803 and 2002-182333.

It is preferable that an organic silver salt-containing coating solution in the invention is a so-called thixotropic fluid. Regarding this technique, reference can be made to JP-A No. 11-52509. A viscosity of an organic silver salt-containing coating solution in the invention at a shear rate of 0.1S⁻¹ is preferably not smaller than 400 mPa.s and not larger than 100,000 mPa.s, more preferably not smaller than 500 mPa.s and not larger than 20,000 mPa.s. In addition, at a shear rate of 1000S⁻¹, not smaller than 1 mPa.s and not larger than 200 mPa.s is preferable, and not smaller than 5 mPa.s and not larger than 80 mPa.s is more preferable.

When a coating solution in the invention is prepared, upon mixing of two kinds of solutions, the known in-line mixer and in-plant mixer are preferably used. An in-line mixer preferable in the invention is described in JP-A No. 2002-85948, and an in-plant mixer preferable in the invention is described in JP-A No. 2002-90940.

In order to retain better the state of the coating surface of a coating solution in the invention, it is preferable to perform defoaming treatment. A preferable defoaming treating method in the invention is a method described in JP-A No. 2002-66431.

In order to prevent attachment of a trash or a dust due to electrification of a substrate upon coating of a coating solution in the invention, it is preferable to perform static eliminating treatment. An example of a preferable static eliminating method in the invention is described in JP-A No. 2002-143747.

In the invention, in order to dry a non-setting image forming layer coating solution, it is important to accurately control a drying wind and a drying temperature. A preferable drying method in the invention is described in detail in JP-A Nos. 2001-194749 and 2002-139814.

In order to improve the film foaming property, the thermally developable photosensitive material in the invention is preferably subjected to heating treatment immediately after coating and drying. A temperature at heating treatment (film surface temperature) is preferably in a range of 60° C. to 100° C., and a heating time is preferably in a range of 1 second to 60 seconds. A more preferable range is such that a film surface temperature is in a range of 70 to 90° C., and a heating time is in a range of 2 to 10 seconds. A preferable method of heating treatment in the invention is described in JP-A No. 2002-107872.

In addition, in order to continuously prepare the thermally developable photosensitive material in the invention stably, a preparation method described in JP-A Nos. 2002-156728 and 2002-182333 is preferably used.

It is preferable that the thermally developable photosensitive material is a monosheet type (type which can form an image on a thermally developable photosensitive material without using other sheet such as an image receiving material).

13) Packaging Material

In order to suppress a variation in the photographic performance in storage period of a photosensitive material in the invention, and to improve curling and winding habit, it is preferable to package the photosensitive material with a packaging material having a low oxygen permeating rate and/or moisture permeating rate. The oxygen permeating rate at 25° C. is preferably 50 ml/atm·m²·day or less, more preferably 10 ml/atm·m²·day or less, further preferably 1.0 ml/atm·m²·day or less. The moisture permeating rate is preferably 10 g/atm·m²·day or less, more preferably 5 g/atm·m²·day or less, further preferably 1 g/atm·m²·day or less.

Examples of a packaging material having the low oxygen permeating rate and/or moisture permeating rate include packaging materials described in JP-A Nos. 8-254793 and 2000-206653.

14) Other Available Techniques

Examples of the techniques which can be used in the thermally developable photosensitive material in the invention include those described in EP803764A1, EP883022A1, WO 98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064, and 2000-171936.

In the case of multi-color thermally developable photosensitive material, respective emulsion layers are retained being discriminated from each other by using a functional or non-functional barrier layer between respective photosensitive layers as generally described in U.S. Pat. No. 4,460,681.

In the case of a multi-color thermally developable photosensitive material, combinations of these two layers are contained regarding each color, and may contain all components in a single layer as described in U.S. Pat. No. 4,708,928.

(Image Forming Method)

1) Exposure

A red to infrared emitting He—Ne laser, a red semiconductor laser, a blue to green emitting Ar⁺, He—Me and He—Cd laser, and a blue semiconductor laser are used. A red to infrared semiconductor laser is preferable, and a peak wavelength of the laser light is 600 nm to 900 nm, preferably 620 nm to 850 nm. On the other hand, recently, in particular, a module in which a SAG (Second Harmonic Generator) element and a semiconductor laser are incorporated, and a blue semiconductor laser have been developed, and a laser outputting apparatus at a short wavelength region has been closed up. Since a blue semiconductor laser can record an image at a high precision, and can increase a recording density and can afford a long-life and stable output, increase in demand is expected from now on. It is preferable that a peak wavelength of the blue laser light is 300 nm to 500 nm, particularly 400 nm to 500 nm.

The laser light which is oscillated in a longitudinal multiple manner by a high frequency overlapping method is preferably used.

2) Thermal Development

The thermally developable photosensitive material in the invention may be developed by any method, and is usually developed by rising a temperature of an image-wisely exposed thermally developable photosensitive material. A developing temperature is 80 to 250° C., preferably 100 to 140° C., further preferably 110 to 130° C. A developing time is preferably 1 to 60 seconds, more preferably 3 to 30 seconds, further preferably 5 to 25 seconds, particularly preferably 7 to 15 seconds.

As a thermally developing manner, any of a drum-type heater and a plate-type heater may be used, and a plate-type heater method is more preferable. As a thermally developing method by a plate-type heater method, a method described in JP-A 11-133572 is preferable. An apparatus for the method is a thermally developing apparatus for obtaining a visible image by contacting a thermally developable photosensitive material having a latent image formed thereon, with a heating means at a thermally developing part in the apparatus. The heating means comprises a plate heater and a plurality of pushing rollers are oppositely disposed along one of a plane of the above-mentioned plate heaters, and thermal development is performed by passing the thermally developable photosensitive material between the pushing roller and the plate heater. It is preferable that the plate heater is divided into 2 to 6 steps, and a temperature of a tip part is lowered by around 1 to 10° C. For example, an example where 4 sets of plate heaters which can independently control a temperature are used, and temperatures are controlled at 112° C., 119° C., 121° C., and 120° C., can be cited. Such the method is described in JP-A 54-30032, in which a moisture and an organic solvent contained in a thermally developable photosensitive material can be removed, and a change in a shape of a substrate of a thermally developable photosensitive material due to rapid heating of a thermally developable photosensitive material can be suppressed.

In order to miniaturize a thermal processor and shorten a thermally developing time, it is preferable to control a heater more stably, and it is desirable that exposure is initiated starting from a front part of a sheet sensitive material, and thermal development is initiated before completion of exposure of a rear part. An imager which can perform preferable treatment rapidly in the invention is described in, for example, Japanese Patent Application Nos. 2001-088832 and 091114. When this imager is used, for example, thermal development treatment can be performed in 14 seconds with a three-step plate-heater controlled at 107° C.-121° C.-121° C., and an outputting time for the first print can be shortened to about 60 seconds. In order to perform such a rapid developing treatment, it is preferable to use, in conjunction, a thermally developable photosensitive material-2 in the invention which poorly influenced by an environmental temperature.

3) System

Examples of a medical laser imager provided with an exposing part and a thermally developing part include Fuji Medical Dry Laser Imager FM-DPL. FM-DPL is described in Fuji Medical Review (No. 8, page 39 to 55), and it goes without saying that those techniques can be applied as a laser imager for a thermally developable photosensitive material in the invention. In addition, the thermally developable photosensitive material recited in the invention can be applied also as a thermally developable photosensitive material for a laser imager in “AD network” proposed by FujiFilm Medical Co., Ltd, which is. a network system adapted to DICOM standard

(Use of the Invention)

It is preferable that the thermally developable photosensitive material of the invention is used as a medical diagnostic thermally developable photosensitive material, an industrial photographic thermally developable photosensitive material, a printing thermally developable photosensitive material, or a COM thermally developable photosensitive material, which forms a black and white image of a silver image.

### EXAMPLES

The present invention will be explained in detail by way of Examples, but the invention is not limited by them.

### EXAMPLE 1

1. Preparation of PET Substrate, and Undercoating

1) Preparation of Film

Using terephthalic acid and ethylene glycol, PET having an intrinsic viscosity IV=0.66 (measured in phenol/tetrachloroethane=6/4 (ratio by weight) at 25° C.) was obtained according to the conventional method. This was pelletized, dried at 130° C. for 4 hours, and melted at 300° C. so that a dye BB having the following structure was contained at 0.04 wt %. Thereafter, the melt was extruded through a T-type dye, and rapidly cooled to prepare an unstretched film having such a thickness that a thickness of a film after heat fixation became 175 μm.

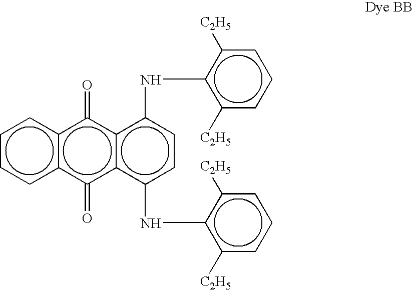

This was 3.3-fold stretched in a machine direction using rolls having different circumferential velocities and, then, 4.5-fold stretched in a traverse direction with a tenter. Temperatures thereupon were 110° C. and 130° C., respectively, thereafter, a film was thermally fixed at 240° C. for 20 seconds, and 4% relaxed in a traverse direction at the same temperature. Thereafter, a chuck part of a tenter was slit, knurl-processed at both ends, and wound at 4 kg/cm² to obtain a roll having a thickness of 175 μm.

2) Surface Corona Treatment

Using Solid State Corona treating machine 6 KVA model manufactured by Pillar, both surfaces of a substrate were treated at 20 m/min under room temperature. Thereupon, it was found that 0.375 kV·A·min/m² treatment was done to a substrate from read values of a current and a voltage. A treating frequency thereupon was 9.6 kHz, and a gap clearance between an electrode and a dielectric roll was 1.6 mm.

3) Undercoating

3-1) Preparation of Undercoating Layer Coating Solution

Prescription (1) (for photosensitive
layer side undercoating layer)

| | | |
|---|---|---|
| Pesresin A-520 (30% by mass solution) manufactured by | 59 | g |
| Takamatsu Oil & Fat Co., Ltd. | | |
| Polyethylene glycol monononyl phenyl ether | 5.4 | g |
| (Average ethylene oxide number = 8.5) 10% by mass solution | | |
| MP-1000 (polymer fine particle, | 0.91 | g |
| average particle diameter 0.4 μm) | | |
| manufactured by Soken Chemical & Engineering Co., Ltd. | | |
| Distilled water | 935 | ml |
| Prescription (2) (for back surface first layer) | | |
| Styrene-butadiene copolymer latex | 158 | g |
| (Solid matter 40% by mass, styrene/butadiene | | |
| ratio by weight = | | |
| 68/32) | | |
| Sodium salt of 2,4-dichloro-4-hydroxy-S-triazine 8% by mass | 20 | g |
| aqueous solution | | |
| 1% by mass aqueous solution of | 10 | ml |
| sodium lauryl benzenesulfonate | | |
| Distilled water | 854 | ml |
| Prescription (3) (for back surface second layer) | | |
| SnO₂/SbO (9/1 ratio by mass, average particle | 84 | g |
| diameter 0.038 μm, | | |
| 17% by mass dispersion) | | |
| Gelatin (10% by mass aqueous solution) | 89.2 | g |
| Metholose TC-5 (2% by mass aqueous solution) | 8.6 | g |
| manufactured by | | |
| Shin-Etsu Chemical Co., Ltd. | | |
| MP-1000 manufactured by Soken Chemical & | 0.01 | g |
| Engineering Co., | | |
| Ltd. | | |
| 1% by mass aqueous solution of sodium dodecyl | 10 | ml |
| benzenesulfonate | | |
| NaOH (1% by mass) | 6 | ml |
| Proxel (manufactured by ICI) | 1 | ml |
| Distilled water | 805 | ml |

3-2) Undercoating

Each of both surfaces of the above-mentioned biaxially stretched polyethylene terephthalate substrate having a thickness of 175 μm was subjected to the above-mentioned corona discharge treatment. The above-mentioned undercoating solution prescription (1) was coated on one surface (photosensitive layer surface) with a wire bar with a wet coating amount of 6.6 ml/m² (per one surface), dried at 180° C. for 5 minutes. The above-mentioned undercoating solution prescription (2) was coated on this back (back surface) with a wire bar at a wet coating amount of 5.7 ml/m², dried at 180° C. for 5 hours. The above-mentioned undercoating solution prescription (3) was further coated on the back (back surface) with a wire bar at a wet coating amount of 7.7 ml/m², and dried at 180° C. for 6 minutes to prepare a substrate.

2. Back Layer

2-1. Preparation of Back Layer Coating Solution

1) Preparation of a Dispersion (a) of a Solid Fine Particle of a Base Precursor

1.5 kg of a base precursor compound, 225 g of Demol N (trade name, Kao Corporation), 937.5 g of diphenylsulfone, 15 g of butyl parahydroxybenzoate ester (trade name: Mexins, Uenoseiyaku K.K.) and distilled water were added so that the total amount became 5.0 kg. The materials were mixed and a mixed solution was dispersed with a traverse-type sand mill (trade name: UVM 2, I.mecs). The dispersing conditions were as follows: a mixture solution was supplied to the UVM 2 machine filled with zirconia beads having an average diameter of 0.5 mm with a diaphragm pump, and dispersion was continued at an internal pressure of 50 hPa or higher until a desired dispersion degree was attained. As a dispersion degree, a ratio of absorbances at 450 nm and 650 nm by measurement of spectroscopic absorption of a dispersion (D450/D650) was used as a standard, and dispersion was performed until the value became 2.2 or larger. After dispersion, the mixture was diluted with distilled water so that the concentration of a base precursor became 20% by weight, and filtered with a filter (average fine pore diameter: 3 μm, material: polypropyrene) for removing trashes.

2) Preparation of a Dispersion (a) of a Dye Solid Fine Particle

6.0 kg of a cyanine dye compound 1, 3.0 kg of sodium p-dodecylsulfonate, 0.6 kg of a surfactant Demol SNB manufactured by Kao Corporation, 0.15 kg of a defoaming agent (trade name: Surfinol 104E, manufactured by Nisshin Chemicals Co., Ltd.) and distilled water were mixed so that the total amount became 60 kg. The mixture solution was dispersed with a traverse-type sand mill UVM 2 using zirconia beads having an average diameter of 0.5 mm. Dispersion was performed until an absorbance ratio (D650/D750) became 5.0 or greater. After dispersion, the mixture was diluted with distilled water so that the concentration of a cyanine dye became 6% by weight, and filtered with a filter (average fine pore diameter: 1 μm material: polypropylene) for removing trashes.

3) Preparation of Halation Preventing Layer Coating Solution

30 g of gelatin, 24.5 g of polyacrylamide, 2.2 g of sodium hydroxide having the concentration of 1 mol/L, 2.4 g of a monodisperse polymethyl methacryate fine particle (average particle size 8 μm, particle diameter standard deviation 0.4), 0.08 g of benzoisothiazolinone, 35.9 g of the above-mentioned dye solid fine particle dispersion (a), 74.2 g of the above-mentioned base precursor solid fine particle dispersion (a), 0.6 g of sodium polyethylene sulfonate, 0.21 g of a blue dye compound 1, 0.15 g of a yellow dye compound 1, 8.3 g of an acrylic acid/ethyl acrylate copolymer latex (copolymerization ratio: 5:95) and water were mixed so that the total amount became 818 mL, to prepare a halation preventing layer coating solution.

4) Preparation of Back Surface Protecting Layer Coating Solution

While maintaining a container at 40° C., 40 g of gelatin, 1.5 g (in terms of liquid paraffin) of a liquid paraffin emulsion, 35 mg of benzoisothiazolinone, 6.8 g of sodium hydroxide having the concentration of 1 mol/L, 0.5 g of sodium t-octylphenoxyethoxyethanesulfonate, 0.27 g of sodium polystyrenesulfonate, 2.0 g of N, N-ethylenebis(vinylsulfonacetamide), 37 mg of a fluorine series surfactant (F-1), 150 mg of a fluorine series surfactant (F-2), 64 mg of a fluorine series surfactant (F-3), 32 mg of a fluorine series surfactant (F-4), 6.0 g of an acrylic acid/ethyl acrylate copolymer copolymerization ratio by weight 5/95), and 2.0 g of N, N-ethylenebis (vinylsulfonamide) were mixed, and a volume was adjusted to 1000 ml with water to obtain a back surface protecting layer coating solution.

2-2. Coating of Back Layer

A halation preventing layer coating solution was coated on a back surface of the above-mentioned undercoated substrate in a gelatin coated amount of 0.44 g, and a back surface protecting layer coating solution was coated thereon in a gelatin coated amount of 1.7 g/m², followed by drying to prepare a back layer. The coating of the both layers were conducted in a form of simultaneous multi-layer coating.

3. Image Forming Layer, and Surface Protecting Layer

3-1. Preparation of Coating Materials

1) Silver Halide Emulsion

(Preparation of Silver Halide Emulsion 1)

3.1 ml of a 1% by mass potassium bromide solution was added to 1421 ml of distilled water, 3.5 ml of sulfuric acid having the concentration of 0.5 mol/L and 31.7 g of phthalated gelatin were further added. The resulted solution was maintained at 30° C. while stirred in a stainless reaction vessel, and all amounts of a solution A obtained by adding distilled water to 22.22 g of silver nitrate to dilute to 95.4 ml and a solution B obtained by diluting 15.3 g of potassium bromide and 0.8 g of potassium iodide with distilled water to a volume of 97.4 ml were added at a constant flow rate over 45 seconds. Thereafter, 10 ml of a 3.5% by mass aqueous hydrogen peroxide solution was added, and 10.8 ml of a 10% by mass aqueous solution of benzimidazole was further added.

Further, an all amount of a solution C obtained by adding distilled water to 51.86 g of silver nitrate to dilute to 317.5 ml was added at a constant flow rate over 20 minutes, and a solution D obtained by diluting 44.2 g of potassium bromide and 2.2 g of potassium iodide with distilled water to a volume of 400 ml was added by a controlled double jet method while maintaining pAg at 8.1. An all amount of a potassium salt of iridate (III) hexachloride was added in an amount of 1×10⁻⁴ mol per 1 mol of silver, 10 minutes after initiation of addition of a solution C and a solution D. In addition, an all amount (3×10⁻⁴ mol per 1 mol of silver) of an aqueous potassium iron (II) hexacyanide solution was added 5 seconds after completion of addition of a solution C. PH was adjusted to 3.8 using sulfuric acid having the concentration of 0.5 mol/L, stirring was stopped, and a settlement/desalting/water washing step was performed. PH was adjusted to 5.9 using sodium hydroxide having the concentration of 1 mol/L, to prepare a silver halide dispersion having pAg of 8.0.

5 ml of a 0.34% by mass solution of 1,2-benzoisothiazoline-3-one in methanol was added while maintaining the above-mentioned silver halide dispersion at 38° C. with stirring and, after 40 minutes, a solution of a spectroscopic sensitizing dye A and a spectroscopic sensitizing dye B (mol ratio 1:1) in methanol was added in an amount that the total of a spectroscopic sensitizing dye A and a spectroscopic sensitizing dye B was 1.2×10⁻³ mol per 1 mol of silver, and a temperature was elevated to 47° C. 1 minute later. Twenty minutes after elevation of a temperature, a solution of sodium benzenethiosulfonate in methanol was added in an amount of 7.6×10⁻⁵ mol per 1 mol of silver and, 5 minutes after, a solution of a tellurium sensitizing agent C in methanol was further added in an amount of 2.9×10⁻⁴ mol per 1 mol of silver, followed by ripening for 91 minutes. 1.3 ml of a 0.8% by mass solution of N, N′-dihydroxy-N″-diethylmelamine in methanol was added and, 4 minutes later, a solution of 5-methyl-2-mercaptobenzimidazole in methanol in an amount of 4.8×10⁻³ mol per 1 mol of silver and a solution of 1-phenyl-2-heptyl-5-mercapto-1,3,4-triazole in methanol in an amount of 5.4×10⁻³ mol per 1 mol of silver were added to prepare a silver halide emulsion 1.

A particle in the prepared silver halide emulsion was a silver bromide iodide particle having an average sphere equivalent diameter of 0.042 μm and uniformly containing 3.5 mol % of iodine having a variation coefficient of a sphere equivalent diameter of 20%. A particle size and the like were obtained from an average of 1000 particles using an electron microscope. A {100} plane rate of this particle was measured using a Kubercamunk method and was found to be 80%.

(Preparation of Silver Halide Emulsion 2)

A silver halide emulsion particle 2 was prepared according to the same manner as that for preparing a silver halide emulsion 1 except that a liquid temperature of 30° C. at particle formation was changed to 47° C., a solution B was obtained by diluting 15.9 g of potassium bromide with distilled water to a volume of 97.4 ml, a solution D was obtained by diluting 45.8 g of potassium bromide with distilled water to a volume of 400 ml, a time period for adding a solution C was 30 minutes, and potassium iron (II) hexacyanide was removed, in preparation of a silver halide emulsion 2. Further, according to the same manner as that for an emulsion 1 except that a solution of a spectroscopic sensitizing dye A and a spectroscopic sensitizing dye B (mol ratio 1:1) in methanol was added in an amount that the total of a spectroscopic sensitizing dye A and a spectroscopic sensitizing dye B was 7.5×10⁻⁴ mol per 1 mol of silver, a solution of a tellurium sensitizing agent C in methanol was added in an amount of 1.1×10⁻³ mol per 1 mol of silver, and 1-phenyl-2-heptyl-5-mercapto-1,3,4-triazole was added in an amount of 3.3×10⁻³mol per 1 mol of silver, spectroscopic sensitization and chemical sensitization were performed, and 5-methyl-2-mercaptobenzimidazole, and 1-phenyl-2-heptyl-5-mercapto-1,3,4-triazole were added, to prepare a silver halide emulsion 2.

The resultant silver halide emulsion particle was a cubic particle of pure silver bromide having an average sphere equivalent diameter of 0.080 μm and a variation coefficient of a sphere equivalent diameter of 20%.

(Preparation of Silver Halide Emulsion 3)

According to the same manner as that for preparing a silver halide emulsion 1 except that a solution temperature of 30° C. at particle formation was changed to 27° C., a silver halide emulsion particle was prepared. Further, settlement/desalting/water washing/dispersion were performed as in a silver halide emulsion 1. According to the same manner as that for a silver halide emulsion 1 except that a spectroscopic sensitizing dye A and a spectroscopic sensitizing dye B (mol ratio 1:1) was used as a solid dispersion (dispersed in an aqueous gelatin solution), the total of a spectroscopic sensitizing dye A and a spectroscopic sensitizing dye B per 1 mol of silver was changed to 6×10⁻³ mol, a tellurium sensitizing agent C was changed to 5.2×10⁻⁴ mol per 1 mol of silver, and aurate bromide in an amount of 5×10⁻⁴ mol per 1 mol of silver and potassium thiocyanate in an amount of 2×10⁻³ mol per 1 mol of silver were added three minutes after addition of a tellurium sensitizing agent, a silver halide emulsion 3 was obtained.

The resultant silver halide emulsion particle was a silver bromide iodide particle containing 3.5 mol % of iodine uniformly and having an average sphere equivalent diameter of 0.034 μm and a variation coefficient of a sphere equivalent diameter of 20%.

(Preparation of Mixed Silver Halide Emulsion A for Coating)

70% by weight of a silver halide emulsion 1, 15% by weight of a silver halide emulsion 2, and 15% by weight of a silver halide emulsion 3 were dissolved, a 1% by mass aqueous solution of benzothiazolium iodide was added in an amount of 7×10⁻³ mol per 1 mol of silver. Further, water was added so that a content of silver halide per 1 kg of a mixed emulsion became 38.2 g in terms of silver.

2) Preparation of Fatty Acid Silver Dispersion

(Preparation of Fatty Acid Silver Dispersion A)

87.6 kg of behenic acid (product name Edenor C22-85R) manufactured by Henkel, 423 L of distilled water, 49.2 L of an aqueous NaOH solution having the concentration of 5 mol/L, and 120 L of t-butyl alcohol were mixed, and stirred at 75° C. for 1 hour to react them, to obtain a sodium behenate solution A. Separately, 206.2 L of an aqueous solution (pH 4.0) containing 40.4 kg of silver nitrate was prepared, and a temperature was retained at 10+ C. A reaction container containing 635 L of distilled water and 30 L of t-butyl alcohol was maintained at 30° C., and an all amount of the above-mentioned sodium behenate solution A and an all amount of an aqueous silver nitrate solution were added at a constant flow rate over 93 minutes and 15 seconds and 90 minutes, respectively, while sufficiently stirring.

Thereupon, for 11 minutes after initiation of addition of an aqueous silver nitrate solution, only an aqueous silver nitrate solution was added and, thereafter, addition of a sodium behenate solution A was initiated and, for 14 minutes and 15 seconds after completion of addition of an aqueous silver nitrate solution, only a sodium behenate solution A was added. Thereupon, a temperature in a reaction container was 30° C., and a temperature was controlled from the outside so that a temperature of the solution became constant.

In addition, a piping for adding a sodium behenate solution A was lagged by circulating warm water outside a double tube, and regulated so that a solution temperature at an outlet at a tip of an addition nozzle became 75° C. In addition, a piping for adding an aqueous silver nitrate solution was lagged by circulating cool water outside a double tube. A position at which a sodium behenate solution A was to be added, and a position at which an aqueous silver nitrate solution was to be added were arranged symmetrically relative to a stirring axis as a center, and those positions were adjusted at a height so as not to contact with a reaction solution.

After addition of a sodium behenate solution A was completed, the system was stirred at that temperature for 20 minutes, a temperature was elevated to 35° C. taking 30 minutes and, thereafter, ripening was performed for 210 minutes. Immediately after completion of ripening, the solid matters were filtered off by centrifugation filtration, the solid matters were washed with water until the conductivity of filtered water became 30 μS/cm. Thus, a fatty acid silver salt was obtained. The resultant solid matters were retained as a wet cake without drying.

When the morphology of the resultant silver behenate particle was assessed by electron microscope photographing, as an average, a was 0.14 μm, b was 0.4 μm, c was 0.6 μm, and an average aspect ratio was 5.2 (a, b and c were defined in this text). As a result of measurement with a laser light scattering-type particle size measuring apparatus, a scale-like crystal having an average sphere equivalent diameter of 0.52 μm and a variation coefficient of a sphere equivalent diameter of 15% was obtained. 19.3 kg of polyvinyl alcohol (trade name: PVA-217, Kuraray Co., Ltd.) and water were added to a wet cake equivalent to 260 kg of dry solid matter, so that the total amount became 1000 kg. The materials were converted into a slurry with a Dissolver blade, and pre-dispersed with a pipeline mixer (manufactured by MIZUHO Industrial Co., Ltd.: PM-10 type).

Then, the pre-dispersed stock solution was treated three times by a dispersing machine (trade name: Microfluidizer M-610, manufactured by Microfluidecks International Corporation, using a Z-type interaction chamber) in which a pressure was adjusted at 1260 kg/cm², whereby, a silver behenate dispersion was obtained. In the cooling operation, a temperature of a dispersion was set at 18° C. by attaching coiled heat exchangers before and after an interaction chamber, respectively, and regulating a temperature of a refrigerant.

(Preparation of Fatty Acid Silver Dispersion B)

<Preparation of Recrystallized Behenic Acid >

100 kg of behenic acid (product name Edenor C22-85R) manufactured by Henkel was dissolved by addition of 1200 kg of ispropyl alcohol at 50° C., the solution was filtered with a 10 μm filter, and cooled to 30° C. to recrystallize the acid. A cooling rate for recrystallization was controlled at 3° C./hour. The obtained crystals were centrifugation-filtered, washed with 100 kg of isopropyl alcohol, and dried. Highly pure behenic acid was obtained which has a content of behenic acid of 96% by mass, a content of lignoceric acid of 2% by mass and a content of arachidic acid of 2% by mass. Analysis of this composition was performed by esterifying the recrystallized acid and measuring it by the GC-FID method.

<Preparation of Fatty Acid Silver Dispersion B >

88 kg of recrystallized behenic acid, 422 L of distilled water, 49.2 L of an aqueous NaOH solution having the concentration of 5 mol/L, and 120 L of t-butyl alcohol were mixed and reacted, while stirred, at 75° C. for 1 hour , to obtain a sodium behenate solution B. Separately, 206.2 L of an aqueous solution (pH 4.0) containing 40.4 kg of silver nitrate was prepared, and kept at 10° C. A reaction container containing 635 L of distilled water and 30 L of t-butyl-alcohol was kept at 30° C., and an all amount of the above-mentioned sodium behenate solution B and an all amount of an aqueous silver nitrate solution were added at a constant flow rate taking 93 minutes and 15 seconds and 90 minutes, respectively, while sufficiently stirring the reaction container.

Thereupon, for 11 minutes after initiation of addition of an aqueous silver nitrate solution, only an aqueous silver nitrate solution was added and, thereafter, addition of a sodium behenate solution B was initiated and, for 14 minutes and 15 seconds after completion of addition of an aqueous silver nitrate solution, only a sodium behenate solution B was added. Thereupon, a temperature in a reaction container was 30° C., and a temperature was controlled from the outside so that a temperature of the solution became constant.

In addition, a piping for adding a sodium behenate solution B was lagged by circulating warm water outside a double tube, and regulated so that a solution temperature at an outlet at a tip of an addition nozzle became 75° C. In addition, a piping for adding an aqueous silver nitrate solution was lagged by circulating cool water outside a double tube. A position at which a sodium behenate solution B was to be added, and a position at which an aqueous silver nitrate solution was to be added were arranged symmetrically relative to a stirring axis as a center, and those positions were adjusted at a height so as not to contact with a reaction solution.

After addition of a sodium behenate solution B was completed, the system was stirred at that temperature for 20 minutes, a temperature was elevated to 35° C. for 30 minutes and, thereafter, ripening was performed for 210 minutes. Immediately after completion of ripening, the solid matters were filtered off by centrifugation filtration, the solid matters were washed with water until the conductivity of filtered water became 30 μS/cm. Thus, a fatty acid silver salt was obtained. The resultant solid matters were retained as a wet cake without drying.

When a shape of the resultant silver behenate particle was assessed by electron microscope photographing, the particle was a crystal having, as an average, a of 0.21 μm, b of 0.4 μm, c of 0.4 μm, an average aspect ratio of 2.1, an average sphere equivalent diameter of 0.51 μm, and a variation coefficient of a sphere equivalent diameter of 11% (a, b and c were defined in the text). 19.3 kg of polyvinyl alcohol (trade name: PVA-217, Kuraray Co., Ltd.) and water were added to a wet cake equivalent to 260 kg of dry solid matter, to a total amount of 1000 kg, the materials were converted into a slurry with a Dissolver wing, and pre-dispersed with a pipeline mixer (manufactured by MIZUHO Industrial Co., Ltd.: PM-10 type).

Then, the pre-dispersed stock solution was treated three times by a dispersing machine (trade name: Microfluidizer M-610, manufactured by Microfluidecks International Corporation, using a Z-type interaction chamber), in which a pressure was adjusted at 1150 kg/cm², whereby, a silver behenate dispersion B was obtained. In the cooling operation, a temperature of a dispersion was set at 18° C. by attaching coiled heat exchangers before and after an interaction chamber, respectively, and regulating a temperature of a refrigerant.

3) Preparation of Reducing Agent Dispersion

<Preparation of Reducing Complex 1 Dispersion >

10 kg of water was added to 10 kg of a reducing agent complex 1, 0.12 kg of triphenylphosphine oxide, and 16 kg of a 10% by mass aqueous solution of modified polyvinyl alcohol (manufactured by Kuraray Co., Ltd., Poval MP 203), and the materials were mixed well into a slurry. This slurry was supplied with a diaphragm pump, dispersed for 4 hours and 30 minutes with a traverse-type sand mill (UVM 2: manufactured by I.mecs) charged with zirconia beads having an average diameter of 0.5 mm, and 0.2 g of a sodium salt of benzoisothiazolinone and water were added to adjust the concentration of a reducing agent complex to 22% by mass, to obtain a dispersion of a reducing agent complx-1.

A dispersing time was adjusted so that a reducing agent complex particle contained in thus obtained reducing agent complex dispersion had an average particle size (median diameter) of 0.45 μm. A maximum particle diameter of these dispersions was 1.4 μm or smaller. The resultant dispersion was filtered with a polypropylene filter having a pore diameter of 3.0 μm, to remove foreign matters such as trash.

<Preparation of Dispersion of Reducing Agent 2>

10 kg of water was added to 10 kg of a reducing agent 2, and 16 kg of a 10% by mass aqueous solution of modified polyvinyl alcohol MP203, and the materials were mixed well into a slurry. This slurry was supplied with a diaphragm pump, dispersed for 3 hours and 30 minutes with a traverse-type sand mill UVM 2 charged with zirconia beads having an average diameter of 0.5 mm, and 0.2 g of a sodium salt of benzoisothiazolinone and water were added to adjust the concentration of a reducing agent to 25% by mass. This dispersion was subjected to heating treatment at 60° C. for 5 hours to obtain a dispersion of a reducing agent 2.

A reducing agent particle contained in the thus obtained reducing agent dispersion had an average particle size (median diameter) of 0.40 μm and a maximum particle diameter of 1.5 μm. The resultant dispersion was filtered with a polypropylene filter having a pore diameter of 3.0 μm to remove foreign matters such as trashes.

Regarding reducing agents 3 to 5, each dispersion was obtained as in a reducing agent 2.

4) Preparation of Hydrogen-Bonding Compound 1

10 kg of water was added to 10 kg of a hydrogen-bonding compound 1 and 16 kg of a 10% by mass aqueous solution of modified polyvinyl alcohol MP203, and the materials were mixed well into a slurry. This slurry was supplied with a diaphragm pump, dispersed for 3 hours and 30 minutes with a traverse-type sand mill UVM 2 charged with zirconia beads having an average diameter of 0.5 mm, and 0.2 g of a sodium salt of benzoisothiazolinone and water were added to adjust so that the concentration of a hydrogen-bonding compound became 25% by mass. This dispersion was warmed at 80° C. for 1 hour to obtain a dispersion of a hydrogen-bonding compound 1.

A hydrogen-bonding compound particle contained in the thus obtained dispersion had an average particle size (median diameter) of 0.35 μm and a maximum particle diameter of 1.5 μm or smaller. The resultant dispersion was filtered with a polypropylene filter having a pore diameter of 3.0 μm to remove foreign matters such as trash.

5) Preparation of Development Accelerator-1 Dispersion

10 kg of water was added to 10 kg of a development accelerator 1 and 20 kg of a 10% by mass aqueous solution of modified polyvinyl alcohol MP203, and the materials were mixed well into a slurry. This slurry was supplied with a diaphragm pump, dispersed for 3 hours and 30 minutes with a traverse-type sand mill UVM 2 charged with zirconia beads having an average diameter of 0.5 mm, and 0.2 g of a sodium salt of benzoisothiazolinone and water were added to adjust so that the concentration of a development accelerator became 20% by mass, whereby, a development accelerator-1 dispersion was obtained.

A development accelerator particle contained in the thus obtained development accelerator-1 dispersion had a median diameter of 0.48 μm and a maximum particle diameter of 1.4 μm or filter. The resulting development accelerator-1 dispersion was filtered with a polypropylene filter having a pore diameter of 3.0 μm, to remove foreign matters such as trash.

6) A Solid Dispersion of Development Accelerator 2 and Tone Adjusting Agent 1

Regarding a solid dispersion of a development accelerator 2 and a tone adjusting agent 1, the materials were dispersed according to the same manner as that for a development accelerator 1, to obtain a 20% by mass dispersion.

7) Preparation of Polyhalogen Compound Dispersion

<Organic Polyhalogen Compound 1 Dispersion>

10 kg of an organic polyhalogen compound 1, 10 kg of a 20% by mass aqueous solution of modified polyvinyl alcohol MP 203, 0.4 kg of a 20% by mass aqueous solution of sodium triisopropylnaphthalenesulfonate, and 14 kg of water were added, and the materials were mixed well into a slurry. This slurry was supplied with a diaphragm dispersed for basically 5 hours with a traverse-type sand mill UVM 2 charged with zirconia beads having an average diameter of 0.5 mm, 0.2 g of a sodium salt of benzoisothiazolinone and water were added to adjust so that the concentration of an organic polyhalogen compound became 26% by mass, whereby, a polyhalogen compound 1 dispersion was obtained.

An organic polyhalogen compound particle contained in the thus obtained dispersion had a median diameter of 0.41 μm and a maximum particle diameter of 2.0 μm or smaller. The resulting organic polyhalogen compound dispersion was filtered with a polypropylene filter having a pore diameter of 10.0 μm, to remove foreign matters such as trashes.

<Organic Polyhalogen Compound 2 Dispersion>

10 kg of an organic polyhalogen compound 2, 20 kg of a 10% by mass aqueous solution of modified polyvinyl alcohol MP203, and 0.4 kg of a 20% by mass aqueous solution of sodium triisopropylnaphthalenesulfonate were added, and the materials were mixed well into a slurry. This slurry was supplied with a diaphragm pump, dispersed for 5 hours with a traverse-type sand mill UVM 2 charged with zirconia beads having an average diameter of 0.5 mm, and 0.2 g of a sodium salt of benzoisothiazolinone and water were added to adjust so that the concentration of an organic polyhalogen compound became 30% by mass. This suspension was warmed at 40° C. for 5 hours to obtain a polyhalogen compound 2 dispersion.

An organic polyhalogen compound particle contained in the thus obtained dispersion had an average particle size (median diameter) of 0.40 μm and a maximum particle diameter of 1.3 μm or smaller. The resultant organic polyhalogen compound dispersion was filtered with a polypropylene filter having a pore diameter of 3.0 μm to remove foreign matters such as trashes.

8) Preparation of phthalazine Compound 1 Solution

8 kg of modified polyvinyl alcohol MP203 was dissolved in 174.57 kg of water, and 3.15 kg of a 20% by mass aqueous solution of sodium triisopropylnaphtharenesulfonate and 14.28 kg of a 70% by mass aqueous solution of a phthalazine compound 1 were added to prepare a 5% by mass solution of a phthalazine compound 1.

9) Preparation of Aqueous Mercapto Compound Solution

<Aqueous Mercapto Compound 1 Solution>

7 g of a mercapto compound 1 was dissolved in 993 g of water to obtain a 0.7% by mass aqueous solution.

<Aqueous Mercapto Compound 2 solution>

20 g of a mercapto compound 2 was dissolved in 980 g of water to obtain a 2.0% by mass aqueous solution.

10) Preparation of Pigment 1 Dispersion

250 g of water was added to 64 g of C.I.Pigment Blue 60 and 6.4 g of Demol N manufactured by Kao Corporation, and the materials were mixed well into a slurry. 800 g of zirconia beads having an average diameter of 0.5 mm and the slurry were placed into a vessel, dispersed for 25 hours with a ¼G sand grinder (manufactured by I.mecs), and water was added to dilute the pigment concentration to 5% by mass, to obtain a pigment-1 dispersion. An average particle size of a pigment in the resultant dispersion was 0.21 μm.

11) Preparation of SBR Latex Solution

A SBR latex having Tg=22° C. was prepared as follows: Using ammonium persulfate as a polymerization initiator and an anionic surfactant as an emulsifying agent, 70.0 mass of styrene, 27.0 mass of butadiene and 3.0 mass of acrylic acid were emulsion- polymerized, followed by aging at 80° C. for 8 hours. Thereafter, the material was cooled to 40° C., and pH was adjusted to 7.0 with aqueous ammonia, and Sandead BL manufactured by Sanyo Chemical Industries, Ltd. was added in an amount of 0.22%. Then, a 5% aqueous sodium hydroxide solution was added to adjust pH to 8.3, and pH was adjusted to 8.4 with aqueous ammonia.

A mol ratio of a Na⁺ ion and a NH₄⁺ ion used thereupon was 1:2.3. Further, to 1 kg of this solution was added 0.15 ml of a 7% aqueous solution of a sodium salt of benzoisothiazolinone to prepare a SBR latex solution.

(SBR latex: latex of-St(70.0)-Bu(27.0)-AA(3.0)-) has Tg of 22° C., an average particle diameter of 0.1 μm, the concentration of 43% by mass, an equilibrium moisture content at 25° C. and 60% RH of 0.6% by mass, an ion conductivity of 4.2 mS/cm (the ion conductivity was measured by measuring a latex stock solution (43% by mass) at 25° C. using a conductivity meter CM-30s manufactured by DKK-TOA Corporation) and pH of 8.4.

A SBR latex having different Tg can be prepared by appropriately changing a ratio of styrene and butadiene, according to the similar method.

3-2) Preparation of Coating Solution

1) Preparation of Image Forming Layer Coating Solution-1

1000 g of the fatty acid silver dispersion A obtained above, 276 ml of water, 33 g of a pigment 1 dispersion, 21 g of an organic polyhalogen compound 1 dispersion, 58 g of an organic polyhalogen compound 2 dispersion, 173 g of a phthaladine compound 1 solution, 1082 g of a SBR latex (Tg: 22° C.) solution, 299 g of a reducing agent complex 1 dispersion, 6 g of a development accelerator 1 dispersion, 9 ml of an aqueous mercapto compound 1 solution, and 27 ml of an aqueous mercapto compound 2 solution were successively added, 117 g of a silver halide mixed emulsion A was added immediately before coating, the materials were mixed well, and the resultant emulsion layer coating solution was supplied as it was to a coating die, to perform coating.

A viscosity of the above emulsion layer coating solution was measured with a B-type viscometer of Tokyokeiki and found to be 25[mPa.S] at 40° C. (No. 1 rotor, 60 rpm).

A viscosity of the coating solution at 25° C. measured with a RFS fluid spectrometer manufactured by Rheometric Scientific FE. Ltd. was 230, 60, 46, 24 or 18 [mPa.S] at a shear rate of 0.1, 1, 10, 100 or 1000[ 1/sec], respectively.

In addition, an amount of zirconium in a coating solution was 0.38 mg per 1 g of silver.

2) Preparation of Intermediate Layer Coating Solution

27 ml of a 5% by mass aqueous solution of Aerosol OT (manufactured by American Cyanamide), 135 ml of a 20% by mass aqueous solution of a diammonium salt of phthalic acid, and water were added to 1000 g of polyvinyl alcohol (PVA205 (manufactured by Kuraray Co., Ltd.), 272 g of a pigment-1 dispersion, and 4200 ml of a 19% by mass solution of a methyl methacrylate/styrene/butyl acrylate/hydroxyethyl methacrylate/acrylic acid copolymer (copolymerization ratio by weight 64/9/20/5/2) latex, so that the total amount became 10,000 g, pH was adjusted to 7.5 with NaOH to obtain an intermediate layer coating solution, and this solution was supplied at 9.1 ml/m² to a coating die.

A viscosity of the coating solution was measured with a B-type viscometer (No. 1 roter, 60 rpm) at 40° C. and found to be 58 [mPa.S].

3) Preparation of Surface Protecting First Layer Coating Solution

64 g of inert gelatin dissolved in water, 80 g of a 27.5% by mass solution of a methyl methacrylate/styrene/butyl acrylate/hydroxyethyl methacrylate/acrylic acid copolymer (copolymerization ratio by weight 64/9/20/5/2) latex, 23 ml of a 10% by mass solution of phthalic acid in methanol, 23 ml of a 10% by mass aqueous solution of 4-methylphthalic acid, 28 ml of sulfuric acid having the concentration of 0.5 mol/L, 5 ml of a 5% by mass aqueous solution of Aerosol OT (manufactured by American Cyanamide), 0.5 g of phenoxyethanol, and 0.1 g of benzoisothiazolinone were added, water was added to make the total amount 750 g to prepare a coating solution. 26 mg of 4% by mass of chromium alum was mixed in the coating solution with a static mixer immediately before coating, and the mixture was supplied at 18.6 ml/m² to a coating die.

A viscosity of the coating solution was measured with a B-type viscometer (No. 1 rotor, 60 rpm) at 40° C. and found to be 20[mPa.S].

4) Preparation of Surface Protecting Second Layer Coating Solution

Water was added to 80 g of inert gelatin dissolved in water, 102 g of a 27.5% by mass solution of methyl methacrylate/styrene/butyl acrylate/hydroxyethyl methacrylate/acrylic acid copolymer (copolymerization ratio by weight 64/9/20/5/2) latex, 3.2 ml of a 5% by mass solution of a fluorine series surfactant F-1, 32 ml of a 2% by mass aqueous solution of a fluorine series surfactant F2, 23 ml of a 5% by mass solution of Aerosol OT, 4 g of a polymethyl methacrylate fine particle (average particle diameter 0.7 μm), 21 g of a polymethyl methacrylate fine particle (average particle diameter 4.5 μm), 1.6 g of 4-methylphthalic acid, 4.8 g of phthalic acid, 44 ml of sulfuric acid having the concentration of 0.5 mol/L, and 10 mg of benzoisothiazolinone, so that the total amount became 650 g. 445 ml of an aqueous solution containing 4% by mass of chromium alum and 0.67% by mass of phthalic acid was mixed therein with a static mixer immediately before coating, to obtain a surface protecting layer coating solution, which was supplied at 8.3 ml/m² to a coating die.

A viscosity of the coating solution was measured with a B-type viscometer (No. 1 rotor, 60 rpm) at 40° C. and found to be 19 [mPa.S].

3-2. Preparation of Coating Sample

1) Preparation of Thermally Developable Photosensitive Material 1 (Comparative Sample)

An image forming layer coating solution-1, and each coating solution for an intermediate layer, a surface protecting first layer, and a surface protecting second layer were successively coated on a surface opposite to a back surface in a simultaneous multi-layer coating manner by a slide bead coating method, to obtain a thermally developable photosensitive material 1. A temperature of each coating solution was adjusted to 31° C. in the case of an image forming layer and an intermediate layer, 36° C. in the case of a protecting layer first layer, and 37° C. in the case of a protecting layer second layer.

A coating amount (g/m²) of each compound for an emulsion layer was as follows:

| | |
|---|---|
| Fatty acid silver dispersion A | 5.58 |
| (in terms of amount of fatty acid silver) | |
| C.I. Pigment Blue 60 | 0.036 |
| Organic polyhalogen compound 1 | 0.12 |
| Organic polyhalogen compound 2 | 0.37 |
| Phthalazine compound 1 | 0.19 |
| SBR latex | 9.97 |
| Reducing agent complex 1 | 1.41 |
| Development accelerator 1 | 0.024 |
| Mercapto compound 1 | 0.002 |
| Mercapto compound 2 | 0.012 |
| Silver halide (in terms of Ag) | 0.091 |

The coating drying conditions were as follows:

Coating was performed at a speed of 160 m/min, a gap between a tip of a coating die and a substrate was set at 0.10 to 0.30 mm, and a pressure in a reduced chamber was set lower by 196 to 882 Pa relative to atmospheric pressure. A substrate was static eliminated with an ion wind before coating.

Subsequently, a coating solution was cooled with a wind at a dry-bulb temperature of 10 to 20° C. in a chilling zone, conveyed in a contactless manner, and dried with a dry wind at a dry-bulb temperature of 23 to 45° C. and a wet-bulb temperature of 15 to 21° C. in a helix contactless-type drying apparatus.

After drying, moisture conditioning was performed at 25° C. and humidity of 40 to 60% RH, and a film surface was heated to 70 to 90° C. After heating, a film surface was cooled to 25° C.

A mat degree in terms of Beck smoothness of the resultant thermally developable photosensitive material was 550 seconds on an image forming layer side and 130 seconds on a back surface. In addition, pH of a film surface on an image forming layer side was measured and found to be 6.0.

2) Preparation of Thermally Developable Photosensitive Materials 2 to 9

According to the same manner as that for a thermally developable photosensitive material 1 except that silver behenate B was used in place of a silver behenate A dispersion in an image forming layer coating solution-1, an addition amount thereof was changed as shown in Table 1, a reducing agent complex 1 dispersion was removed and, instead, a reducing agent 2 dispersion was used in an amount indicated in Table 1 (reducing agent 2 amount), 0.6 g/m² of a hydrogen-bonding compound 1 was used, photosensitive silver halide was used in an amount of 0.11 g/m² in terms of a coated silver amount, a mercapto compound 1 was removed, a coating amount of a mercapto compound 2 was changed to 0.01 g/m², and an addition amount of an organic polyhalogen compound 2 dispersion, and an amount of a development accelerator 1 dispersion were changed to amounts indicated in Table 1, thermally developable photosensitive materials 2 to 9 were prepared. Among them, sample Nos. 5, 7 and 9 were comparative samples.

3) Preparation of Thermally Developable Photosensitive Materials 10 to 20

According to the same manner as a thermally developable photosensitive material 1 except that silver behenate B was used in place of a silver behenate A dispersion in an image forming layer coating solution-1, an addition amount thereof was changed as indicated in Table 1, a reducing agent complex 1 dispersion was removed, instead, a reducing agent 2 dispersion was used in an amount indicated in Table 1 (reducing agent 2 amount) was used, a hydrogen-bonding compound 1 was used at 0.3 g/m², photosensitive silver halide was used at 0.13 g/m² in terms of a coated silver amount, further, a mercapto compound 1 was removed, a coating amount of a mercapto compound 2 was changed to 0.003 g/m², an addition amount of an organic polyhalogen compound 1 dispersion was changed to 0.18 g/m², further, an addition amount of an organic polyhalogen compound 2 dispersion, and an amount of a development accelerator 1 dispersion were changed to amounts indicated in Table 1, and newly a tone adjusting agent 1 dispersion was added in an amount of 0.01 g/m² (coating amount of tone adjusting agent 1), and a development accelerator 2 dispersion was added in an amount indicated in Table 1, thermally developable photosensitive materials 10 to 20 were prepared. Among them, sample Nos. 14, 16, 18 and 20 were comparative samples.

Chemical structures of compounds used in Examples of the invention will be shown below.

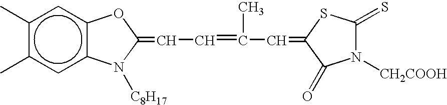

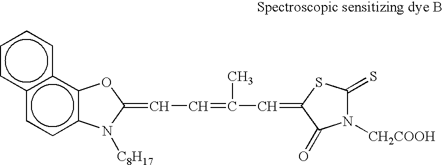

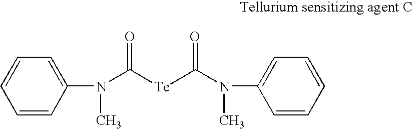

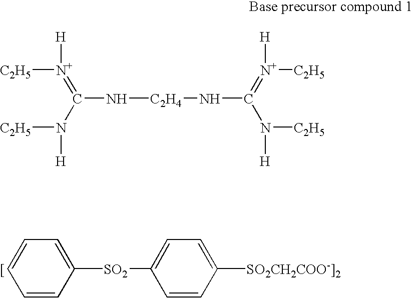

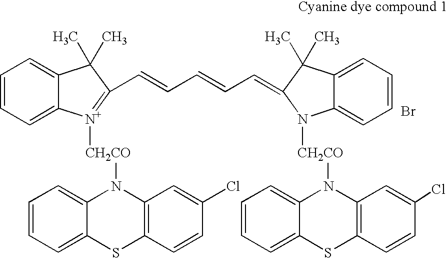

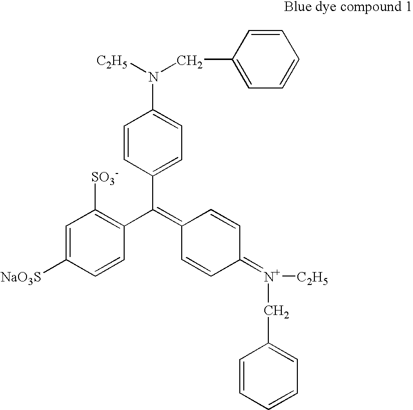

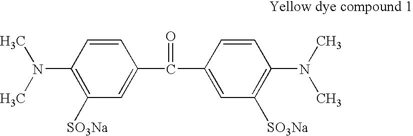

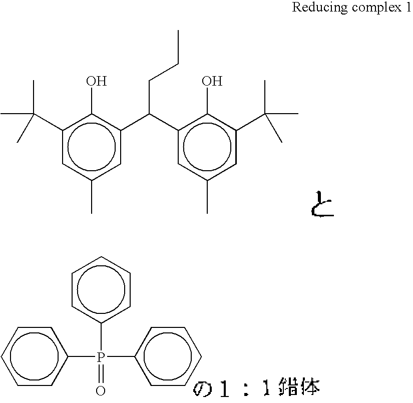

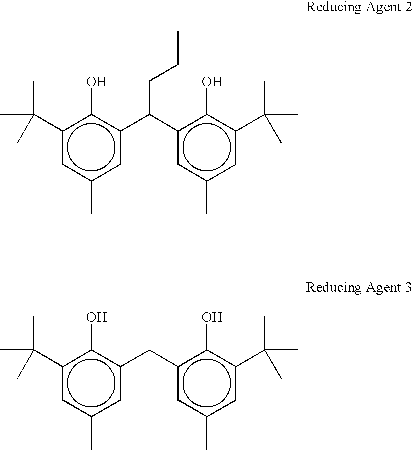

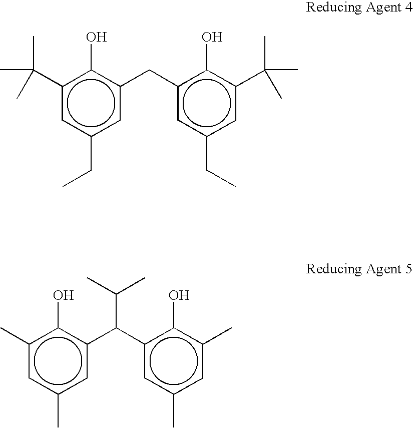

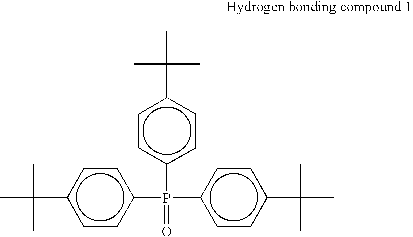

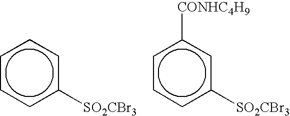

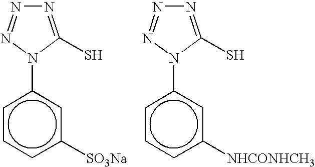

Phthalazine compound 1 Development accelerator 1

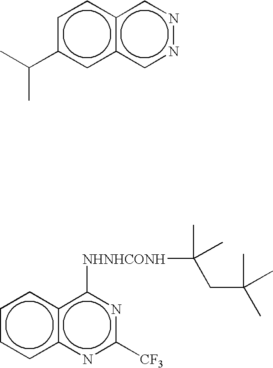

Development accelerator 2 Tone adjusting agent 1

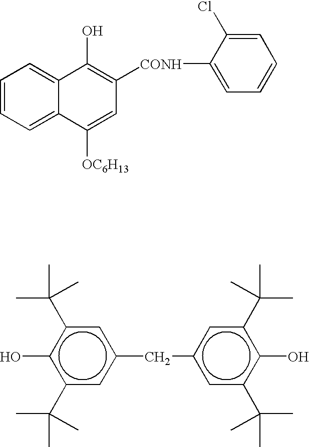

CF₃(CF₂)ₙCH₂CH₂SCH₂CH₂COOL i (F-1)

Mixture of n=5 to 11

CF₃(CF₂)ₙCH₂CH₂O(CH₂CH₂O) mH (F-2)

Mixture of n=5 to 11, m=5 to 15

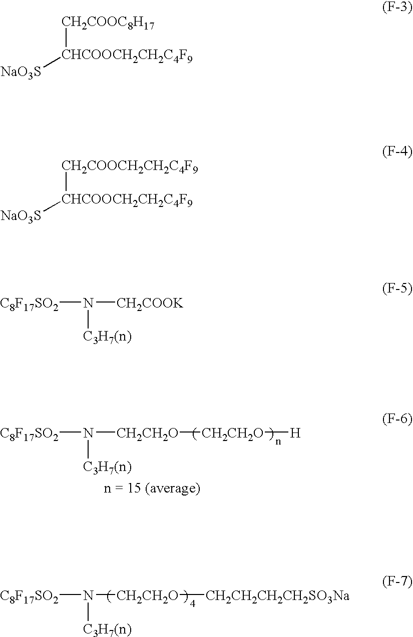

C₈F₁₇SO₃K (F-8)

4. Assessment of Photographic Performance

(Preparation)

The resultant sample was cut into a half-cut size, packaged into the following packaging material under an environment of 25° C. 50% RH, and stored at a normal temperature for 2 weeks.

(Packaging Material)

PET10 μm/PE12 μm/aluminium foil 9 μm/Ny 15 μm/polyethylene containing 3% carbon 50 μm

Oxygen permeating rate: 0.02 ml/atm·m²·25° C.·day, moisture permeating rate: 0.10 g/atm·m²·25° C.·day

(Exposure and Thermal Developing Treatment of Photosensitive Material)

Exposing and thermal developing treatment was performed with Fuji Medical Dry Laser Imager FM-DP-L (carrying a 660 nm semiconductor laser having an output of maximum 60 mW (IIIB)).

Four panel heaters were set at 112° C.-119° C.-121° C.-121° C., and thermally developable photosensitive materials 1 to 9 were thermally developed 24 seconds in total, and thermally developable photosensitive materials 10 to 20 were thermally developed for 14 seconds in total.

(Assessment)

The fog density was measured with a Macbeth TR-927-type densitometer. A color difference was measured with a spectroscopic densitometer according to JIS Z8722, and L*, a* and b* of CIELAB color display system were obtained. In addition, L*, a* and b* were obtained as values with the test light F 5 (day light color) defined in JIS Z 8719 based on calorimetric data obtained by a spectroscopic calorimetric densitometer. In samples 1 to 20, a value of b₀* at a fog density portion was in a range of −10.9 to −8.8.

Regarding respective samples, the shelf stability was measured under an environmental conditions which were the following forcible aging conditions, for samples of immediately after thermal development and samples of after 10 minutes exposure with 10,000 Lux high illuminance schaukasten.

(a) leaving under 30° C. and 60% RH environment for 9 months

(b) leaving under 40° C. and 40% RH environment for 3 months

(c) leaving under 45° C. and 40% RH environment for 1 week

Color differences before and after a point when an amount of time has passed under each a point when an amount of time has passed condition were calculated from the above-mentioned equation (1). A color difference was different depending on the image density, and a value at an intermediate density part (D=1.2 to 1.6) where a color difference was greatest is described in Table 1. In addition, fog density differences before and after a point when an amount of time has passed were obtained, and only fog density changes under the condition (c) where the change was greatest are described in Table 1.

(Assessment of Tone)

The respective thermally developed samples prepared above were observed with naked eyes, and an extent of a tone change of samples before and after a point when an amount of time has passed were assessed based on the following assessment criteria, regarding samples which were naturally stored for 2 years under an environment (normal temperature and normal humidity) in a storage chamber in a normal medical fascilities. Assessment ranks A to C were judged as a practically acceptable range.

A: A change in tone could not be recognized visually at all.

B: When stared, a slight change in tone could be recognized visually, but there was practically no problem.

C: There was a part, for which a change in tone could be recognized visually depending on an exposed amount, but there was no sense of incongruity before and after a point when an amount of time has passed.

The foregoing results are summarized in Table 1.

TABLE 1

| | | Entire | | | Coated | Coated | | | | | | |
|---|---|---|---|---|---|---|---|---|---|---|---|---|
| | Coated | amount | | Coated | amount of | amount of | Fog density | | | | | |
| | amount | of | Coated | amount of | develop- | develop- | value | | Color difference | | | Rank of |
| | of silver | coated | amount of | reducing | ment ac- | ment ac- | Immediately | | Condi- | Condi- | Condi- | tone |
| | behenate | silver | polyhaloge | agent 2 | celerator 1 | celerator 2 | after | | tion | tion | tion | assess- |
| Sample No. | (g/m²) | (g/m²) | n 2 (g/m²) | (g/m²) | (g/m²) | (g/m²) | treatment | Δ(c) | (a) | (b) | (c) | ment |
| 1 (Comparative | 5.55 | 1.43 | 0.37 | — | 0.024 | — | 0.17 | 0.03 | 2.09 | 2.95 | 1.55 | D |
| Example) | | | | | | | | | | | | |
| 2 (Invention) | 5.55 | 1.45 | 0.25 | 0.81 | 0.024 | — | 0.16 | 0.01 | 0.89 | 0.90 | 0.58 | B |
| 3 (Invention) | 7.00 | 1.80 | 0.25 | 0.81 | 0.024 | — | 0.18 | 0.02 | 1.34 | 1.27 | 0.89 | C |
| 4 (Invention) | 5.55 | 1.45 | 0.25 | 0.89 | 0.024 | — | 0.17 | 0.01 | 1.19 | 1.28 | 0.85 | C |
| 5 (Comparative | 5.55 | 1.45 | 0.25 | 0.97 | 0.024 | — | 0.21 | 0.02 | 1.67 | 1.82 | 1.21 | D |
| Example) | | | | | | | | | | | | |
| 6 (Invention) | 5.55 | 1.45 | 0.25 | 0.81 | 0.029 | — | 0.18 | 0.01 | 0.93 | 0.86 | 0.62 | B |
| 7 (Comparative | 5.55 | 1.45 | 0.25 | 0.81 | 0.036 | — | 0.23 | 0.01 | 1.43 | 1.36 | 1.03 | D |
| Example) | | | | | | | | | | | | |
| 8 (Invention) | 5.55 | 1.45 | 0.20 | 0.81 | 0.024 | — | 0.17 | 0.02 | 1.21 | 1.17 | 0.86 | C |
| 9 (Comparative | 5.55 | 1.45 | 0.15 | 0.81 | 0.024 | — | 0.22 | 0.04 | 1.61 | 1.54 | 1.11 | D |
| Example) | | | | | | | | | | | | |
| 10 (Invention) | 5.55 | 1.47 | 0.30 | 0.81 | 0.024 | 0.025 | 0.16 | 0.01 | 0.59 | 0.57 | 0.30 | A |
| 11 (Invention) | 6.25 | 1.64 | 0.30 | 0.81 | 0.024 | 0.025 | 0.17 | 0.015 | 0.90 | 0.87 | 0.59 | B |
| 12 (Invention) | 7.00 | 1.82 | 0.30 | 0.81 | 0.024 | 0.025 | 0.18 | 0.02 | 1.17 | 1.15 | 0.88 | C |
| 13 (Invention) | 5.55 | 1.47 | 0.30 | 0.89 | 0.024 | 0.025 | 0.17 | 0.01 | 0.76 | 0.83 | 0.55 | B |
| 14 (Comparative | 5.55 | 1.47 | 0.30 | 0.97 | 0.024 | 0.025 | 0.21 | 0.02 | 1.26 | 1.31 | 0.90 | D |
| Example) | | | | | | | | | | | | |
| 15 (Invention) | 5.55 | 1.47 | 0.30 | 0.81 | 0.029 | 0.025 | 0.18 | 0.01 | 0.84 | 0.77 | 0.53 | B |
| 16 (Comparative | 5.55 | 1.47 | 0.30 | 0.81 | 0.036 | 0.025 | 0.23 | 0.01 | 1.28 | 1.24 | 0.88 | D |
| Example) | | | | | | | | | | | | |
| 17 (Invention) | 5.55 | 1.47 | 0.30 | 0.81 | 0.024 | 0.030 | 0.18 | 0.02 | 1.13 | 1.08 | 0.80 | C |
| 18 (Comparative | 5.55 | 1.47 | 0.30 | 0.81 | 0.024 | 0.038 | 0.24 | 0.05 | 1.51 | 1.44 | 1.17 | D |
| Example | | | | | | | | | | | | |
| 19 (Invention) | 5.55 | 1.47 | 0.24 | 0.81 | 0.024 | 0.025 | 0.17 | 0.02 | 1.02 | 0.98 | 0.74 | C |
| 20 (Comparative | 5.55 | 1.47 | 0.18 | 0.81 | 0.024 | 0.025 | 0.22 | 0.04 | 1.40 | 1.35 | 1.01 | D |
| Example | | | | | | | | | | | | |

From Table 1, it can be seen that, in the case of a bluish type photosensitive material usually called blue base having a value of b₀* in the above equation (1) in a fog density portion satisfying −20≦b₀*<−4, samples of the invention having a fog density value immediately after treatment of 0.20 or less and having any one of a color difference of (a) 1.2 or less after 9 months under 30° C. and 60% RH environment, (b) 1.2 or less after 3 months under 40° C. and 40% RH environment, or (c) 0.9 or less after 1 week under 45° C. and 40% RH environment, have smaller color differences as compared with a comparative product, and have a small tone change after long term natural a point when an amount of time has passed.

In addition, it can be seen that samples having an entire amount of coated silver of 1.6 g/m² or less have a smaller tone change as compared with samples having a larger coated silver amount.

### Example 2

According to the same manner as that for thermally developable photosensitive materials 10 to 14 except that a blue dye compound 1 was coated on a back layer at 0.11 g, and a pigment-1 dispersion (C.I. Pigment Blue 60) in an image forming layer coating solution was removed in preparation of a halation preventing layer coating solution in Example 1, thermally developable photosensitive materials 21 to 25 were prepared.

Assessment of the photographic property and the tone was performed as in Example 1. A value of b₀* in a fog density portion was in a range of −3.0 to −0.8 in samples 21 to 25. The results are summarized in Table 2.

TABLE 2

| | Coated | Entire | Coated | Coated | Coated | Coated | | | | | | |
|---|---|---|---|---|---|---|---|---|---|---|---|---|
| | amount of | amount of | amount of | amount of | amount of | amount of | Fog density value | | Color difference | | | Rank of |
| | silver | coated | polyha- | reducing | development | development | Immediately | | Condi- | Condi- | Condi- | tone |
| | behenate | silver | logen 2 | agent 2 | accelerator | accelerator | after | | tion | tion | tion | assess- |
| Sample No. | (g/m²) | (g/m²) | (g/m²) | (g/m²) | 1 (g/m²) | 2 (g/m²) | treatment | Δ(c) | (a) | (b) | (c) | ment |
| 21 | 5.55 | 1.47 | 0.30 | 0.81 | 0.024 | 0.025 | 0.10 | 0.01 | 0.58 | 0.56 | 0.29 | A |
| (Invention) | | | | | | | | | | | | |
| 22 | 6.25 | 1.64 | 0.30 | 0.81 | 0.024 | 0.025 | 0.11 | 0.015 | 0.88 | 0.89 | 0.60 | B |
| (Invention) | | | | | | | | | | | | |
| 23 | 7.00 | 1.82 | 0.30 | 0.81 | 0.024 | 0.025 | 0.13 | 0.025 | 1.18 | 1.17 | 0.87 | C |
| (Invention) | | | | | | | | | | | | |
| 24 | 5.55 | 1.47 | 0.30 | 0.89 | 0.024 | 0.025 | 0.12 | 0.02 | 0.77 | 0.85 | 0.56 | B |
| (Invention) | | | | | | | | | | | | |
| 25 (Compar- | 5.55 | 1.47 | 0.30 | 0.97 | 0.024 | 0.025 | 0.15 | 0.02 | 1.27 | 1.34 | 0.92 | D |
| ative | | | | | | | | | | | | |
| Example) | | | | | | | | | | | | |

From Table 2, it can be seen that, in the case of a weakly bluish type photosensitive material usually called clear base having a value of b₀* in the equation (1) in a fog density portion satisfying −4≦b₀*≦4, samples of the invention having a fog density value immediately after treatment of 0.13 or less, and having any one of a color difference of (a) 1.2 or less after 9 months under 30° C. and 60% RH environment, (b) 1.2 or less after 3 months under 40° C. and 40% RH environment, or (c) 0.9 or less after 1 week under 45° C. and 40% RH environment have smaller color differences as compared with a comparative product, and have a small tone change also after long time natural a point when an amount of time has passed.

In addition, it can be seen that samples having an entire amount of coated silver of 1.6 g/m² or less have a smaller tone change as compared with samples having a larger coated silver amount.

### Example 3

Coating of a back layer was performed by changing, compared with a back layer in Example 1, preparation of a base precursor solid fine particle dispersion (a), preparation of a halation preventing layer coating solution, and preparation of a back surface protecting layer coating solution as follows:

(Back Layer)

1) Preparation of Back Layer Coating Solution

(Preparation of Base Precursor Solid Fine Particle Dispersion (a))

2.5 kg of a base precursor compound 1,300 g of a surfactant (trade name: Demol N, manufactured by Kao Coiporation), 800 g of diphenylsulfone, 1.0 g of a sodium salt of benzoisothiazolinone and distilled water were added so that the total amount became 8.0 kg, the materials were mixed, and the mixture was beads-dispersed using a traverse-type sand mill (UVM 2: manufactured by I.mecs). As a dispersing method, the mixture was supplied to UVM 2 charged with zirconia beads having an average diameter of 0.5 mm with a diaphragm, and dispersed in the state of an internal pressure of 50 hPa or higher until a desired average particle diameter was obtained.

The dispersion was dispersed until a ratio of absorbance at 450 nm and absorbance at 650 nm (D450/D650) in spectroscopic absorption of the dispersion became 3.0 as measured by spectroscopic absorption. The resultant dispersion was diluted with distilled water so that the concentration of a base precursor became 25% by weight, and filtered (polypropylene filter having an average fine pore diameter: 3 μm) for removing trashes, which was subjected to practical use.

2) Preparation of Dye Solid Fine Particle Dispersion

6.0 kg of a cyanine dye compound 1, 3.0 kg of sodium p-dodecylbenzenesulfonate, 0.6 kg of a surfactant Demol SNB manufactured by Kao Corporation and 0.15 kg of an antifoaming agent (trade name: Surfinol 104E, manufactured by Nisshin Chemicals Co., Ltd.) were mixed with distilled water so that the total amount became 60 kg. The mixture was dispersed with 0.5 mm zirconia beads using a traverse-type sand mill (UVM 2: manufacture by I.mecs).

The dispersion was dispersed until a ratio of absorbance at 650 nm and absorbance at 750 nm (D650/D750) in spectroscopic absorption of the dispersion became 5.0 or higher as measured by spectroscopic absorption. The resulting dispersion was diluted with distilled water so that the concentration of a cyanine dye became 6% by mass, and filtered with a filter (average fine pore diameter: 1 μm) for removing trash, which was subjected to practical use.

3) Preparation of Halation Preventing Layer Coating Solution

A container was kept at 40° C., and 40 g of gelatin, 20 g of a monodisperse polymethyl methacrylate fine particle (average particle size 8 μm, particle diameter standard deviation 0.4), 0.1 g of benzoisothiazolinone and 490 ml of water were added to dissolve gelatin. Further, 2.3 ml of a 1 mol/l aqueous sodium hydroxide solution, 40 g of the above-mentioned dye solid fine particle dispersion, 90 g of above-mentioned base precursor solid fine particle dispersion (a), 12 ml of a 3% aqueous solution of sodium polystyrenesulfonate, and 180 g of a 10% solution of SBR latex were mixed. Immediately before coating, 80 ml of a 4% aqueous solution of N, N-ethylenebis (vinylsulfonacetamide) was mixed therein to obtain a halation preventing layer coating solution.

4) Preparation of Back Surface Preventing Coating Solution

A container was kept at 40° C., and 40 g of gelatin, 35 mg of benzoisothiazolinone and 840 ml of water were added to dissolve gelatin. Further, 5.8 ml of a 1 mol/l aqueous sodium hydroxide solution, 1.5 g (in terms of liquid paraffin) of a liquid paraffin emulsion, 10 ml of a 5% aqueous solution of a sodium salt of di(2-ethylhexyl) sulfosuccinate, 20 ml of a 3% aqueous solution of sodium polystyrenesulfonate, 2.4 ml of a 2% solution of a fluorine series surfactant (F-1), 2.4 ml of a 2% solution of a fluorine series surfactant (F-2), and 32 g of a 19% by mass solution of a methyl methacrylate/styrene/butyl acrylate/hydroxyethyl methacrylate/acrylic acid copolymer (copolymerization ratio by weight 57/8/28/5/2) latex were mixed therein. Immediately before coating, 25 ml of a 4% aqueous solution of N, N-ethylenebis(vinylsulfonacetamide) was mixed therein to obtain a back surface protecting layer coating solution.

4) Coating of Back Layer

On a back surface side of the above-mentioned undercoated substrate, an anti-halation layer coating solution was coated in a gelatin coated amount of 0.52 g/m² and a back surface protecting layer coating solution was coated in a gelatin coated amount of 1.7 g/m² in a simultaneous multi-layer coating manner, which was dried to prepare a back layer.

(Image Foaming Layer Surface)

By changing preparation of an intermediate layer coating solution, preparation of a surface protecting layer first layer coating solution, and preparation of a surface protecting layer second layer coating solution as follows, compared with an intermediate layer and a surface protecting layer of Example 1, and combining the above-mentioned back layer with image forming layers of thermally developable photosensitive materials 1 to 20 of Example 1, thermally developable photosensitive materials 26 to 45 were prepared.

1) Preparation of Intermediate Layer Coating Solution

27 ml of a 5% by mass aqueous solution of Aerosol OT (manufactured by American Cyanamide), 135 ml of a 20% by mass aqueous solution of diammonium salt of phthalic acid, and water were added to 1000 g of polyvinyl alcohol PVA-205 (manufactured by Kuraray Co., Ltd.), 163 g of a pigment-1 dispersion, 33 g of an aqueous solution of a blue dye compound 1 (manufactured by Nippon Kayaku Co., Ltd.: Kayafecttarcoise RN Liquid 150), 27 ml of a 5% aqueous solution of a sodium salt of di(2-ethylhexyl) sulfosuccinate, and 4200 ml of a 19% by mass solution of a methyl methacrylate/styrene/butyl acrylate /hydroxyethyl methacrylate/ acrylic acid copolymer (copolymerization ratio by weight 57/8/28/5/2) latex, so that the total amount became 10000 g, pH was adjusted to 7.5 with NaOH to obtain an intermediate layer coating solution, which was supplied to a coating die at 8.9 ml/m².

A viscosity of the coating solution was measured with a B-type viscometer (No. 1 rotor, 60 rpm) at 40° C. and found to be 58 [mPa.s].

2) Preparation of surface protecting layer first layer coating Solution

100 g of inert gelatin and 10 mg of benzoisothiazolinone were dissolved in 840 ml of water. 180 g of a 19% by mass solution of a methyl methacrylate/ styrene/butyl acrylate/hydroxymethyl methacrylate/acrylic acid/copolymer (copolymerization ratio by weight 57/8/28/5/2) latex, 46 ml of a 15% by mass solution of phthalic acid in methanol, and 5.4 ml of a 5% by mass aqueous solution of a sodium salt of di(2-ethylhexyl) sulfosuccinate were added to the solution and mixed. 40 ml of 4% by mass chromium alum was mixed therein with a static mixer immediately before coating, which was supplied to a coating die in a coating amount of 26.1 mi/M².

A viscosity of the coating solution was measured with a B-type viscometer (No. 1 rotor, 60 rpm) at 40° C. and found to be 20 [mPa.s].

3) Preparation of Surface Protecting Layer Second Layer Coating Solution

100 g of inert gelatin and 10 mg of benzoisothiazolinone were dissolved in 800 ml of water, and 180 g of a 19% by mass solution of a methyl methacrylate/styrene/butyl acrylate/hydroxyethyl methacrylate/acrylic acid copolymer (copolymerization ratio by weight 57/8/28/5/2) latex, 40 ml of a 15% by mass solution of phthalic acid in methanol, 5.5 ml of a 1% by mass solution of a fluorine series surfactant (F-1), 5.5 ml of a 1% by mass aqueous solution of a fluorine series surfactant (F-2), 28 ml of a 5% by mass aqueous solution of a sodium salt of di(2-ethylhexyl) sulfosuccinate, 4 g of a polymethyl methacrylate fine particle (average particle diameter 0.7 μm) and 21 g of a polymethyl methacrylate fine particle (average particle diameter 4.5 μm) were mixed therein to obtain a surface protecting layer coating solution, which was supplied to a coating die at 8.3 ml/m².

A viscosity of the coating solution was measured with a B-type viscometer (No. 1 rotor, 60 rpm) at 40° C. and found to be 19 [mPa.s].

Assessment of the photographic property and the tone was performed as in Example 1 and, as a result, the same effects as those of Example 1 were obtained.

### Example 4

According to the same manners as those for thermally developable photographic materials 16 to 20 except that a pigment-1 dispersion was changed to 190 g and a blue dye compound 1 aqueous solution was changed to 20 g, and a pigment-1 dispersion (C.I.Pigment Blue 60) was removed, in preparation of an intermediated layer coating solution in Example 3, thermally developable photosensitive materials 46 to 50 were prepared.

Assessment of the photographic property and the tone was performed as in Example 2 and, as a result, the same effects as those of Example 2 were obtained.

### Example 5

<<Preparation of Emulsion Layer (Photosensitive Layer) Coating Solutions-52 to 65>>

Respective compounds were successively added so that coating amounts described in Table 3 and item of thermally developable photosensitive materials 52 to 65 later, were attained, as in an emulsion layer (photosensitive layer) coating solution-1 in Example 1, whereby coating solutions-52 to 65 were prepared, and each of them was supplied and coated as described above.

Viscosities of the above-mentioned emulsion layer coating solutions were measured with a B-type viscometer of Tokyokeiki and found to be 24 to 39 [mPa.s] at 40° C. (No. 1 rotor, 60 rpm).

A viscosity of the coating solution at 25° C. measured by RFS Fluid Spectrometer manufactured by Rheometric Scientific FE. Ltd. was 223 to 521, 59 to 141, 45 to 93, 23 to 49, or 18 to 27 [mPa.s] at a shear rate of 0.1, 1, 10, 100 or 1000[1/sec], respectively.

A zirconium amount in a coating solution was 0.25 to 0.38 mg per 1 g of silver.

<<Preparation of Thermally Developable Photosensitive Material 51>>

According to the same manner as that for a thermally developable photosensitive material 1 of Example 1 except that a fluorine series surfactant F-1 to F-4 in a back surface protecting layer coating solution and an emulsion surface protecting layer second layer coating solution were changed to F-5 to F-8, a thermally developable photosensitive material 51 was prepared.

<<Preparation of a Thermally Developable Photosensitive Material 52>>

According to the same manner as that for a thermally developable photosensitive material-51 except that a mercapto compound 1 in an emulsion layer coating solution-1 was removed, a fatty acid silver dispersion B was used in place of a fatty acid silver dispersion A, a reducing agent 2 and a hydrogen-bonding compound 1 were used in place of a reducing agent complex 1, each amount of each compound was changed to a coating amount described below (emulsion layer coating solution-2), a yellow dye compound 1 was removed from a halation preventing layer, and fluorine series surfactants in a back surface protecting layer and an emulsion surface protecting layer were changed from F-5, F-6, F-7 and F-8 to F-1, F-2, F-3 and F-4, respectively, a thermally developable photosensitive material-52 was prepared.

A coating amount (g/m²) of each compound in an emulsion layer thereupon was as follows:

| | |
|---|---|
| Silver behenate | 5.55 |
| Pigment (C.I.Pigment Blue 60) | 0.036 |
| Polyhalogen compound 1 | 0.12 |
| Polyhalogen compound 2 | 0.25 |
| Phthalazine compound 1 | 0.19 |
| SBR latex | 9.67 |
| Reducing agent 2 | 0.81 |
| Hydrogen-bonding compound 1 | 0.60 |
| Development accelerator 1 | 0.024 |
| Mercapto compound 2 | 0.01 |
| Silver halide (in terms of Ag) | 0.11 |

<<Preparation of Thermally Developable Photosensitive Materials 53 to 65>>

According to the same manner as that for a thermally developable photosensitive material-52 except that a reducing agent described in Table 3 was used in place of a reducing agent 2 in an emulsion layer coating solution-52, a development accelerator 2 and a tone adjusting agent 2 were newly added in a coating amounts in Table 3 and described later, and amounts of other compounds were changed to coating amounts in Table 3 and described later, compared with the thermally developable photosensitive material-52, thermally developable photosensitive materials 53 to 65 were prepared.

A coating amount (g/m²) of each compound in an emulsion layer thereupon was as follows:

| | |
|---|---|
| Silver behenate | Coating amount described in Table 1 |
| Pigment (C.I.Pigment Blue 60) | 0.036 |
| Polyhalogen compound 1 | 0.18 |
| Polyhalogen compound 2 | Coating amount described in Table 1 |
| Phthalazine compound 1 | 0.19 |
| SBR latex | 9.67 |
| Reducing agent | Kind and coating |
| | amount described in Table 1 |
| Hydrogen-bonding compound 1 | 0.30 |
| Development accelerator 1 | 0.024 |
| Development accelerator 2 | |
| | Coating amount described in Table 1 |
| Tone adjusting agent 1 | 0.010 |
| Mercapto compound 2 | 0.003 |
| Silver halide (in terms of Ag) | |
| | Coating amount described in Table 1 |

(Assessment of Photographic Performance)

The resulting sample was cut into a half-cut size, packaged in the following packaging material under an environment of 25° C. and 50% RH, stored at a normal temperature for 2 weeks, and the following assessment was performed.

(Packaging Material)

PET 10 μm/PE 12 μm/aluminium foil 9 μm/Ny 15 μm/polyethylene containing 3% carbon 50 μm

Oxygen permeating rate: 0.02 ml/atm·m²·25° C.·day, moisture permeating rate: 0.10 g/atm·m²·25° C.·day

(Assessment of Color Difference and Change of Fog Density)

The prepared thermally developable photosensitive materials were exposed and thermally developed (with four panel heaters set at 112° C.-119° C.-121° C.-121° C. for 24 seconds in total in the case of a thermally developable photosensitive materials 51 and 52, for 14 seconds in total in the case of thermally developable photosensitive materials 53 to 65) with Fuji Medical Dry Laser Imager FM-DPL(carrying a 660 nm semiconductor laser having an maximum output of 60 mW(IIIB)), the fog density of the resultant image immediately after developing treatment was measured with a Macbeth densitometer, and L₀*, a₀* and b₀* of CIELAB color display system were obtained as a value at the test light F5 (day color) with a spectroscopic colorimetric densitometer according to JIS Z 8719. A value of b₀* in a fog density portion was in a range of −11.3 to −9.0 in samples 1 to 15.

Then, the fog density after light irradiation and L₁*, a₁* and b₁* of CIELAB color display system were obtained similarly for (a) the samples after irradiation with 1000 Lux fluorescent lamp continuously for one day under an environment of 30° C. and 70% RH, and (b) the samples after irradiation with 10000 Lux schaukasten light continuously for one day under an environment of 25° C. and 60% RH.

A color difference before and after light irradiation under each condition was calculated from the above-mentioned equation (1). A color difference was different depending on the image concentration, and values at an intermediate concentration part where a color difference was greatest (D=1.2 to 1.6) are described in Table 3. A difference in the fog density before and after light irradiation was obtained, and only a change in the fog density under the condition (a) where a change was greatest is described in Table 3.

(Assessment of Tone)

The above-mentioned prepared respective thermally developed samples were observed with naked eyes, and under the following conditions corresponding to light irradiation conditions (light irradiation by indoor fluorescent lamp and schaukasten light at diagnosis) and time which were usually imposed on a thermally developable photosensitive material upon handling at medical facilities, an extent of a tone change of a sample before and after light irradiation was assessed based on the following assessment criteria regarding exposed samples. Assessment ranks A to C were judged as a practically acceptable range.

—Light Irradiation Conditions and Integrated Time

Light irradiation conditions: 10000 Lux/1000 Lux

Time: 64hr/48hr

—Assessment Criteria

A: A tone change could not be observed visibly at all

B: When stared, a slight tone change could be observed visibly, but there was practically no problem.

C: There was a part, in which a tone change could be observed visibly, depending on an exposed amount, but there was no sense of incongruity before and after a point when an amount of time has passed.

D: Regardless of an exposed amount, a tone change could be easily observed visibly, and there was a sense of incongruity before and after a point when an amount of time has passed.

The foregoing results are summarized in Table 3.

TABLE 3

| | | | | | | | Coated | | | | | |
|---|---|---|---|---|---|---|---|---|---|---|---|---|
| | Coated | Coated | Entire | | Reducing agent | | amount of | Color | | | | |
| | amount | amount of | amount | Coated | (complex) | | develop- | Fog density value | | difference ΔE | | Tone |
| | of silver | silver | of coated | amount of | | Coated | ment | Immediately | | Condi- | Condi- | assess- |
| | halide | behenate | silver | polyhalogen | | amount | accelerator | after | | tion | tion | ment |
| Sample No. | (g/m²) | (g/m²) | (g/m²) | 2 (g/m²) | Kind | (g/m²) | 2 (g/m²) | treatment | Δ(a) | (a) | (b) | Rank |
| 51 (Comparative | 0.091 | 5.55 | 1.43 | 0.37 | 1 | 1.41 | — | 0.17 | 0.01 | 1.84 | 1.57 | D (x) |
| Example) | | | | | | | | | | | | |
| 52 (Invention) | 0.11 | 5.55 | 1.45 | 0.25 | 2 | 0.81 | — | 0.16 | 0.02 | 1.16 | 0.83 | C |
| 53 (Invention) | 0.13 | 5.55 | 1.47 | 0.30 | 2 | 0.81 | 0.025 | 0.16 | 0.01 | 0.63 | 0.37 | A |
| 54 (Invention) | 0.13 | 6.25 | 1.64 | 0.30 | 2 | 0.81 | 0.025 | 0.17 | 0.015 | 1.02 | 0.69 | B |
| 55 (Invention) | 0.13 | 7.00 | 1.82 | 0.30 | 2 | 0.81 | 0.025 | 0.18 | 0.02 | 1.17 | 1.14 | C |
| 56 (Invention) | 0.18 | 5.55 | 1.52 | 0.30 | 2 | 0.81 | 0.025 | 0.17 | 0.03 | 1.10 | 1.17 | C |
| 57 (Invention) | 0.13 | 5.55 | 1.47 | 0.30 | 2 | 0.89 | 0.025 | 0.17 | 0.01 | 0.95 | 0.76 | B |
| 58 (Comparative | 0.13 | 5.55 | 1.47 | 0.30 | 2 | 0.97 | 0.025 | 0.21 | 0.02 | 1.45 | 1.08 | D (x) |
| Example) | | | | | | | | | | | | |
| 59 (Comparative | 0.13 | 5.55 | 1.47 | 0.30 | 3 | 0.72 | 0.025 | 0.25 | 0.01 | 1.28 | 0.90 | D (x) |
| Example) | | | | | | | | | | | | |
| 60 (Comparative | 0.13 | 5.55 | 1.47 | 0.30 | 4 | 0.78 | 0.025 | 0.23 | 0.04 | 1.19 | 0.99 | D (x) |
| Example) | | | | | | | | | | | | |
| 61 (Invention) | 0.13 | 5.55 | 1.47 | 0.30 | 5 | 0.82 | 0.025 | 0.16 | 0.02 | 1.17 | 1.06 | C |
| 62 (Invention) | 0.13 | 5.55 | 1.47 | 0.30 | 2 | 0.81 | 0.030 | 0.18 | 0.02 | 1.22 | 0.87 | C |
| 63 (Comparative | 0.13 | 5.55 | 1.47 | 0.30 | 2 | 0.81 | 0.038 | 0.24 | 0.04 | 1.39 | 0.98 | D (x) |
| Example) | | | | | | | | | | | | |
| 64 (Invention) | 0.13 | 5.55 | 1.47 | 0.24 | 2 | 0.81 | 0.025 | 0.17 | 0.02 | 1.28 | 0.89 | C |
| 65 (Comparative | 0.13 | 5.55 | 1.47 | 0.18 | 2 | 0.81 | 0.025 | 0.22 | 0.03 | 1.41 | 1.01 | D (x) |
| Example) | | | | | | | | | | | | |

From table 3, it can be seen that, in the case of a bluish type photosensitive material usually called blue base having a value of b₀* in the above-mentioned equation (1) at a fog density portion satisfying −20≦b₀*<−4, samples of the invention having a fog density value immediately after treatment of 0.20 or less and having either color difference of (a) 1.2 or less with 1000 Lux light continuous irradiation for 1 day under an environment of 30° C. and 70% RH, or (b) 0.9 or less with 10000 Lux light continuous irradiation for 1 day under an environment of 25° C. 60%, have a smaller color difference as compared with a comparative product, and have a small tone change also after light irradiation. In addition, it can be seen that a sample having an entire amount of coated silver of 1.6 g/m² or less has a smaller tone change as compared with a sample having a greater coated silver amount.

### Example 6

According to the same manners as those for thermally developable photosensitive materials 53 to 55, 57 and 58 except that a blue dye compound 1 was contained in an amount of 0.11 g upon back layer coating, and a pigment-1 dispersion (C.I.Pigment Blue 60) in an image forming layer coating solution was removed in preparation of a halation preventing layer coating solution in Example 5, thermally developable photosensitive materials 66 to 70 were prepared.

Assessment of the photographic property and the tone was performed as in Example 5. A value of b₀* in a fog density portion was in a range of −3.1 to −0.9 in samples 66 to 70. The results are summarized in Table 4.

TABLE 4

| | Coated | Coated | Entire | | Reducing agent | | Coated | | | Color | | |
|---|---|---|---|---|---|---|---|---|---|---|---|---|
| | amount of | amount | amount | Coated | (complex) | | amount of | Fog density value | | difference ΔE | | Tone |
| | silver | of silver | of coated | amount of | | Coated | development | Immediately | | Condi- | Condi- | assess- |
| | halide | behenate | silver | polyhalogen | | amount | accelerator | after | | tion | tion | ment |
| Sample No. | (g/m²) | (g/m²) | (g/m²) | 2 (g/m²) | Kind | (g/m²) | 2 (g/m²) | treatment | Δ(a) | (a) | (b) | Rank |
| 66 | 0.13 | 5.55 | 1.47 | 0.30 | 2 | 0.81 | 0.025 | 0.10 | 0.01 | 0.59 | 0.39 | A |
| (Invention) | | | | | | | | | | | | |
| 67 | 0.13 | 6.25 | 1.64 | 0.30 | 2 | 0.81 | 0.025 | 0.11 | 0.015 | 1.05 | 0.70 | B |
| (Invention) | | | | | | | | | | | | |
| 68 | 0.13 | 7.00 | 1.82 | 0.30 | 2 | 0.81 | 0.025 | 0.13 | 0.03 | 1.16 | 1.13 | C |
| (Invention) | | | | | | | | | | | | |
| 69 | 0.13 | 5.55 | 1.47 | 0.30 | 2 | 0.89 | 0.025 | 0.12 | 0.015 | 0.97 | 0.74 | B |
| (Invention) | | | | | | | | | | | | |
| 70 (Compara- | 0.13 | 5.55 | 1.47 | 0.30 | 2 | 0.97 | 0.025 | 0.15 | 0.02 | 1.49 | 1.12 | D (x) |
| tive Example | | | | | | | | | | | | |

From table 4, it can be seen that, in the case of a blueless type photosensitive material usually called clear base having the value of b₀* in the equation (1) at a fog density portion satisfying −4≦b₀*≦4, samples having a fog density value immediately after treatment of 0.13 or less and having either color difference of (a) 1.2 or less with 1000 Lux light continuous irradiation for 1 day under an environment of 30° C. and 70% RH, or (b) 0.9 or less with 10000 Lux light continuous irradiation for 1 day under an environment of 25° C. and 60% RH, have a smaller color difference as compared with a comparative product, and have a small tone change also after light irradiation. In addition, it can be seen that a sample having an entire amount of coated silver of 1.6 g/m² or less has a smaller tone change as compared with a sample having a greater coated silver amount.

### Example 7

(Image Forming Layer Surface)

As in Example 3, by changing an intermediate layer, a surface protecting layer first coating solution, a surface protecting layer second coating solution, and a back layer of thermally developable photosensitive materials 1 to 15 of Examples 5 and 6, to an intermediate layer of Example 3, a surface protecting layer first coating solution of Example 3, a surface protecting layer second coating solution of Example 3, and a back layer of Example 3, respectively, thus a thermally developable photosensitive material 71 to 85 were prepared.

Assessment of the photographic property and the tone was performed as in Example 5 and, as a result, the same effects as those of Example 5 were obtained.

### Example 8

According to the same manners as those for thermally developable photosensitive materials 66 to 70 except that an amount of a pigment 1-dispersion was changed to 190 g, an amount of a blue dye compound 1 aqueous solution was changed to 20 g, and a pigment-1 dispersion (C.I.Pigment Blue 60) in an image forming layer coating solution was removed in preparation of an intermediate layer coating solution in Example 7, thermally developable photosensitive materials 86 to 100 were prepared.

Assessment of the photographic property and the tone was performed as in Example 6 and, as a result, the same effects as those of Example 6 were obtained.

According to the invention, a thermally developable photosensitive material excellent in the tone stability at storage can be provided. In addition, according to the invention, there can be provided a thermally developable photosensitive material which gives the sufficient image concentration with a small amount of a reducing agent, has the low fog density, and has the improved image shelf stability (tone change) at light irradiation.

What is claimed is:

1. A thermally developable photosensitive material comprising a non-photosensitive organic silver salt, a photosensitive silver halide and a reducing agent on at least one surface of a transparent substrate, wherein a fog density value immediately after thermal developing treatment is 0.20 or less, a value of b₀* in the following equation (1) at a fog density portion satisfies −20≦b₀*<−4, and a change in an image tone from immediately after thermal developing treatment to a point when an amount of time has passed as a value of a color difference ΔE as defined in equation (1) is any one of (a) 1.2 or less at 9 months under an environment of 30° C. and 60% RH, (b) 1.2 or less at 3 months under an environment of 40° C. and 40% RH, or (c)0.9 or less at 1 week under an environment of 45° C. and 40% RH:
ΔE=[(L₁*−L₀*)²+(a₁*−a₀*)²+b₁*−b₀*]²]^{1/2} Equation (1)
wherein L₁* and L₀* respectively represent metric brightnesses after a point when an amount of time has passed and immediately after thermal developing treatment, in a CIELAB space when observed with a light source used in a medical schaukasten, and a₁*, b₁* and a₀*, b₀* represent amounts (color coordinates) of a hue and a chroma after a point when an amount of time has passed and immediately after thermal developing treatment, respectively, in a CIELAB space.

2. A thermally developable photosensitive material according to claim 1, wherein the fog density value is 0.13 or less, and a value of b₀* in the equation (1) at the fog density portion satisfies −4≦b₀*≦4.

3. A thermally developable photosensitive material according to claim 1, wherein an entire amount of coated silver in the thermally developable photosensitive material is 0.1 to 5.0 g/m².

4. A thermally developable photosensitive material according to claim 2, wherein an entire amount of coated silver in the thermally developable photosensitive material is 0.1 to 5.0 g/m².

5. A thermally developable photosensitive material according to claim 1, wherein 50% by mass or more of the particles of the photosensitive silver halide have a particle size of 80 nm or smaller.

6. A thermally developable photosensitive material according to claim 2, wherein 50% by mass or more of the particles of the photosensitive silver halide have a particle size of 80 nm or smaller.

7. A thermally developable photosensitive material according to claim 1, wherein an amount of the reducing agent is 0.1 to 3.0 g/m².

8. A thermally developable photosensitive material according to claim 2, wherein an amount of the reducing agent is 0.1 to 3.0 g/m².

9. A thermally developable photosensitive material according to claim 1 comprising an organic polyhalogen compound represented by the following general formula (H) as a antifoggant:
Q-(Y)ₙ-c(Z₁)(Z₂)X General formula (H)
wherein Q represents an alkyl group, an aryl group or a heterocyclic group; Y represents a divalent tethering group; n represents 0 or 1; Z₁ and Z₂ represent a halogen atom; and X represents a hydrogen atom or an electron withdrawing group.

10. A thermally developable photosensitive material according to claim 2 comprising an organic polyhalogen compound represented by the general formula (H) as a antifoggant:
Q-(Y)ₙ-c(Z₁)(Z₂)X General formula (H)
wherein Q represents an alkyl group, an aryl group or a heterocyclic group; Y represents a divalent tethering group; n represents 0 or 1; Z₁ and Z₂ represent a halogen atom; and X represents a hydrogen atom or an electron withdrawing group.

11. A thermally developable photosensitive material comprising at least a non-photosensitive organic silver salt, a photosensitive silver halide and a reducing agent on the same surface of a substrate, wherein
1) a fog density value immediately after thermal developing treatment is 0.20 or less;
2) a value of b₀* in the following equation (1) at a fog density portion satisfies −20≦b₀*<−4; and
3) a change in an image tone (color difference ΔE) from immediately after thermal developing treatment to after light irradiation as defined in equation (1) satisfies any one of the following condition (a) or the following condition (b):
ΔE=[(L₁*−L₀*)²+(a₁*−a₀*)²+b₁*−b₀*]²]^{1/2} Equation (1)
wherein L₁* and Lo* respectively represent metric brightnesses after a point when an amount of time has passed and immediately after thermal developing treatment, in a CIELAB space when observed with a light source used in a medical schaukasten, and a₁*, b₁* and a₀*, b₀* represent amounts (color coordinates) of a hue and a chroma after a point when an amount of time has passed and immediately after thermal developing treatment, respectively, in a CIELAB space
Condition (a):
ΔE is 1.2 or less when 1000 Lux light is continuously irradiated to the thermally developable photosensitive material for 1 day under an environment of 30° C. and 70% RH,
Condition (b):
ΔE is 0.9 or less when 10000 Lux light is continuously irradiated to the thermally developable photosensitive material for 1 day under an environment of 25° C. and 60% RH.

12. A thermally developable photosensitive material according to claim 11, wherein the fog density value is 0.13 or less, and a value of b₀* in the equation (1) at the fog density portion satisfies −4≦b₀*≦4.

13. A thermally developable photosensitive material according to claim 11, wherein an entire amount of coated silver in the thermally developable photosensitive material is 0.1 to 5.0 g/m².

14. A thermally developable photosensitive material according to claim 12, wherein an entire amount of coated silver in the thermally developable photosensitive material is 0.1 to 5.0 g/m².

15. A thermally developable photosensitive material according to claim 11, wherein 50% by mass or more of the particles of the photosensitive silver halide have a particle size of 80 nm or smaller.

16. A thermally developable photosensitive material according to claim 12, wherein 50% by mass or more of the particles of the photosensitive silver halide have a particle size of 80 nm or smaller.

17. A thermally developable photosensitive material according to claim 11, wherein an amount of the reducing agent is 0.1 to 3.0/m².

18. A thermally developable photosensitive material according to claim 12, wherein an amount of the reducing agent is 0.1 to 3.0 g/m².

19. A thermally developable photosensitive material according to claim 11 comprising an organic polyhalogen compound represented by the general formula (H) as a antifoggant:
Q-(Y)ₙ-c(Z₁)(Z₂)X General formula (H)
wherein Q represents an alkyl group, an aryl group or a heterocyclic group; Y represents a divalent tethering group; n represents 0 or 1; Z₁ and Z₂ represent a halogen atom; and X represents a hydrogen atom or an electron withdrawing group.

20. A thermally developable photosensitive material according to claim 12 comprising an organic polyhalogen compound represented by the general formula (H) as a antifoggant:
Q-(Y)ₙ-c(Z₁)(Z₂)X General formula (H)
wherein Q represents an alkyl group, an aryl group or a heterocyclic group; Y represents a divalent tethering group; n represents 0 or 1; Z₁ and Z₂ represent a halogen atom; and X represents a hydrogen atom or an electron withdrawing group.
